(19) United States
(12) Patent Application Publication
(10) Pub. No.: US 2026/0211802 A1
(43) Pub. Date: Jul. 23, 2026

(54) Artificial Intelligence (AI) Assisted End-to-End Workflow Integration for Software Development in Digital Model Platforms

(71) Applicant: Istari Digital, Inc., Charleston, SC (US)

(72) Inventors: William Roper, JR., Charleston, SC (US); Christopher Lee Benson, Arlington, VA (US); Sriram Krishnan, Cambridge, MA (US); Baha aldeen E. A. Abunojaim, Roslindale, MA (US); Najem Aldeen Abu Rmaileh, Amman (JO); Peter Galvin, Watertown, MA (US)

(21) Appl. No.: 19/570,121

(22) Filed: Mar. 17, 2026

Related U.S. Application Data
(63) Continuation of application No. PCT/US24/49149, filed on Sep. 28, 2024.
(60) Provisional application No. 63/586,384, filed on Sep. 28, 2023.

(51) Int. Cl. G06F 11/3668; G06F 8/35; G06F 8/73

(52) U.S. Cl. CPC G06F 11/3692; G06F 8/35; G06F 8/73; G06F 11/3684; G06F 11/3688

(57) ABSTRACT

Systems and methods for artificial intelligence (AI) assisted workflow integration for software development in a digital model platform are provided. In one embodiment, the methods receive a user selection of a target digital tool from a plurality of digital tools that are not directly interoperable with each other. Receive a user request comprising a description of a function script executable by the digital model platform on a target digital model type associated with the target digital tool. Fine-tune a scripting AI agent on prior user actions involving the target digital tool and on a resource-capability mapping of the digital model platform. Generate the function script and generate a unit test script, where the unit test script when interpreted tests the function script against the description. Finally, interpret the unit test script to generate a verification result for the function script; and, generate a test report based on the verification result.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
PCT application No. PCT/US24/44938 (Docket No. IST-03.006PCT), filed on Sep. 1, 2024 entitled “Multimodal Digital Document Interfaces for Dynamic and Collaborative Reviews,” describes interface enhancement for digital software platforms.
PCT application No. PCT/US24/42768 (Docket No. IST-02.004PCT), filed on Aug. 16, 2024, entitled “Artificial Intelligence (AI) Assisted Automation of Testing in Software Environments,” describes workflow enhancement for digital software platforms.
PCT application No. PCT/US24/40624 (Docket No. IST-03.003PCT), filed on Aug. 1, 2024, entitled “Machine Learning Engine for Workflow Enhancement in Digital Workflows,” describes workflow enhancement for digital software platforms.
PCT application No. PCT/US24/40468 (Docket No. IST-03.004PCT), filed on Jul. 31, 2024, entitled “Multimodal User Interfaces for Interacting with Digital Model Files,” describes multimodal user interfaces for digital software platforms.
PCT application No. PCT/US24/38878 (Docket No. IST-03.002PCT), filed on Jul. 19, 2024, entitled “Generative Artificial Intelligence (AI) for Digital Workflows,” describes efficient AI-assisted script generation methods that preserve customer data sovereignty.
PCT application No. PCT/US24/35885 (Docket No. IST-02.002PCT), filed on Jun. 27, 2024, entitled “Artificial Intelligence (AI) Assisted Integration of New Digital Model Types and Tools into Integrated Digital Model Platform,” describes the enhancement of model splicer technology through AI-assistance.
PCT application No. PCT/US24/27912 (Docket No. IST-02.003PCT), filed on May 5, 2024, entitled “Secure and Scalable Sharing of Digital Engineering Documents,” describes secure and scalable document splicing technology.
PCT application No. PCT/US24/27898 (Docket No. IST-03.001PCT), filed on May 4, 2024, entitled “Digital Twin Enhancement using External Feedback within Integrated Digital Model Platform,” describes digital and physical twin management and the integration of external feedback within a DE platform.
PCT application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization. “U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (Docket No. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/419,051, filed on Oct. 25, 2022, entitled “Interconnected Digital Engineering and Certification Ecosystem.”
U.S. non-provisional patent application Ser. No. 17/973,142 (Docket No. 54332-0057001) filed on Oct. 25, 2022, entitled “Interconnected Digital Engineering and Certification Ecosystem.”
U.S. non-provisional patent application Ser. No. 18/383,635 (Docket No. 54332-0059001), filed on Oct. 25, 2023, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### NOTICE OF COPYRIGHTS AND TRADEDRESS

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This invention relates to digital model platforms, and more specifically to the application of artificial intelligence (AI) in workflow integration for software development within said digital model platforms.

### BACKGROUND OF THE INVENTION

The statements in the background of the invention are provided to assist with understanding the invention and its applications and uses, and may not constitute prior art.

Software development generally is a complex endeavor that is manually performed by expensive teams of software experts. One area of application of software development is in the field of digital engineering (DE), which is an integrated digital approach to systems engineering. In DE, using authoritative sources of system data and models as a continuum across disciplines supports lifecycle activities from conception through disposal. Disparate engineering tools from multiple disciplines are necessary to enable DE, from design to validation, verification, manufacturing, to certification of complex systems, yet these DE tools and the models they generate are siloed in different engineering software platforms. Robust and efficient integration of data and models from the siloed tools is one of the largest expenses in DE and requires massive teams of highly-specialized engineers and software developers, while cross-platform collaboration is often impeded by the mismatch of software skill sets among highly expensive subject matter experts (SMEs), given the sheer number of different DE model types in use today. Furthermore, large-scale multidisciplinary integration for system-level assessment is far from maturing to efficiently model intricate interactions in large complex systems.

As in conventional software development approaches, within the realm of DE, software development comprises multiple stages, including code creation, testing, annotation, integration, and documentation. For example, testing plays a pivotal role in ensuring the functionality and reliability of individual DE system modules to enable the successful integration of system components. Testing involves the process of executing software scripts within a system with the intent of finding errors or discrepancies. Testing methodologies range from unit testing, where individual system components are tested independently, to integration testing, which assesses interactions between various components. The primary aim is to unearth any oversights from the design and development stages, thereby enhancing the overall system's quality. Similarly, documentation is an essential part of the process and contributes to better communication, knowledge sharing and transfer among stakeholders, as well as quality assurance, maintainability, auditability, and scalability of the technical product. Nonetheless, lack of software development skills among DE SMEs typically lead to highly fragmented and isolated implementations of these individual stages by DE SMEs and software engineers, fostering disparate information flow and potentially incurring significant inefficiencies throughout the DE software engineering lifecycle.

In the broader context of digital model platforms, recent developments in artificial intelligence (AI) and machine learning (ML) have opened new doors for process automation, generative design, and data analytics. Latest advances in natural language processing, transformer-based Large Language Models (LLMs) further show strong promises for essential digital tasks such as code generation for software development and text generation for documentation, yet the applicability of such LLMs is so far unproven, given the complexity and multidisciplinary nature of digital modeling, and the multi-stage, multi-dependency nature of software development and integration.

Therefore, in view of the aforementioned difficulties, there is an unsolved need to provide a software platform that integrates a plethora of digital tools and unifies the software development workflow to enable streamlined testing of software. Accordingly, it would be an advancement in the state of the art to enable AI-assistance in software development workflows involving multidisciplinary digital models from disparate, disconnected tools, together with human-readable documentation, in a unified, scalable, and collaborative digital model platform.

It is against this background that various embodiments of the present invention were developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Broadly, the present invention relates to methods and systems for an artificial intelligence (AI)-assisted approach to integrate discrete workflows for software development within a digital model platform. This integrated workflow streamlines script generation, unit testing, and documentation, encompassing several interdependent stages of the software development process. These stages include one or more of digital model-specific or digital tool-specific function script generation, digital thread orchestration script generation, test script generation, script execution, revision, reporting, and comprehensive software documentation including commenting and annotation, each of which may be enhanced by AI assistance. By enabling the integration of these stages into a cohesive, unified, end-to-end workflow, embodiments of the invention allow smoother transitions between developmental stages, mitigating discrepancies and misalignments that may arise from traditional disconnected workflows during software development, ensuring efficient utilization of human SMEs' time while assisting with the inclusion of new digital model types or new digital tools, even when such new digital tools are non-interoperable with existing ones on the digital model platform.

Accordingly, various methods, processes, and non-transitory storage media storing program code for AI-assisted workflow integration including function script generation, orchestration script generation, test script generation, test script execution, test report preparation, code commenting/annotations with human-readable text, and product documentation are all within the scope of the present invention. Additionally, streamlined bidirectional information flow and data-driven action triggers that integrate the aforementioned stages of the software development workflow with expert feedback are also within the scope of the present invention.

A first aspect, or one embodiment of the present invention, is one or more non-transitory physical storage media storing program code. The program code is executable by a hardware processor. The hardware processor when executing the program code causes the hardware processor to execute a computer-implemented process for artificial intelligence (AI) assisted workflow integration for software development in a digital model platform. The one or more non-transitory storage media may include program code to receive a user selection of a target digital tool from a plurality of digital tools that are not directly interoperable with each other. The program code may include code to receive a user request comprising a description of a function script executable by the digital model platform on a target digital model type associated with the target digital tool. The program code may include code to fine-tune, based on the user selection and the user request, a scripting AI agent on prior user actions involving the target digital tool on the digital model platform, and on a resource-capability mapping of the digital model platform, wherein the resource-capability mapping comprises documentation specific to the target digital tool. The program code may include code to generate the function script, using the scripting AI agent, wherein the function script calls a tool function from the target digital tool, and wherein the function script when interpreted by the digital model platform, generates a digital artifact from a digital model representation of the digital model type. The program code may include code to generate using the scripting AI agent, a unit test script executable by the digital model platform, wherein the unit test script when interpreted tests the function script against the description of the function script. The program code may include code to interpret the unit test script to generate a verification result for the function script. The program code may include code to generate a test report based on the verification result. The program code may include code to receive a user feedback. The program code may include code to update the function script based on the user feedback.

In some embodiments, the unit test script, when interpreted, tests the function script by validating the digital artifact against a corresponding compliance requirement, and wherein a test result indicates whether the digital artifact has passed or failed compliance requirement.

In some embodiments, the user request comprises an update to the digital model representation or an update to the target digital tool.

In some embodiments, the function script when interpreted by the digital model platform, generates the digital artifact from two or more digital model representations of different digital model types.

In some embodiments, the digital model representation of the digital model type is a first digital model representation of a first digital model type, wherein the target digital tool is a first digital tool, and wherein the function script when interpreted by the digital model platform, generates the digital artifact from the first digital model representations of the first digital model type using the first digital tool, and from a second digital model representation of a second digital model type using a second digital tool.

In some embodiments, the first digital tool and the second digital tool are not directly interoperable.

In some embodiments, the program code may further include code to determine, by the digital model platform, a user that provided the user selection and the user request is authorized to access the AI agent.

In some embodiments, the program code may further include code to collect, on the digital model platform, the prior user actions involving the target digital tool, where the prior user actions comprise user-verified scripts that make function calls of the target digital tool to access or manipulate digital models of the digital model type.

In some embodiments, the program code to fine-tune the scripting AI agent generates synthetic fine-tuning data using an Abstract Syntax Tree (AST) decomposition of the user-verified scripts.

In some embodiments, the digital model representation comprises a model splice connected to a digital model file, wherein the model splice comprises one or more splice data items and a splice function providing an Application Programming Interface (API) or Software Development Kit (SDK) endpoint to access the digital artifact.

In some embodiments, the function script is generated based on a predefined input/output schema for the DE model type.

In some embodiments, the program code to update the function script based on the user feedback may include program code to update a prompt to the scripting AI agent; send the prompt to the scripting AI agent; and receive an updated function script.

In some embodiments, the tool function from the target digital tool is an Application Programming Interface (API) function from a digital tool library associated with the target digital tool, and wherein the user request comprises an identification of the digital tool library.

In some embodiments, the program code may further include code to annotate program code of the function script or the unit test script, using a documentation AI agent, wherein the code annotation comprises a human-readable description of the function script.

In some embodiments, the program code may further include code to generate using the scripting AI model, a suite test script for the digital model representation, wherein the suite test script comprises at least one invocation of the function script in a test scenario, and wherein the test scenario is selected from the group consisting of a quality assurance (QA) test scenario, a quality control (QC) test scenario, a usability test scenario, an end-to-end test scenario, a performance test scenario, and a security test scenario.

In some embodiments, the program code may further include code to execute the suite test script to verify the digital model representation; and in response to verifying that the digital model representation, generate using a documentation AI agent, a technical product documentation for the DE model splice.

In some embodiments, the scripting AI agent comprises a transformer.

A second aspect, or another embodiment of the present invention, is a computer-implemented method for artificial intelligence (AI) assisted workflow integration for software development in a digital model platform. The method may include receiving a user selection of a target digital tool from a plurality of digital tools that are not directly interoperable with each other. The method may include receiving a user request comprising a description of a function script executable by the digital model platform on a target digital model type associated with the target digital tool. The method may include fine-tuning, based on the user selection and the user request, a scripting AI agent on prior user actions involving the target digital tool on the digital model platform, and on a resource-capability mapping of the digital model platform, wherein the resource-capability mapping comprises documentation specific to the target digital tool. The method may include generating the function script, using the scripting AI agent, wherein the function script calls a tool function from the target digital tool, and wherein the function script when interpreted by the digital model platform, generates a digital artifact from a digital model representation of the digital model type. The method may include generating using the scripting AI agent, a unit test script executable by the digital model platform, wherein the unit test script when interpreted tests the function script against the description of the function script. The method may include interpreting the unit test script to generate a verification result for the function script. The method may include generating a test report based on the verification result. The method may include receiving user feedback. The method may include updating the function script based on the user feedback.

Features described with respect to the first aspect apply equally to the second aspect.

In another aspect or embodiment of the present invention, a non-transitory, computer-readable storage medium is provided, the non-transitory, computer-readable storage medium storing executable instructions which when executed by a processor, causes the processor to perform a process for AI-assisted workflow integration for software development including the aforementioned steps.

In yet another aspect or embodiment of the present invention, a computer program product is provided. The computer program may be used for AI-assisted workflow integration for software development and may include a computer-readable storage medium having program instructions, or program code, embodied therewith, the program instructions executable by a processor to cause the processor to perform the aforementioned steps.

In yet another aspect or embodiment of the present invention, a system for AI-assisted workflow integration for software development is provided, the system including a memory that stores computer-executable components, and a hardware processor, operably coupled to the memory, and that executes the computer-executable components stored in the memory, where the computer-executable components may include components communicatively coupled with the processor that execute the aforementioned steps.

In yet another aspect or embodiment of the present invention, a system for AI-assisted workflow integration for software development is provided, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In yet another aspect or embodiment of the present invention, a computerized server is provided, including at least one processor, memory, and a plurality of computer codes embodied on said memory, said plurality of computer codes which when executed causes said processor to execute a process including the steps described herein. Other aspects and embodiments of the present invention include the methods, processes, and algorithms including the steps described herein, and also include the processes and modes of operation of the systems and servers described herein.

In yet another aspect or embodiment of the present invention, an edge computerized system is provided, the edge computerized system running on a physical system or physical twin (PTw) with either access to, or dedicated, processing, memory, computer code stored on a non-transitory computer-readable storage medium of the physical system or PTw, and a plurality of sensor data being measured on said physical system or PTw, the computer code causing the processor to perform the aforementioned steps.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium may have corresponding features definable and/or combinable with respect to a digital documentation system and/or method and/or system, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

### Interconnected Digital Model Platform

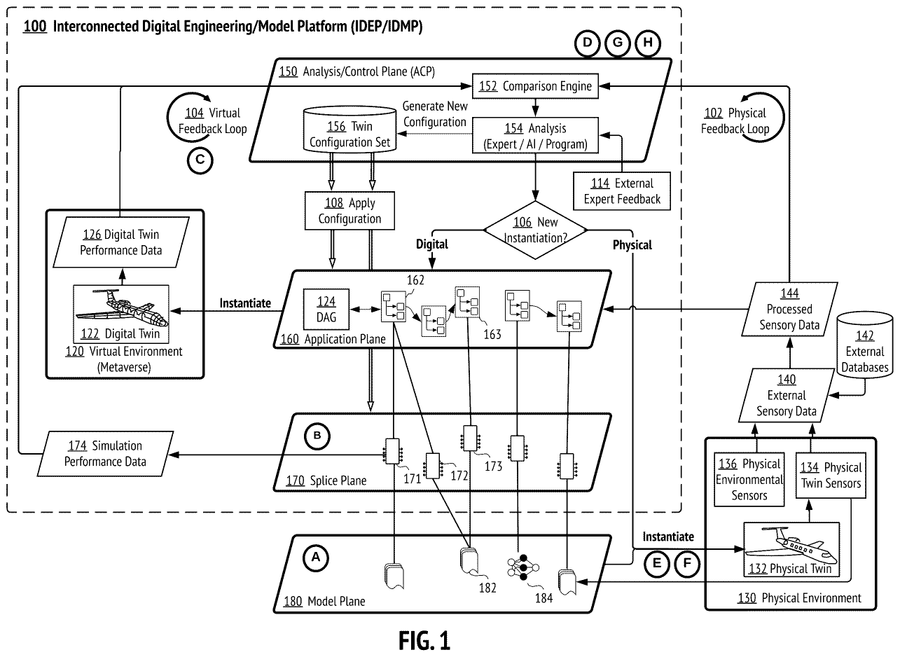

FIG. 1 shows an exemplary interconnected digital model platform (IDMP) architecture, in accordance with some embodiments of the present invention.

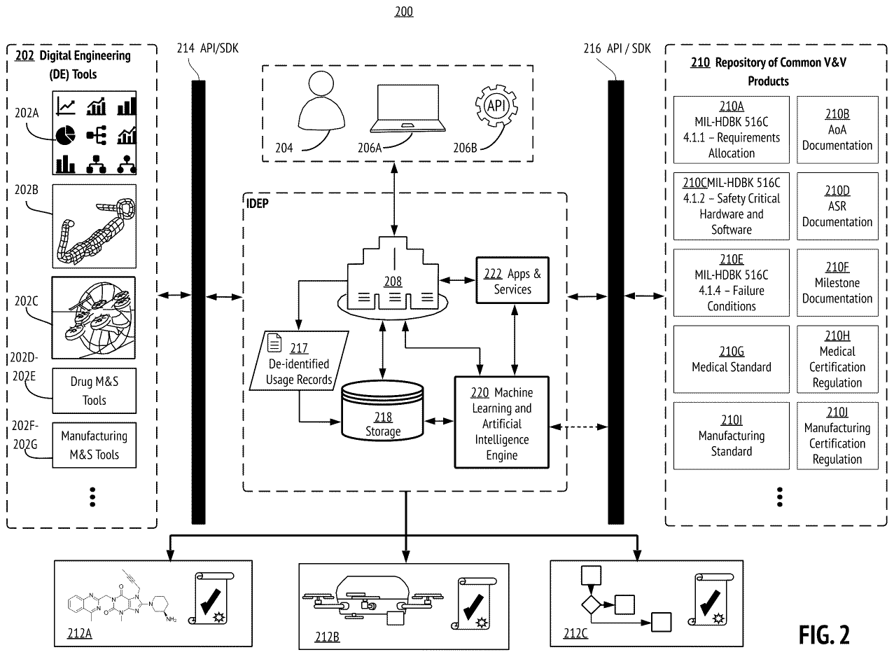

FIG. 2 shows an exemplary implementation of an IDEP as an interconnected digital engineering (DE) and certification ecosystem, and exemplary digitally certified products, in accordance with some embodiments of the present invention.

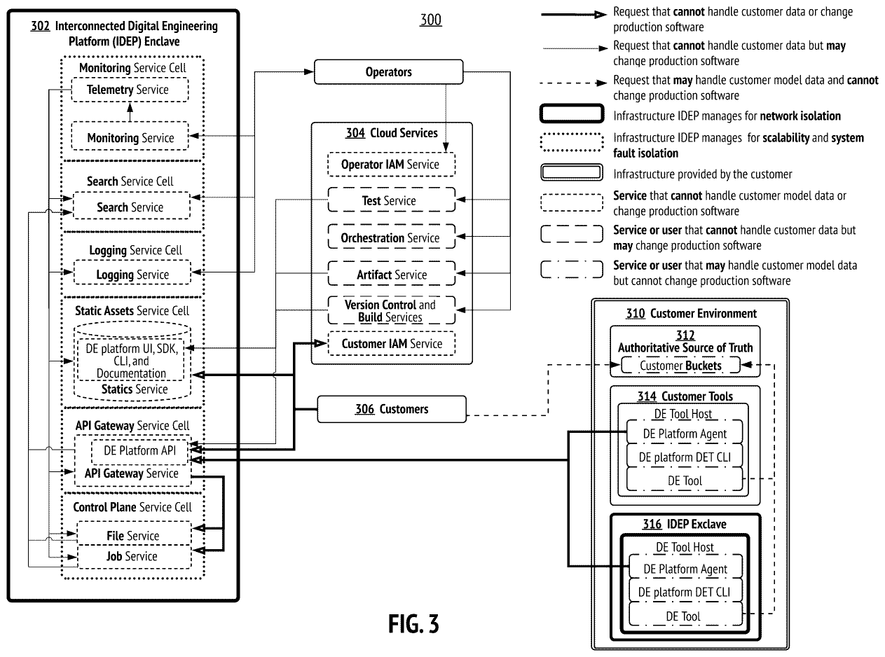

FIG. 3 shows another exemplary implementation of the IDEP illustrating its offered services and features, in accordance with some embodiments of the present invention.

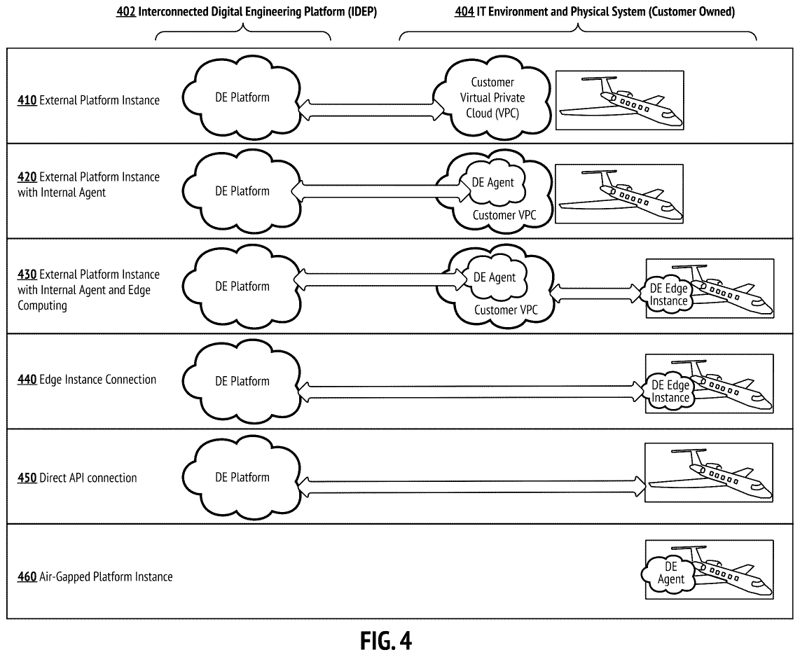

FIG. 4 shows potential scenarios for instantiating an IDEP in connection to a customer's physical system and IT environment, in accordance with some embodiments of the present invention.

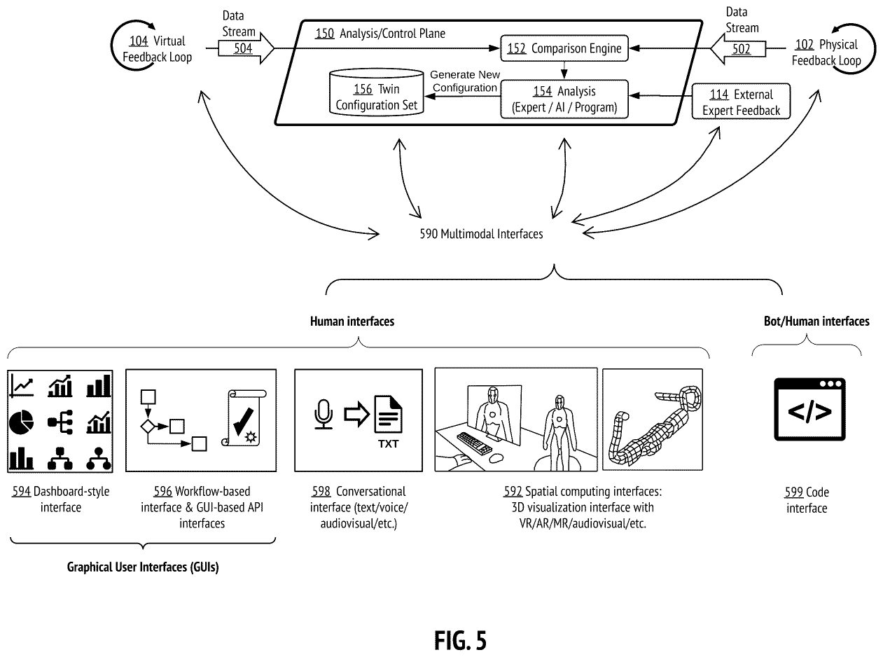

FIG. 5 shows exemplary multimodal interface designs for integration of feedback in an IDEP, in accordance with some embodiments of the present invention.

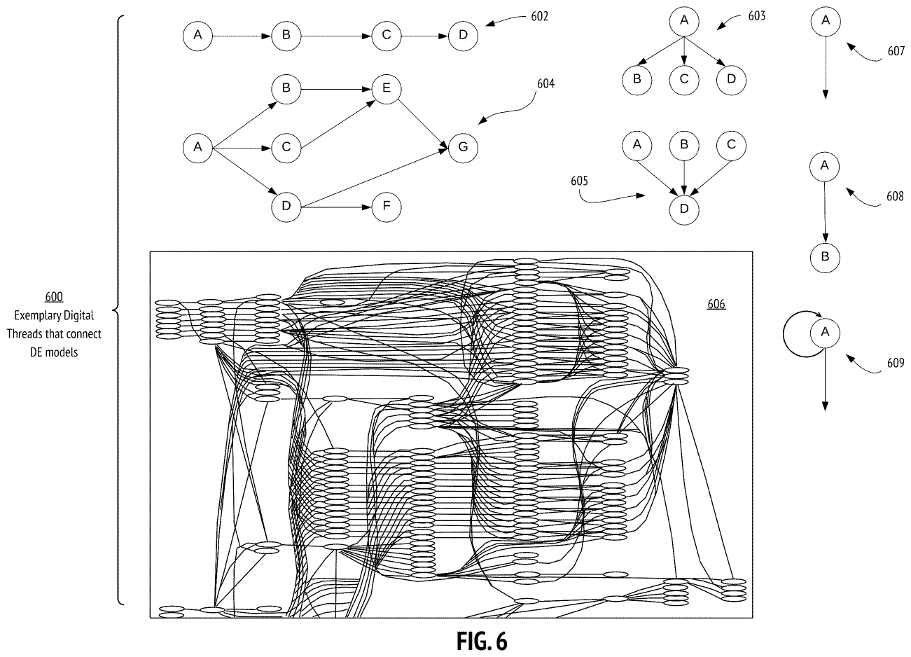

FIG. 6 is a schematic diagram comparing exemplary digital threads that connect DE models, in accordance with some embodiments of the present invention.

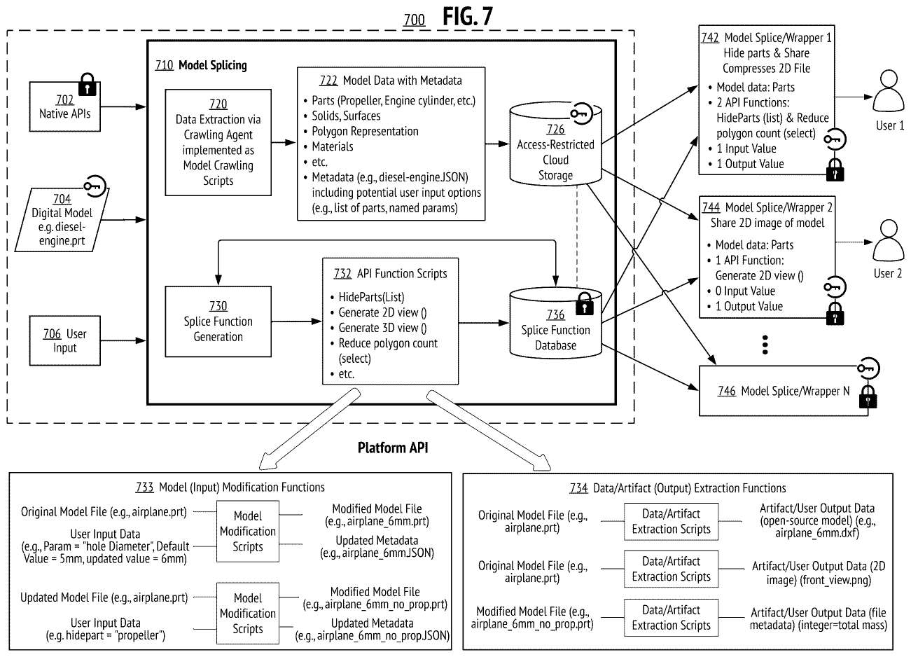

FIG. 7 is a schematic showing an exemplary DE model splicing setup, in accordance with some embodiments of the present invention.

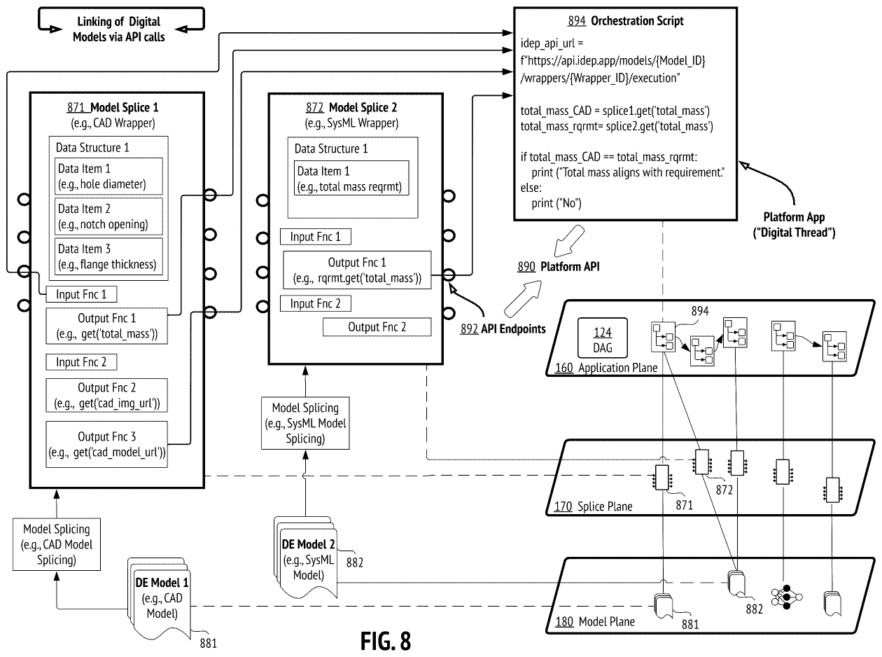

FIG. 8 is a schematic showing digital threading of DE models via model splicing, in accordance with some embodiments of the present invention.

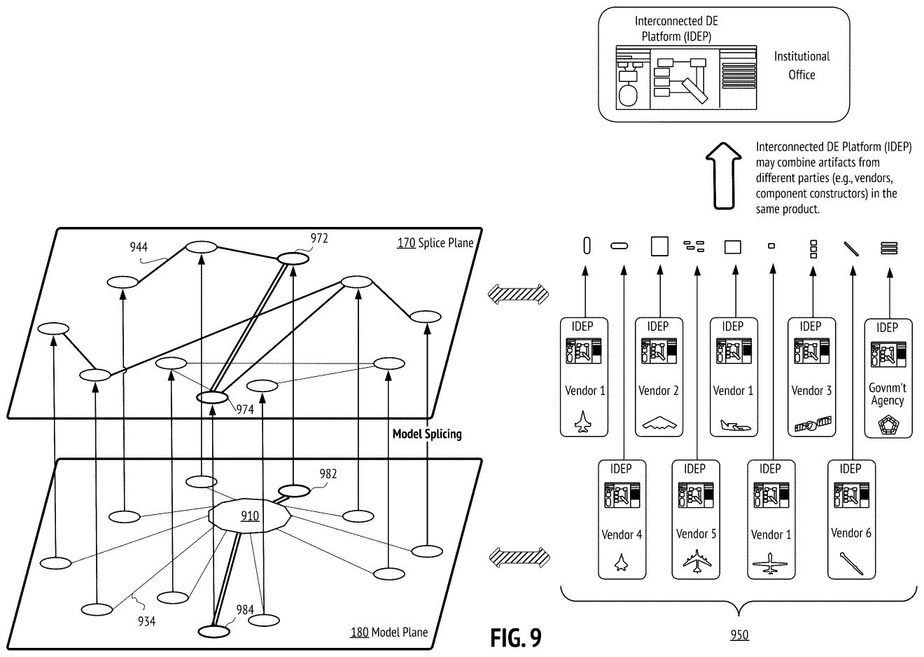

FIG. 9 is a schematic illustrating the linking of DE model splices in a splice plane and comparing digital threading with and without model splicing, in accordance with some embodiments of the present invention.

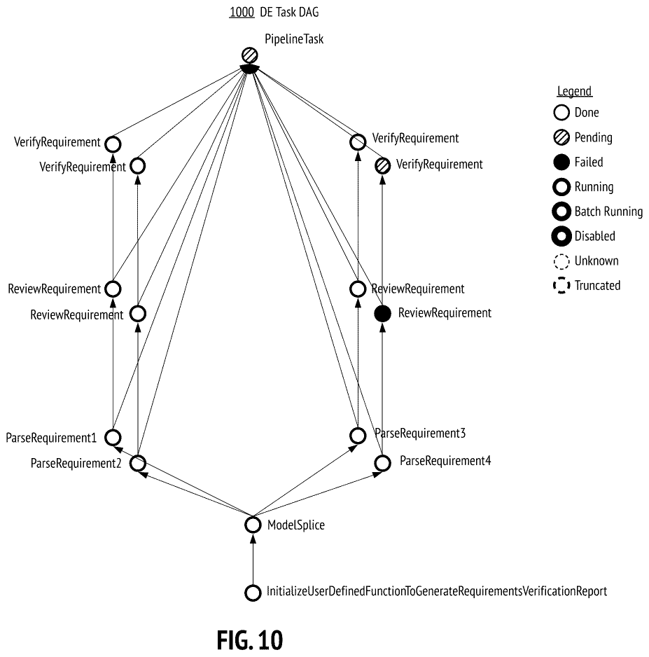

FIG. 10 shows an exemplary directed acyclic graph (DAG) representation of pipelined DE tasks related to digital threads, in accordance with some embodiments of the present invention.

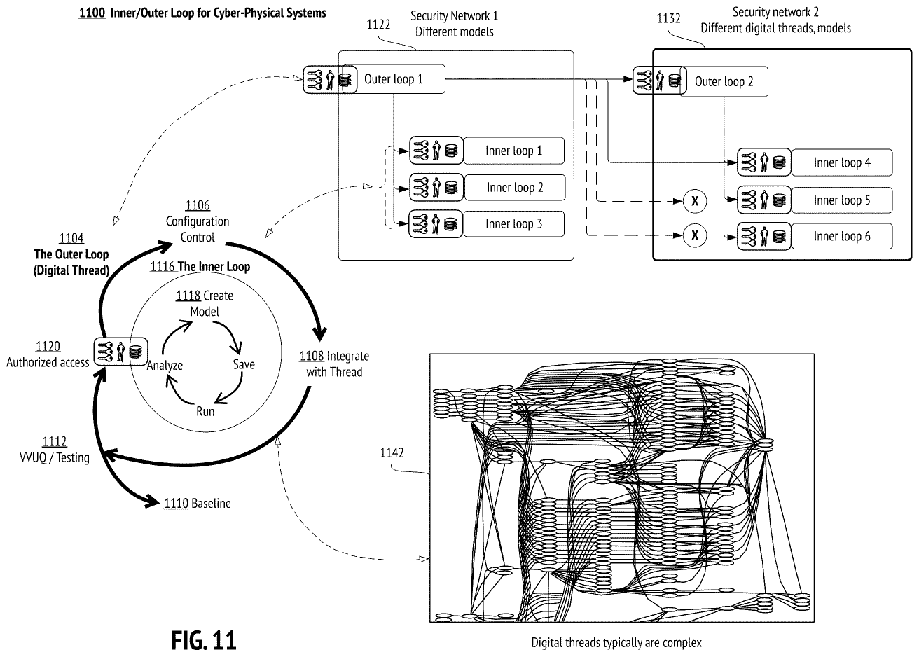

FIG. 11 is an exemplary schematic illustrating the interplay between a digital thread and the individual models or artifacts it uses, defining outer and inner loop processes, in accordance with some embodiments of the present invention.

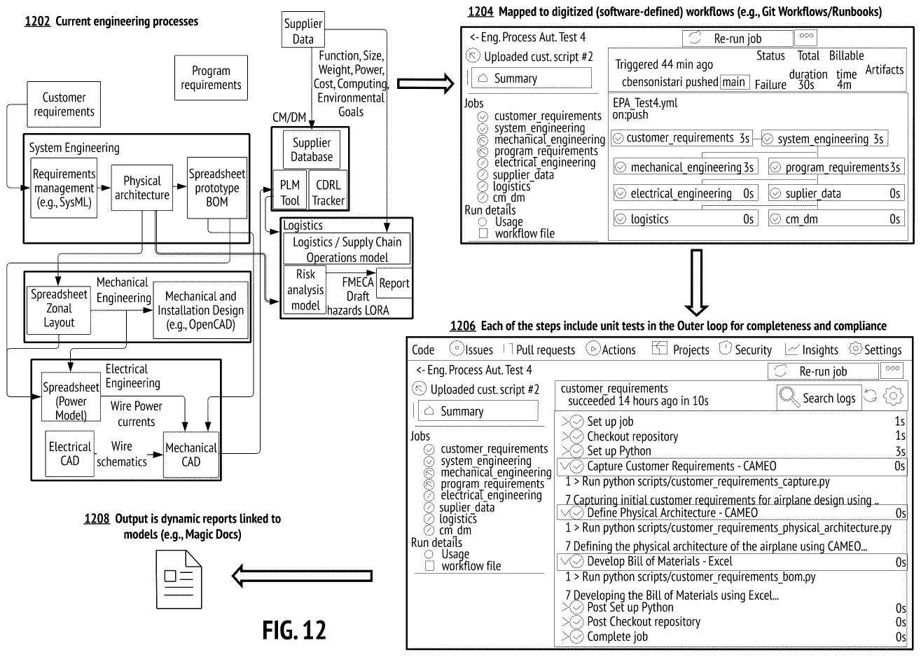

FIG. 12 illustrates an exemplary digital engineering process in the aerospace industry, showing outer loop processes, in accordance with some embodiments of the present invention.

End-to-End Workflow Integration within a Digital Model Platform

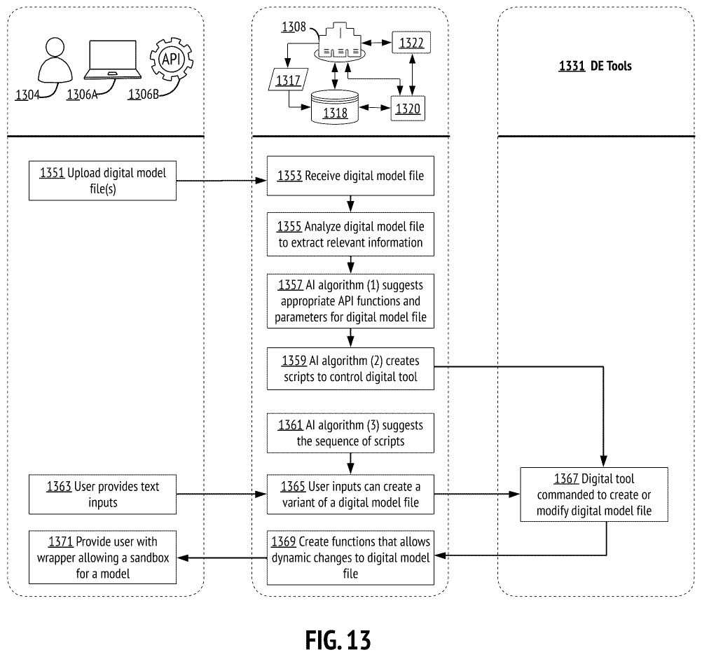

FIG. 13 shows an exemplary use case of AI assistance in model splicing an input Model-Based Systems Engineering (MBSE) model file and scalable sharing of the model, in accordance with some embodiments of the present invention.

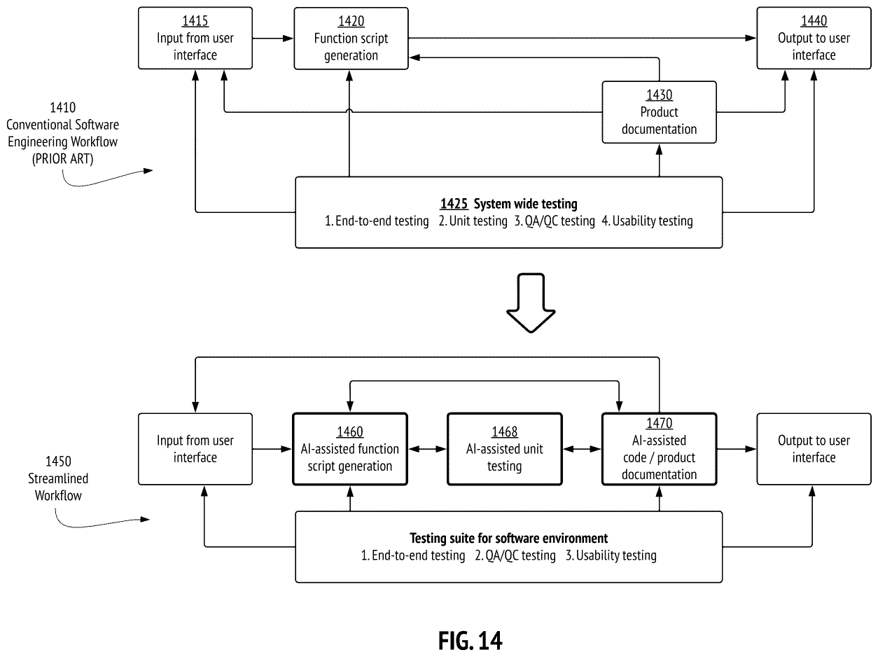

FIG. 14 shows an illustrative comparison between a conventional software engineering workflow and an AI-assisted, integrated workflow, in accordance with some embodiments of the present invention.

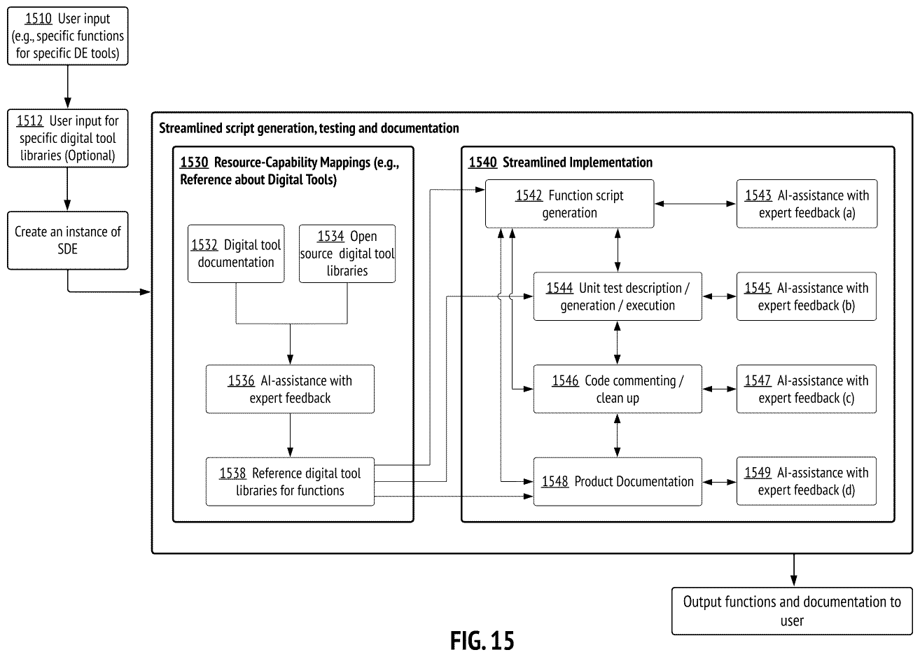

FIG. 15 shows an exemplary implementation architecture for an integrated DE software development workflow, in accordance with some embodiments of the present invention.

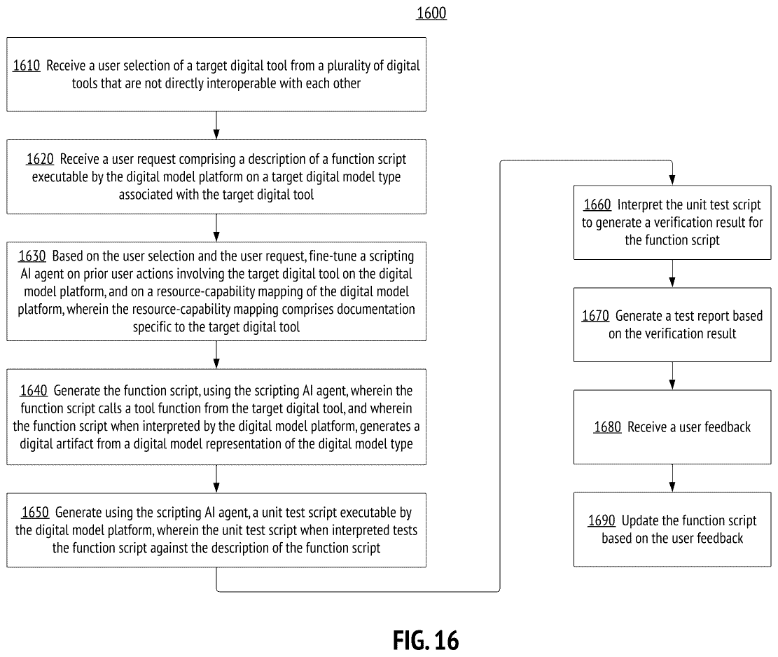

FIG. 16 is an exemplary flowchart showing a process for AI-assisted workflow integration for software development on the IDMP, in accordance with some embodiments of the present invention.

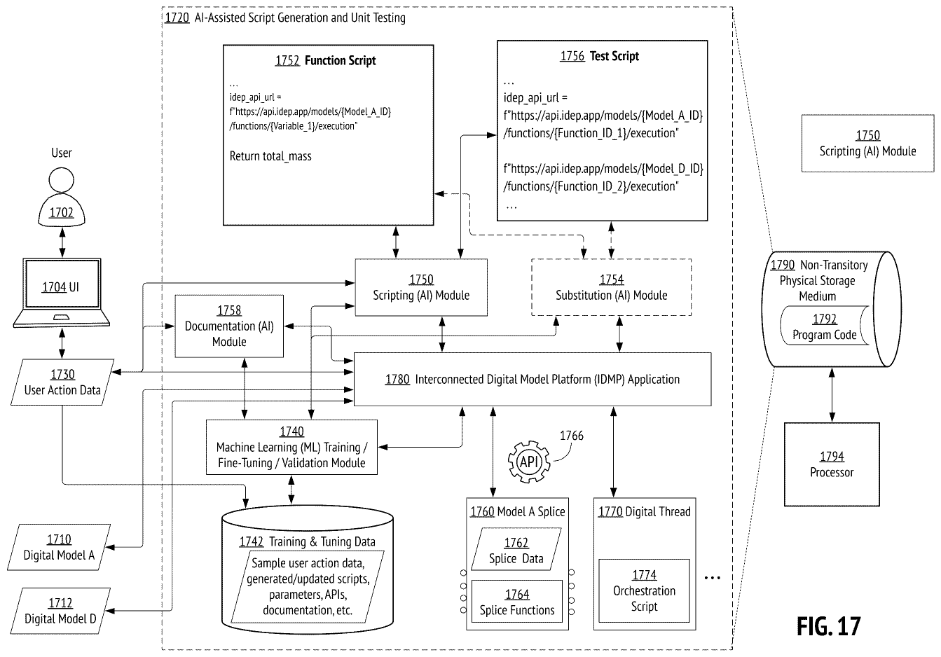

FIG. 17 is an exemplary system diagram for implementing a streamlined process for AI-assisted script generation related to a user request and corresponding unit testing in accordance with some embodiments of the present invention.

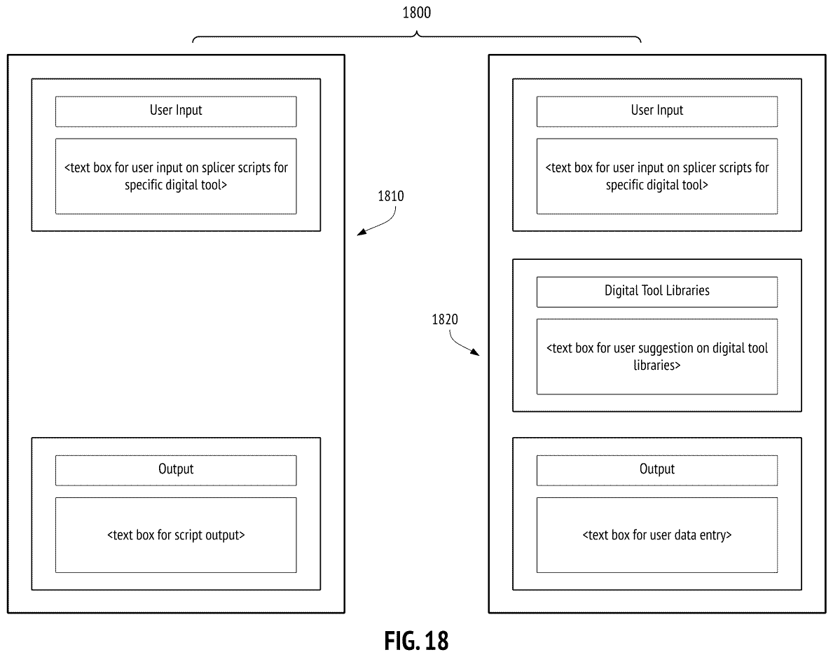

FIG. 18 shows illustrative user interface schematics for collecting user input and displaying script output, in accordance with some embodiments of the present invention.

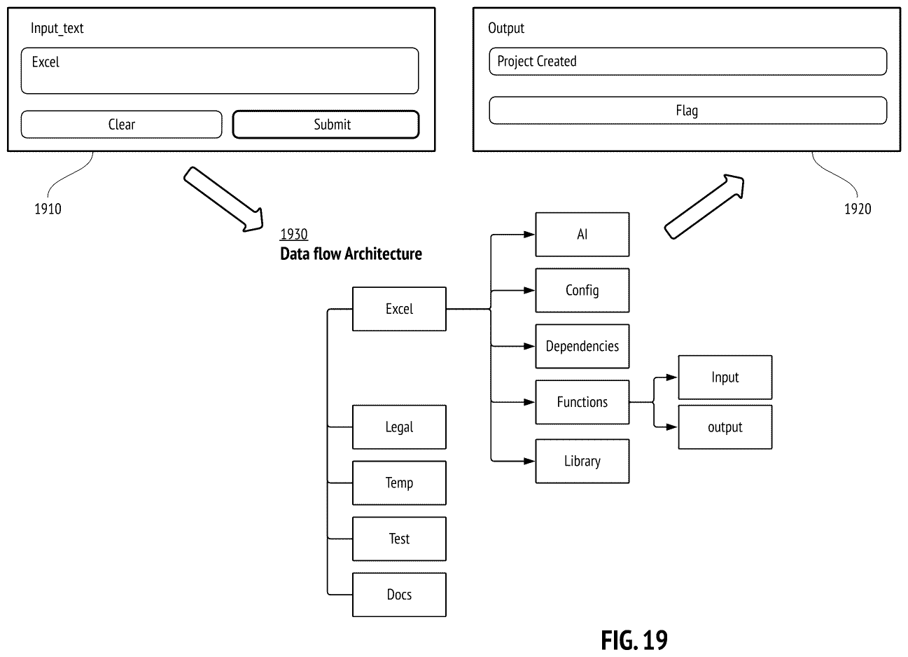

FIG. 19 shows another illustrative user interface for user input during function script generation, in accordance with some embodiments of the present invention.

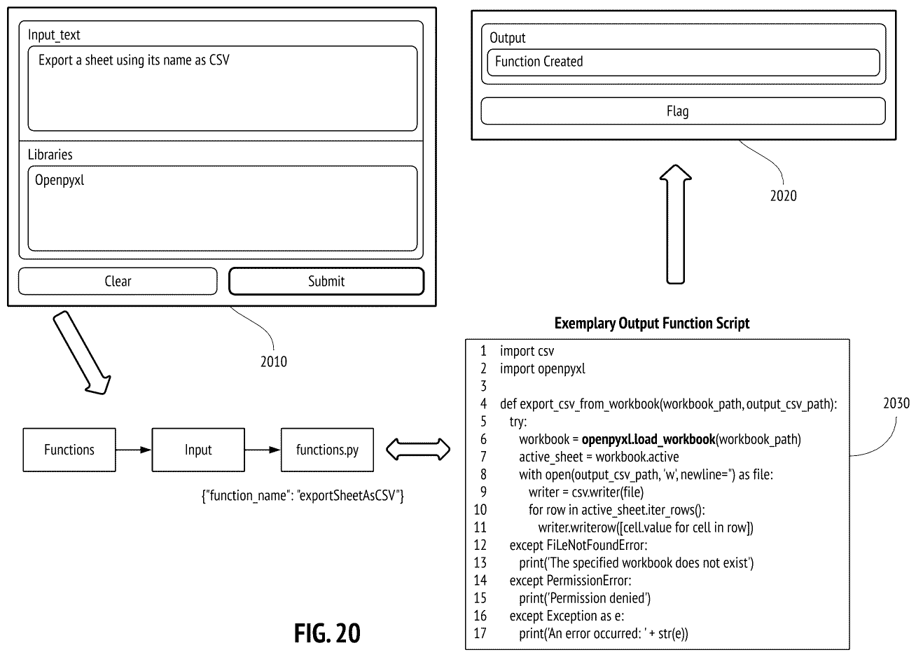

FIG. 20 shows an illustrative function script output generated according to a user-specified function script description and a user selection of a digital tool library, in accordance with some embodiments of the present invention.

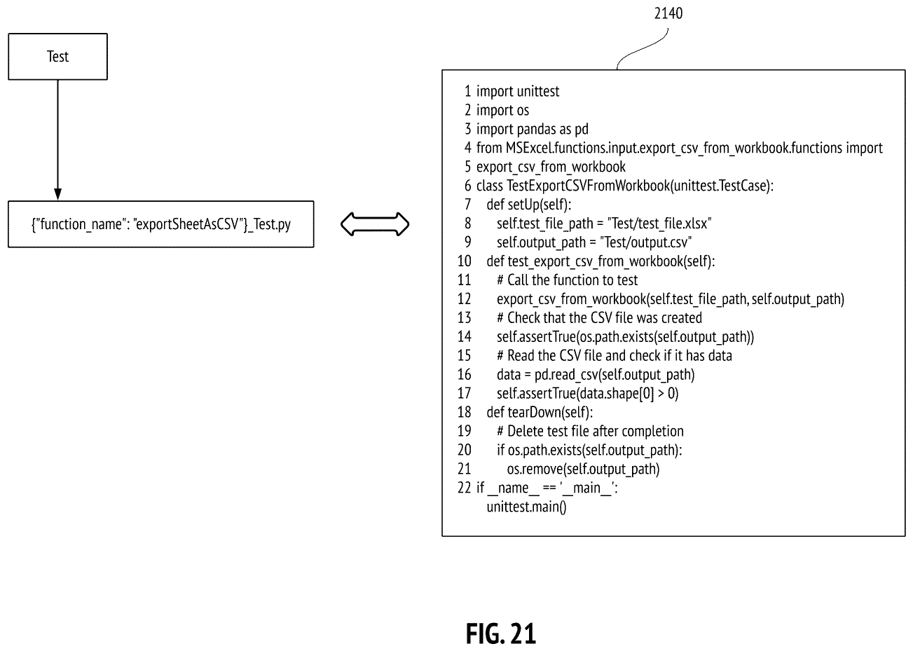

FIG. 21 shows an illustrative testing script output, in accordance with some embodiments of the present invention.

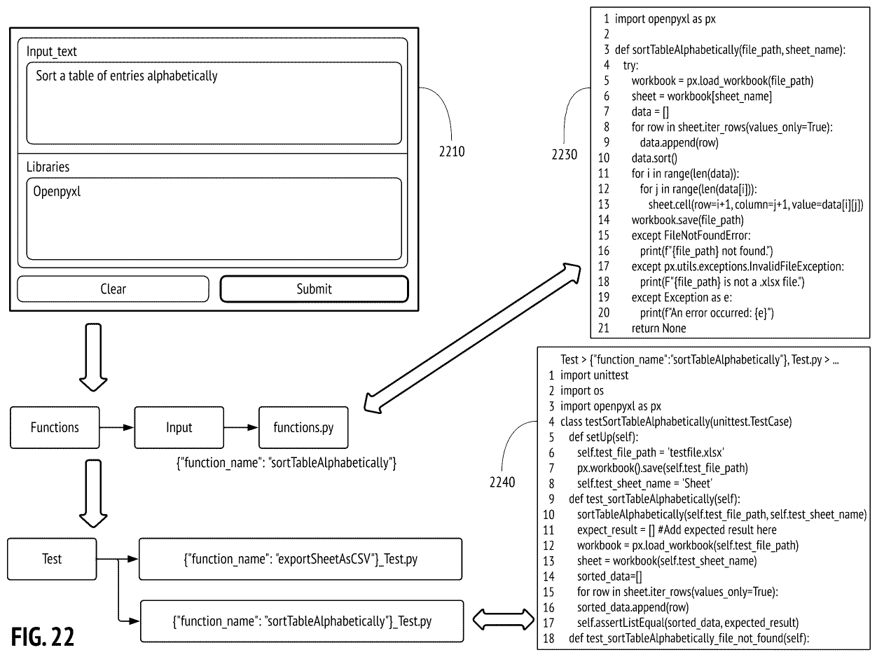

FIG. 22 shows another illustrative example of user input and correspondingly generated model splicer script and testing script, in accordance with some embodiments of the present invention.

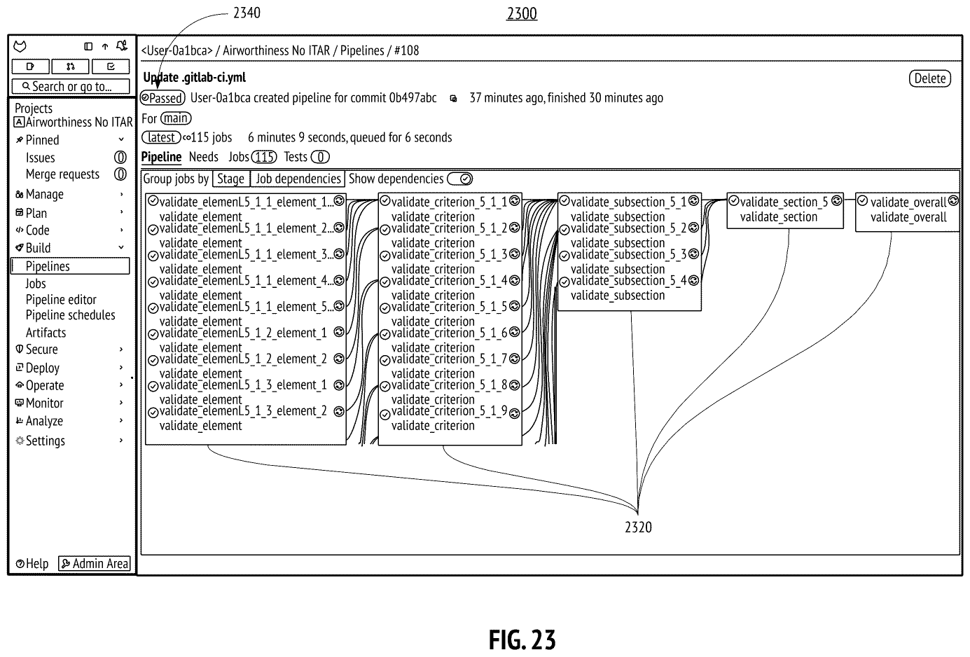

FIG. 23 is an exemplary screenshot illustrating inter-dependent validation tasks across a digital thread needed for end-to-end workflow validation, in accordance with some embodiments of the present invention.

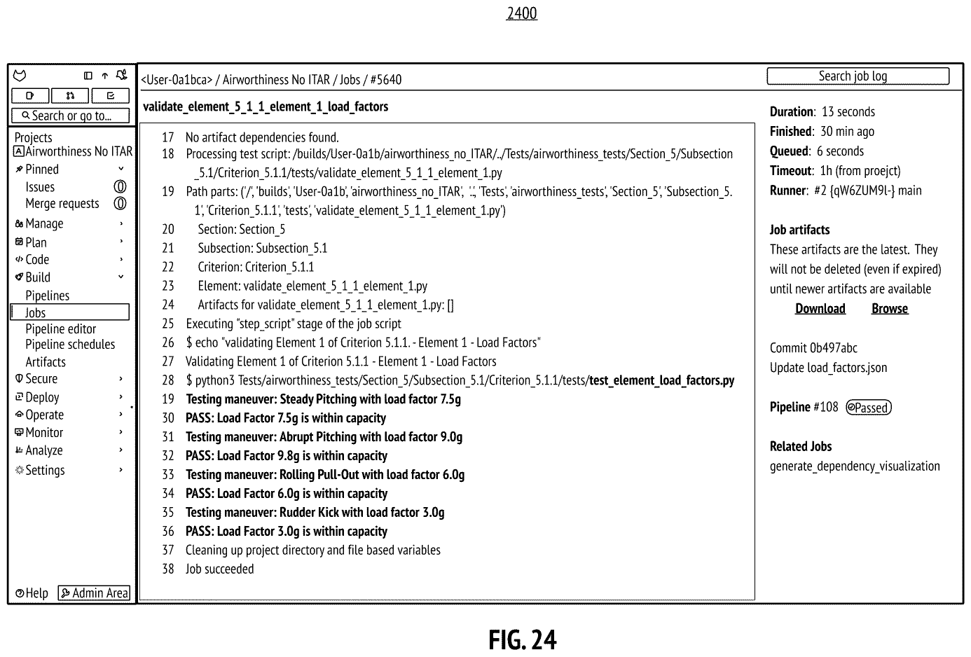

FIG. 24 is a screenshot of an exemplary execution log for a validation task shown in FIG. 23, in accordance with some embodiments of the present invention.

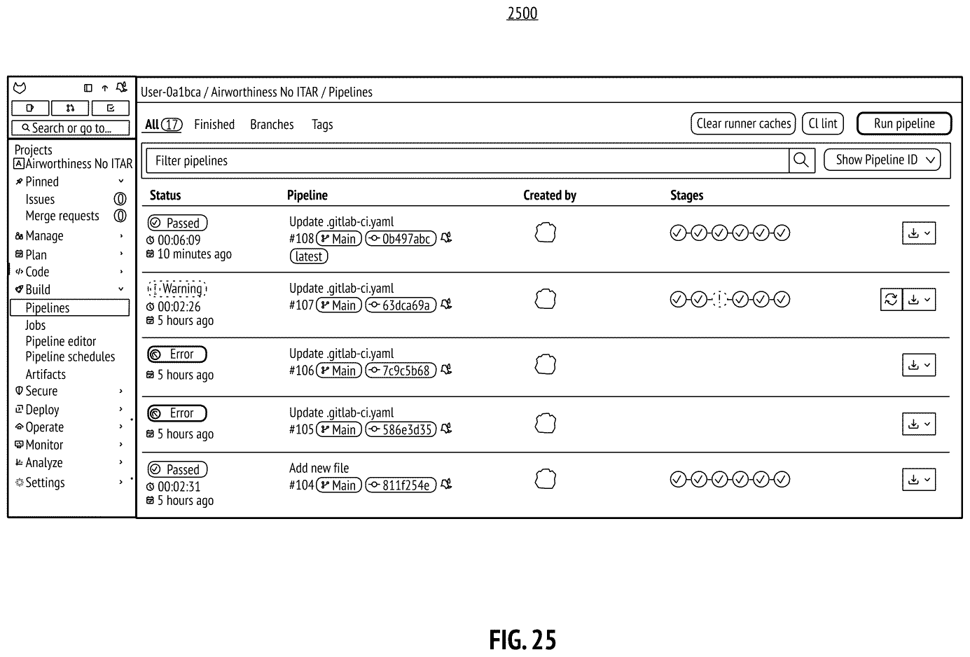

FIG. 25 is a screenshot of an exemplary validation report for jobs shown in FIG. 23, in accordance with some embodiments of the present invention.

### AI-Assisted Digital Model Splicer and Function Script Generation

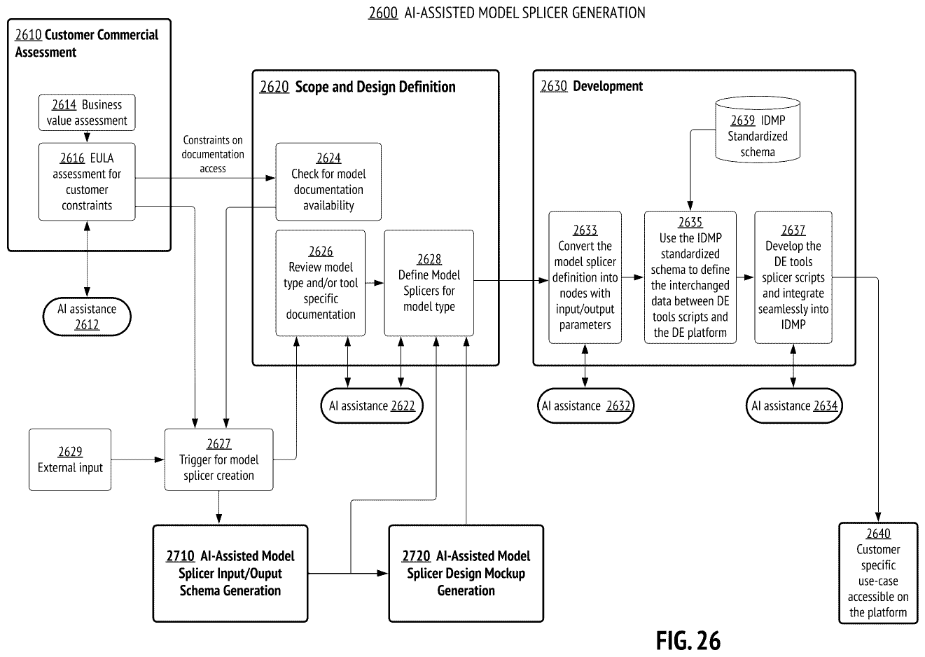

FIG. 26 is a schematic showing an exemplary implementation of AI-assisted model splicer generation or update, in accordance with some embodiments of the present invention.

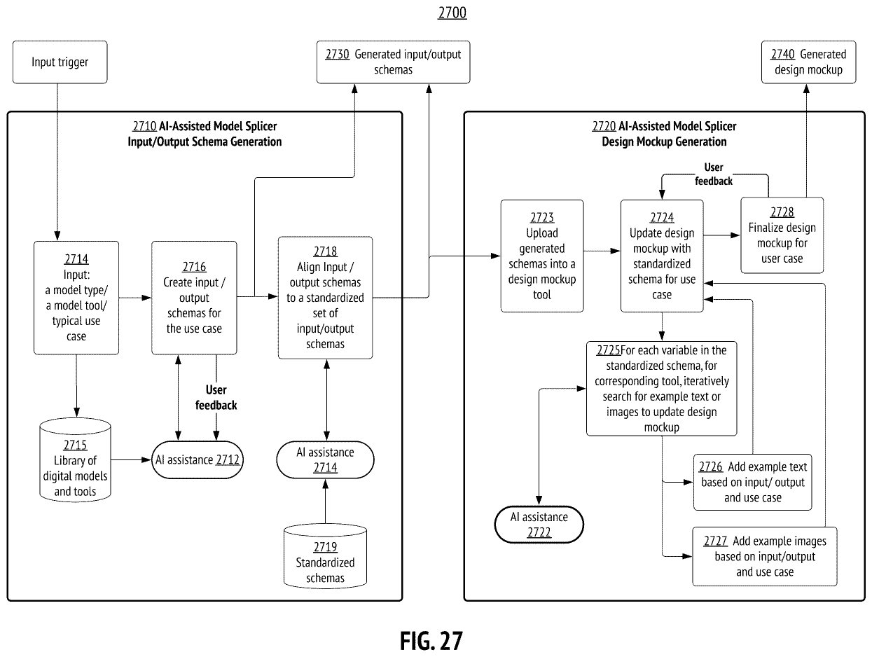

FIG. 27 a schematic showing an exemplary AI-assisted model input/output schema generation module in an IDMP, and a corresponding AI-assisted model splicer design mockup generation module, in accordance with some embodiments of the present invention.

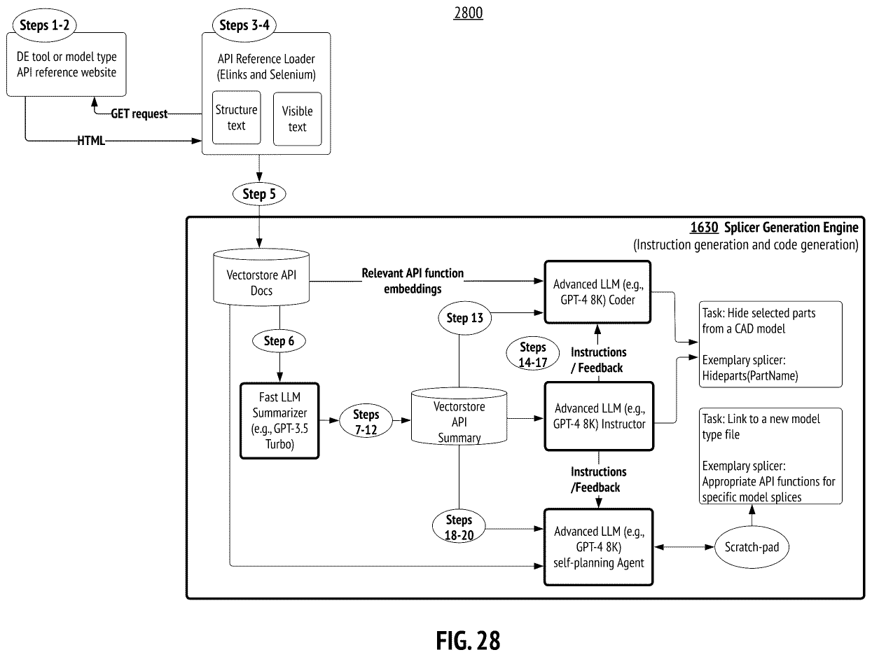

FIG. 28 shows an exemplary open-source LLM implementation of AI-assisted function script generation in a model splicer generation engine, in accordance with some embodiments of the present invention.

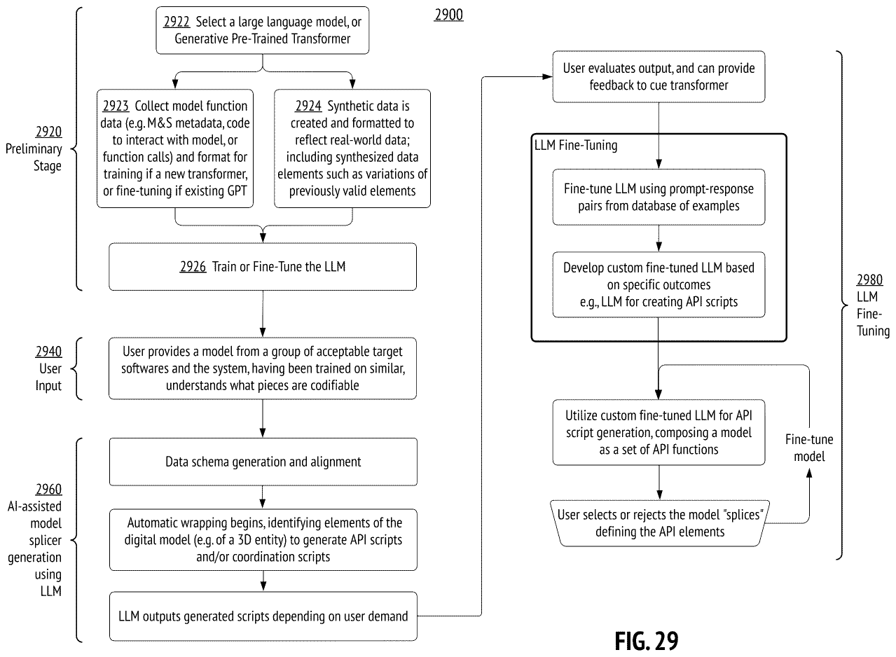

FIG. 29 shows an exemplary process for model splicer generation via Large Language Models (LLMs) directly, with prompt-response fine-tuning, in accordance with some embodiments of the present invention.

### AI-Assisted Testing and Documentation

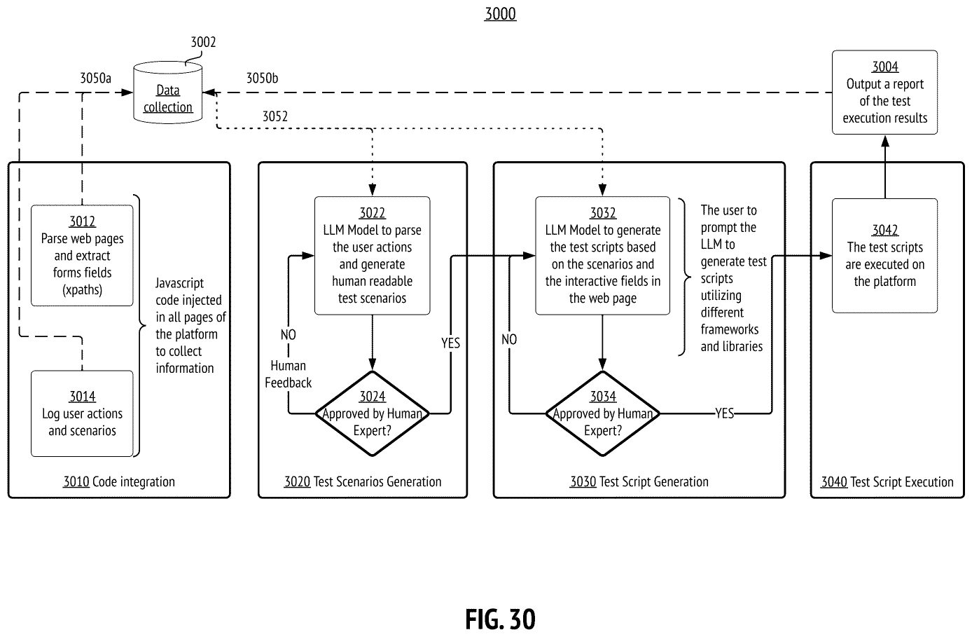

FIG. 30 illustrates a process for AI-assisted testing within the IDMP, in accordance with some embodiments of the present invention.

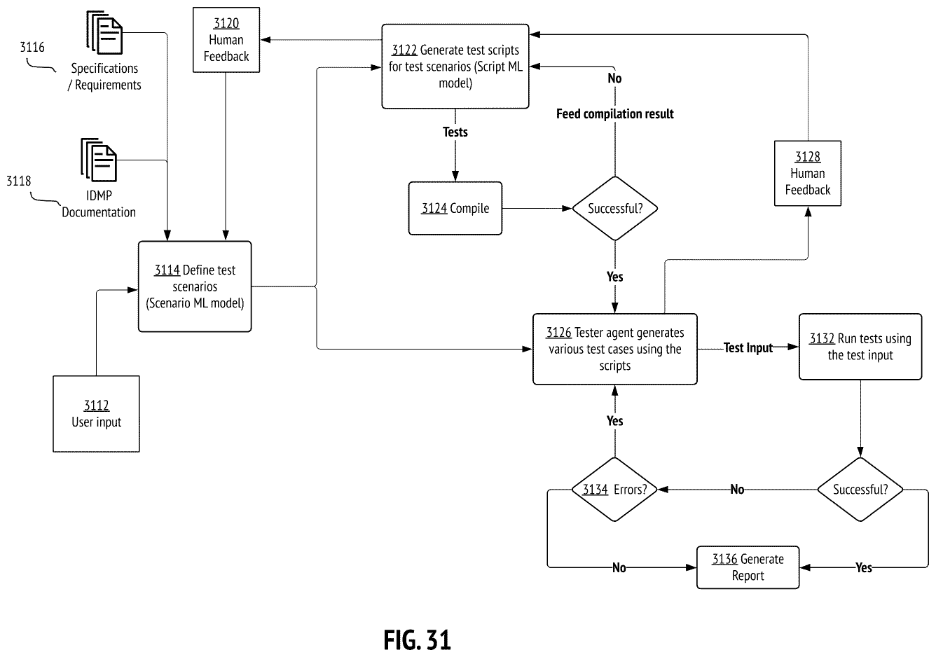

FIG. 31 illustrates a process for AI-assisted testing within the IDMP, in accordance with some embodiments of the present invention.

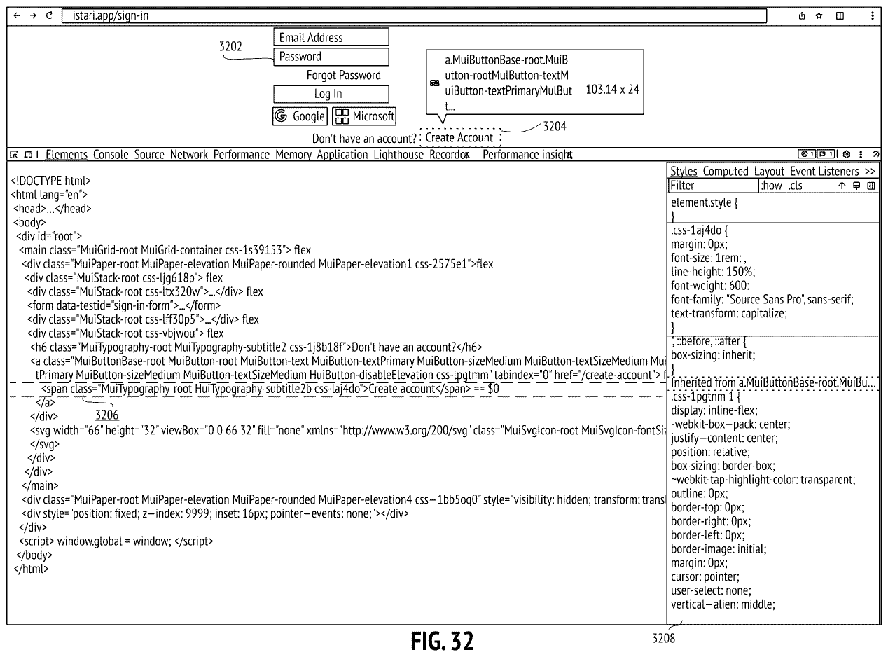

FIG. 32 shows a developer screen illustrating a user action (“Create Account”) interface and corresponding HTML code, in accordance with some embodiments of the present invention.

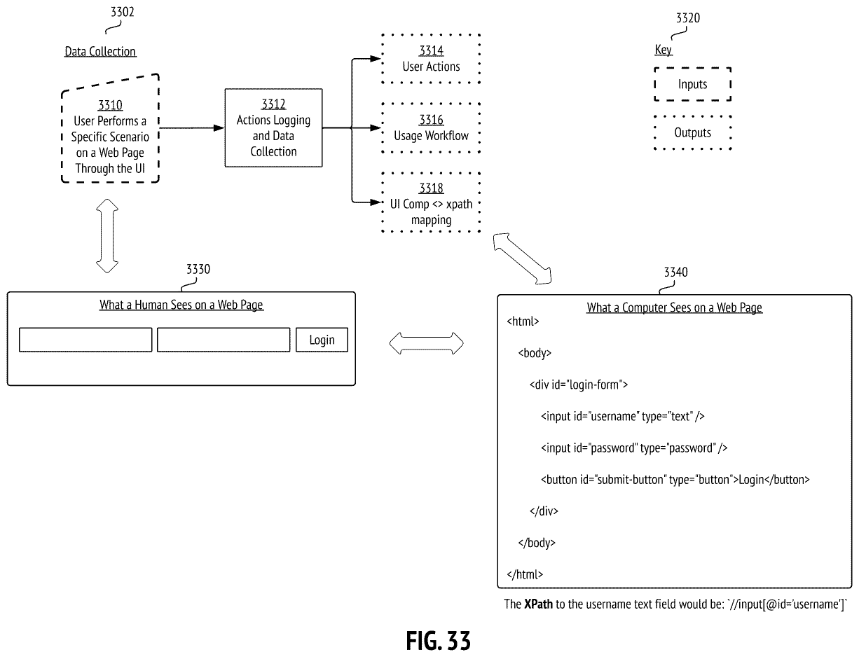

FIG. 33 illustrates data collection for AI-enabled testing, in accordance with some embodiments of the present invention.

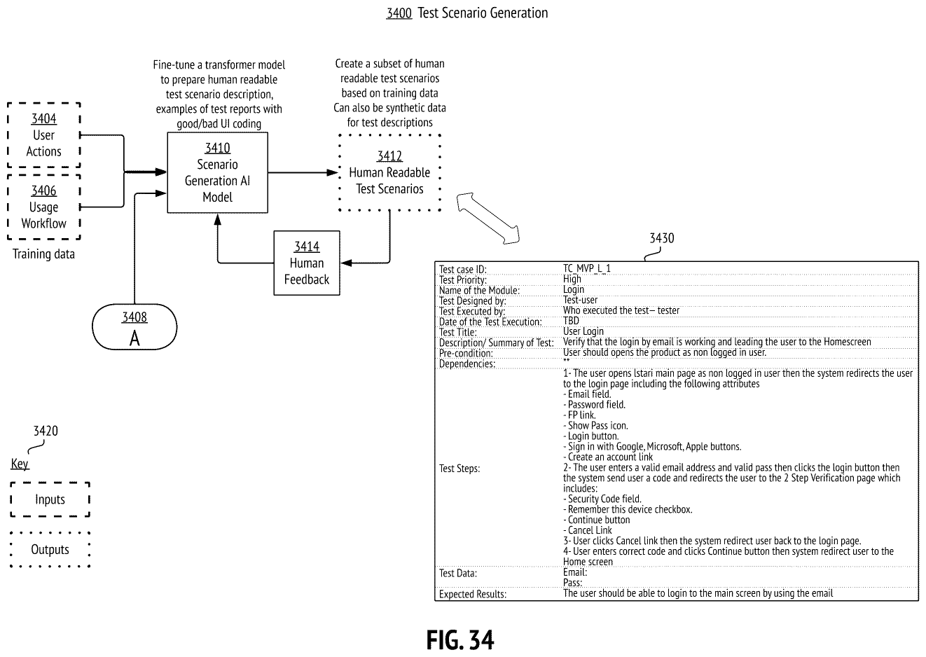

FIG. 34 illustrates an exemplary process for AI-enabled test scenario generation, in accordance with some embodiments of the present invention.

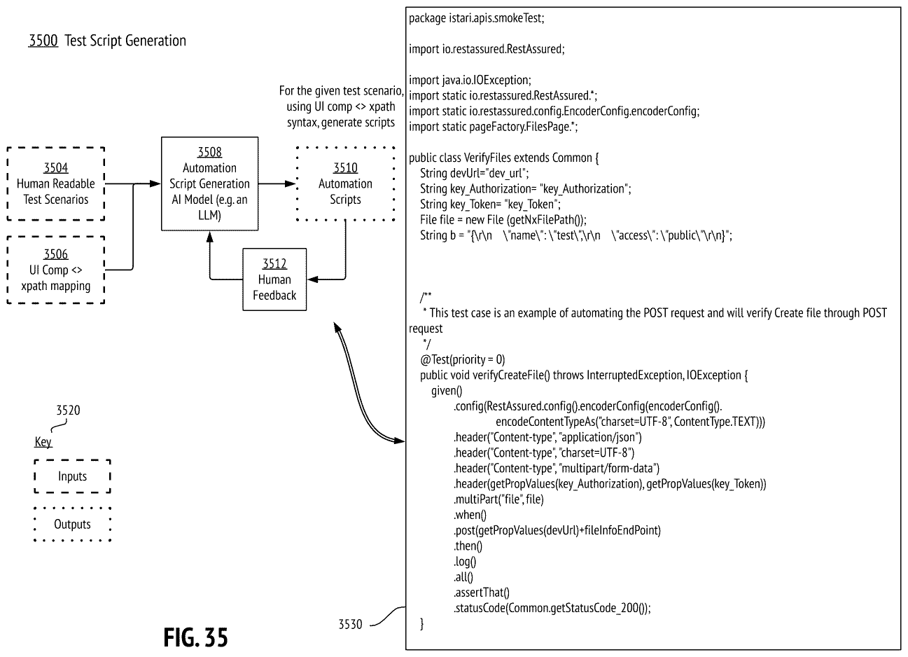

FIG. 35 shows an illustrative process for AI-assisted test script generation, in accordance with embodiments of the present invention.

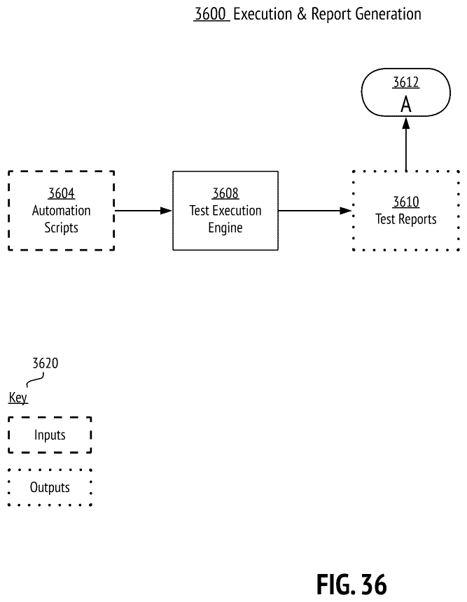

FIG. 36 illustrates test script execution and report generation, in accordance with some embodiments of the present invention.

### Machine Learning Implementation Architecture for IDEP/IDMP Operations

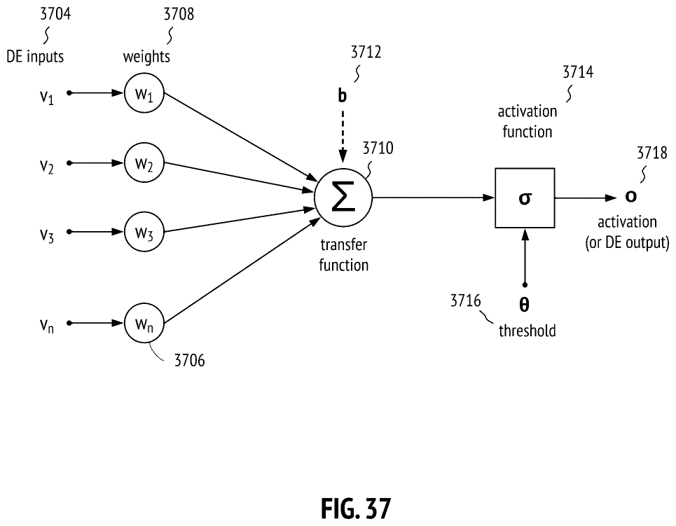

FIG. 37 describes neural network operation fundamentals, in accordance with some embodiments of the present invention.

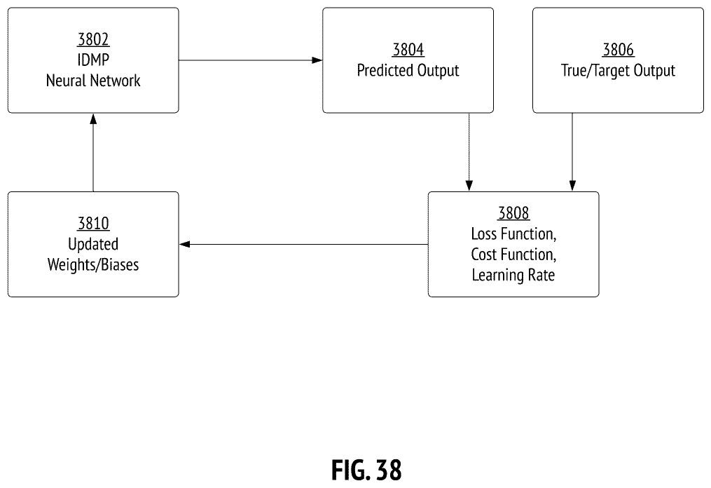

FIG. 38 shows an overview of an IDMP neural network training process, in accordance with some embodiments of the present invention.

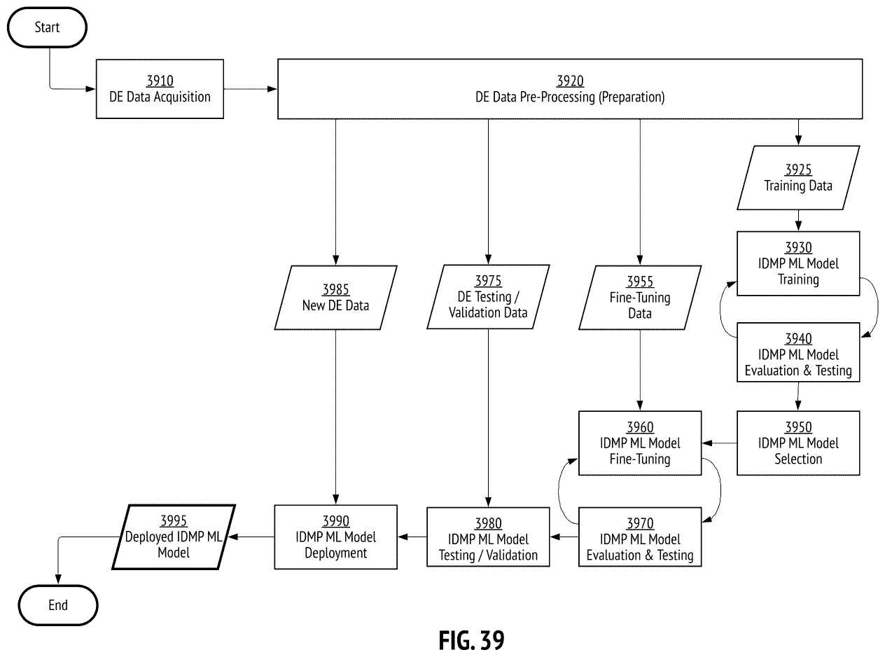

FIG. 39 is an illustrative flow diagram showing the different phases and datasets involved in training an IDMP machine learning model, in accordance with some embodiments of the present invention.

### Hardware and Software Architecture for IDEP/IDMP Operations

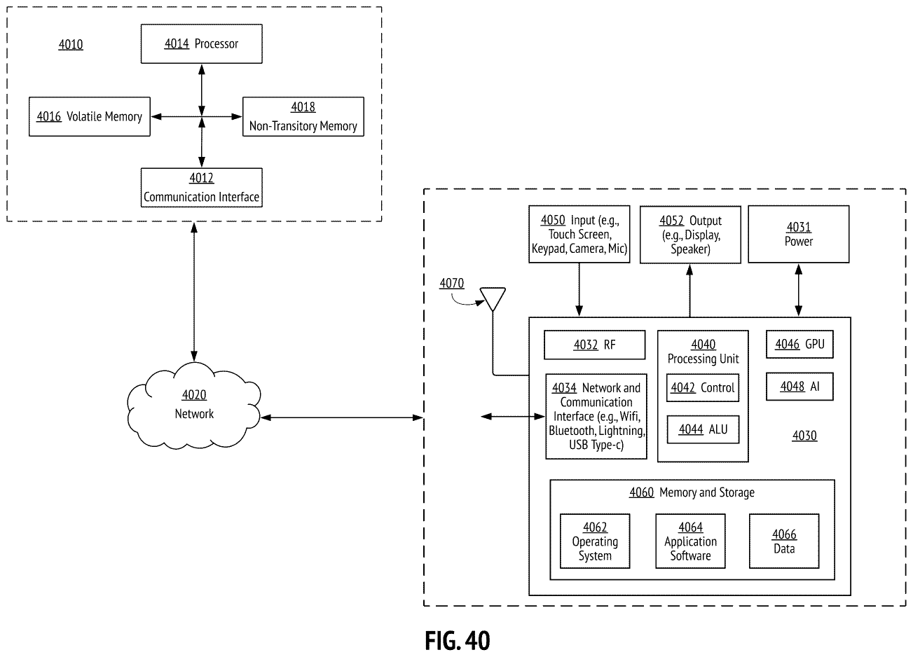

FIG. 40 provides illustrative schematics of a server (management computing entity) and a client (user computing entity) used for documentation within an IDMP, in accordance with some embodiments of the present invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, methods, and processes are shown using schematics, use cases, and/or diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, the present invention relates to methods and systems for an artificial intelligence (AI)-assisted approach to integrate discrete workflows for software development within a digital model platform. This integrated workflow streamlines script generation, unit testing, and documentation, encompassing several interdependent stages of the software development process. These stages include one or more of digital model-specific or digital tool-specific function script generation, digital thread orchestration script generation, test script generation, script execution, revision, reporting, and comprehensive software documentation including commenting and annotation, each of which may be enhanced by AI assistance. By enabling the integration of these stages into a cohesive, unified, end-to-end workflow, embodiments of the invention allow smoother transitions between developmental stages, mitigating discrepancies and misalignments that may arise from traditional disconnected workflows during software development, ensuring efficient utilization of human SMEs” time while assisting with the inclusion of new digital model types or new digital tools, even when such new digital tools are non-interoperable with existing ones on the digital model platform.

Specifically, the methods and systems described herein leverage AI-assistance in a code-based digital model platform to implement, integrate, and streamline one or more of the following software development stages:
(a) digital model splice function script generation and/or digital thread orchestration script generation;
(b) unit test scenario and/or unit test script generation;
(c) unit test execution;
(d) preparation of test reports upon execution of unit test scripts.

Further after scripts and associated unit tests are created and verified to be correct, AI-assistance may be used to:
(e) comment/annotate the code;
(f) generate customer-facing technical product documentations.

With reference to the figures, embodiments of the present invention are now described in detail. First, an interconnected digital model platform (IDMP) and its digital engineering embodiment (IDEP) are explained in detail. Then, digital splicing and threading operations enabling splicer function script and orchestration script generation are described in detail. Finally, the phases of script generation, unit testing, testing report generation and end-user documentation are detailed.

### Terminology

Some illustrative terminologies used herein are provided at the end of this document to assist in understanding the present invention, but these are not to be read as restricting the scope of the present invention. The terms may be used in the form of nouns, verbs, or adjectives, within the scope of the definition.

### An Interconnected Digital Model Platform (IDMP) Architecture

FIG. 1 shows an exemplary interconnected digital model platform (IDMP) architecture, in accordance with some embodiments of the present invention. In the context of digital engineering (DE), IDMP 100 streamlines the process of product development from conception to production, by using a virtual representation or digital twin (DTw) 122 of the product to optimize and refine features before building a physical prototype or physical twin (PTw) 132, and to iteratively update DTw 122 until DTw 122 and PTw 132 are in sync to meet the product's desired performance goals. In what follows, the terms IDMP and IDEP are used interchangeably, as an interconnected digital engineering platform (IDEP) is a representative type of IDMPs.

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDMP platform 100 to develop a new product. The engineering team from the manufacturer may create or instantiate digital twin (DTw) 122 of the product in a virtual environment 120, encompassing detailed computer-aided design (CAD) models and finite element analysis (FEA) or computational fluid dynamics (CFD) simulations of component systems such as fuselage, wings, engines, propellers, tail assembly, and aerodynamics. DTw 122 represents the product's design and performance characteristics virtually, allowing the team to optimize and refine features before building a physical prototype 132 in a physical environment 130. In some embodiments, PTw 132 may be an existing entity, while DTw 122 is a digital instance that replicates individual configurations of PTw 132, as-built or as-maintained. In the present disclosure, for illustrative purposes only, DTw 122 and PTw 132 are discussed in the context of building a new product, but it would be understood by persons of ordinary skill in the art that the instantiation of DTw 122 and PTw 132 may take place in any order, based on the particular use case under consideration.

Digital models (e.g., CAD models, FEA models, CFD models) used for creating DTw 122 are shown within a model plane 180 in FIG. 1. Also shown in model plane 180 is a neural network (NN) model 184, which may provide machine-learning based predictive modeling and simulation for a DE process. A DE model such as 182 may be spliced into one or more model splices, such as 172 and 173 within a splice plane 170. Individual DTws such as 122 are instantiated from splice plane 170 via an application plane 160. A model splice such as 172 may be linked to another model splice such as 171 by a platform script or application 162 on application plane 160 into a digital thread. Multiple digital threads such as 162 and 163 may be further linked across different stages or phases of a product life cycle, from concept, design, testing, to production. Digital threads further enable seamless data exchange and collaboration between departments and stakeholders, ensuring optimized and validated designs.

As model splicing provides input and output splice functions that can access and modify DE model data, design updates and DE tasks associated with the digital threads may be represented by scripted, interconnected, and pipelined tasks arranged in Directed Acyclic Graphs (DAGs) such as 124. A DE task DAG example is discussed in further detail with reference to FIG. 10.

To enhance the design, external sensory data 140 may be collected, processed, and integrated into application plane 160. This process involves linking data from different sources, such as physical sensors 134 on prototype 132, physical environmental sensors 136, and other external data streams such as simulation data from model plane 180. API endpoints provide access to digital artifacts from various environments (e.g., physical twin (PTw) sensor 134 data) and integrate them into the spliced plane 170 for the DTw 122. Model splices on the splice plane 170 enable autonomous data linkages and digital thread generation, ensuring DTw 122 accurately represents the product's real-world performance and characteristics.

To validate DTw 122's accuracy, the engineering team may build or instantiate PTw 132 based on the same twin configuration (i.e., digital design). Physical prototype 132 may be equipped with numerous sensors 134, such as accelerometers and temperature sensors, to gather real-time performance data. This data may be compared with the DTw's simulations to confirm the product's performance and verify its design.

Processed sensory data 144 may be used to estimate parameters difficult to measure directly, such as aerodynamic forces or tire contact patch forces. Such processed sensory data provide additional data for DTw 122, further refining its accuracy and reliability. Processed sensory data 144 may be generated from physical environment sensors 136 with physical environment 130, and may be retrieved from other external databases 142, as discussed below.

During development, feedback from customers and market research may be collected to identify potential improvements or adjustments to the product's design. At an analysis & control plane (ACP) 150, subject matter experts (SMEs) may analyze processed sensory data 144 and external expert feedback 114, to make informed decisions on necessary design changes. Such analysis may be done by an analysis module 154, and may be enhanced or entirely enabled by algorithms (i.e., static program code) or artificial intelligence (AI) modules. Linking of digital threads such as 162, physical sensors 134 and 136, processed sensory data 144, and expert feedback data 114 occurs at ACP 150, where sensor and performance data is compared, analyzed, leading to modifications of the underlying model files through digital threads. Within the ACP 150, the analysis module 154 may carry out testing of the product. Additionally, testing of the twin configuration set 156, which includes feature testing, may occur in the connection between the analysis module 154 and the twin configuration set 156.

In particular, sensory data 144 from physical environment 130 and performance data 126 from virtual environment 120 may be fed into a comparison engine 152. Comparison engine 152 may comprise tools that enable platform users to compare various design iterations with each other and with design requirements, identify performance lapses and trends, and run verification and validation (V&V) tools.

Model splicing is discussed in further detail with reference to FIGS. 7 to 9. Model splicing enables the scripting of any DE operation involving DE model files in model plane 180, where each DE model is associated with disparate and siloed DE tools. Codification of DE models and DE operations with a unified corpus of scripts enable IDMP 100 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 182, 184) associated with a given product within the same interconnected platform or ecosystem 100. As a consequence, the generation and training of AI modules for the purpose of manipulating DE models (e.g., 182), digital threads (e.g., 162), and digital twins (e.g., 122) become possible over the programmable and unified IDMP 100.

### Virtual and Physical Feedback Loops

FIG. 1 uses letter labels “A” to “H” to denote different stages of a product's lifecycle. At each stage, IDMP 100 enables feedback loops whereby data emanating from a PTw or a DTw is analyzed at ACP 150, leading to the generation of a new twin configuration based on design modifications. The new twin configuration may be stored in a twin configuration set and applied through the application and splice planes, yielding modified model files that are registered on the digital thread.

A virtual feedback loop 104 starts with a decision 106 to instantiate new DTw 122. A DAG of hierarchical tasks 124 allows the automated instantiation of DTw 122 within virtual environment 120, based on a twin configuration applied at a process step 108 from a twin configuration set 156. DTw 122 and/or components thereof are then tested in virtual environment 120, leading to the generation of DTw performance data 126. Concurrently, DTw 122 and/or components thereof may be tested and simulated in model plane 180 using DE software tools, giving rise to test and simulation performance data 174. Performance data 126 and 174 may be combined, compared via engine 152, and analyzed at ACP 150, potentially leading to the generation and storage of a new twin configuration. The eventual decision to instantiate a DTw from the new twin configuration completes virtual feedback loop 104.

A physical feedback loop 102 starts with a decision 106 to instantiate a new PTw 132. PTw 132 may be instantiated in a physical environment 130 from the model files of model plane 180 that are associated with an applied twin configuration from the twin configuration set 156. PTw 132 and/or components thereof are then tested in physical environment 132, leading to the generation of sensory data from PTw sensors 134 and environmental sensors 136 located in physical environment 130. This sensory data may be combined with data from external databases to yield processed sensory data 144. In one exemplary embodiment, temperature readings from environmental sensors located within the physical environment are completed, adjusted (e.g., shifted), and/or calibrated using data from external temperature databases.

Data from PTw sensors 134 may be directly added to the model files in model plane 180 by the DE software tools used in the design process of PTw 132. Alternatively, PTw sensor data may be added to digital thread 162 associated with PTw 132 directly via application plane 160. In addition, processed sensory data 144 may be integrated into IDMP 100 directly via application plane 160. For example, processed sensory data 144 may be sent to ACP 150 for analysis, potentially leading to the generation and storage of a new twin configuration. The eventual decision to instantiate a PTw from the new twin configuration completes physical feedback loop 102.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). PCT application No. PCT/US24/27898 (Docket No. IST-03.001PCT) provides a more complete description of authoritative twins and their determination, and is incorporated by reference in its entirety herein.

With faster feedback loops from sensor data and expert recommendations, the system updates DTw 122 to reflect latest design changes. This update process may involve engineering teams analyzing feedback 154 and executing the changes through IDMP 100, or automated changes enabled by IDMP 100 where updates to DTw 122 are generated through programmed algorithms or AI modules. This iterative updating process continues until DTw 122 and PTw 132 are in sync and the product's performance meets desired goals. While IDMP 100 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 122 and PTw 132 have been validated and optimized, the product is ready for production. A digital thread connecting all stages of development can be queried via splice plane 170 to generate documentation as needed to meet validation and verification requirements. The use of model splicing, along with the feedback architecture shown in FIG. 1, improves the efficiency of the overall product innovation process.

### Interconnected DE Platform and Product Lifecycle

In FIG. 1, letter labels “A” to “H” indicate the following major steps of a product lifecycle, according to some embodiments of the current invention:
A. Digital models reside within customer environments: a product may be originally represented by model files that are accessible via software tools located within customer environments. Model plane 180 encompasses all model files (e.g., 182) associated with the product.
B. Preparatory steps for design in the digital realm: splice plane 170 encompasses model splices (e.g., 172) generated from DE model file through model splicing. Model splicing enables the integration and sharing of DE model files within a single platform, as described in detail with reference to FIGS. 7 to 9.
C. Link threads as needed among model splices: to implement a product, model splices are linked through scripts within application plane 160. A digital twin (DTw) 122 englobing as-designed product features may be generated from application plane 160 for running in virtual environment 120. The complete twin configuration of a generated DTw is saved in twin configuration set 156 located at the analysis & control plane (ACP) 150. Features or parts of DTw 122 may be simulated in model plane 180, with performance data 174 accessed through splice plane 170. In one embodiment, features or parts of PTw 132 or DTw 122 configuration may be simulated outside the platform, where performance data is received by the ACP 150 for processing, in a similar way as performance data 126 received from DTw 122.
D. Finalize “As-designed”: performance data 126 from DTw 122 or simulation performance data 174 attained through model plane 180 and accessed through model splicing may be collected and sent to ACP 150 for analysis. Performance data from different iterations of DTw 122 may be compared via engine 152 to design requirements. Analysis of the differences may lead to the generation of new twin configurations that are stored at twin configuration set 156. Each twin configuration in twin configuration set 156 may be applied at application plane 160 and splice plane 170 via process step 108 to instantiate a corresponding DTw. Multiple DTws may be generated and tested, consecutively or simultaneously, against the design requirements, through comparison engine 152 and analysis module 154. Verification and validation tools may be run on the various DTw iterations.
E. Finalize “As-manufactured”: once a DTw 122 satisfies the design requirements, a corresponding PTw 132 prototype may be instantiated from the spliced model files (e.g., 172). Sensor data originating from the PTw 134 or from within the physical environment 136 may be collected, combined with other external data 142 (e.g., sensor data from other physical environments). The resulting processed sensory data 144 may be sent to the analysis & control plane 150 to be compared with performance data 126 from DTws and simulations (e.g., 174), leading to further DTw 122 and PTw 132 iterations populating the twin configuration set 156. Processed sensory data 144 may also be mapped to the digital threads (e.g., 164) and model splices (e.g., 172) governing the tested PTw 132 through the application plane 160.
F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDEP 100 components described above may be used in the assembly process. In its authoritative iteration, DTw 122 ultimately captures the precise details of the physical assembly, enabling comprehensive analysis and control in subsequent stages of the process.
G. Finalize “As-operated”: to assess the performance of the physical assembly or its individual component parts, multiple digital twins 122 may be generated as needed. These digital twins are created based on specific performance metrics and serve as virtual replicas of the physical system. Digital twins 122 are continuously updated and refined in real-time using the operational data (e.g., 144) collected from monitoring the performance of the physical assembly or its components. This data may include, but are not limited to, processed sensory data, performance indicators, and other relevant information. By incorporating this real-time operational data, digital twins 122 stay synchronized with the actual system and provide an accurate representation of its operational performance. Any changes or improvements observed via sensory data 144 during the real-world operation of the assembly are reflected in DE models within the digital twins and recorded in the twin configuration set 156. This ensures that the digital twins remain up-to-date and aligned with the current state of the physical system.
H. Predictive analytics/Future performance: The design process may continue iteratively in virtual environment 120 through new DTw 122 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 182) are continuously updated and refined using the latest sensor data, control policies, and performance metrics to enhance their predictive accuracy. This iterative process ensures that the digital twins (e.g., 122, 156) provide reliable predictions of future performance and assist in making informed decisions.

The hardware components making up IDMP 100 (e.g., servers, computing devices, storage devices, network links) may be centralized or distributed among various entities, including one or more DE service providers and DE clients, as further discussed in the context of FIGS. 3 and 4. FIG. 4 shows an illustration of various potential configurations for instancing a DE platform within a customer's physical system and information technology (IT) environment, usually a virtual private cloud (VPC) protected by a firewall.

Digital Documentation through Live Digital Objects

The methods and systems described herein enable the updating and generation of digital documents using the full functionality of the IDMP shown in FIG. 1. In FIG. 1, the IDMP virtual feedback loop 104 allows the scripting of program code within a digital thread 162 for the generation, storing, and updating of digital twins 122 and twin configurations 156. Similarly, the IDMP virtual feedback loop 104 also allows the scripting of program code within a digital thread 162 for the generation, storing, and updating of digital documents. This enables the creation and maintenance of so-called live digital objects.

Live digital objects are more akin to a DTw than a conventional static document in that they are configured, through a digital thread, to be continuously updated to reflect the most current changes within a particular twin configuration. In particular, an authoritative/trusted live digital object is configured to reflect the latest authoritative/trusted twin configuration. Specifically, live digital objects are digital objects that (1) include a digital artifact extracted from a digital model through a model presentation (e.g., model splice), where (2) a modification of the digital artifact appears in the live digital object within a predetermined delay. In various embodiments, the updates are effectively real-time or near real-time.

Live digital objects may use a document interface, yielding live digital documents, or live documents. Live digital documents may pull data from multiple model files. Preliminary design reviews may thus take the form of a live digital document.

Live digital objects may also use a dashboard interface, yielding live digital boards, or live boards. In some embodiments, a live digital board may display one or more documents and one or more applications on a two-dimensional (2D) screen rendered on a modality of a multimodal interface such as a 2D display, a two-and-a-half-dimensional (2.5D) display, and a three-dimensional (3D) semi-immersive or fully immersive display. Live digital boards may combine multiple documents through a VR/AR and/or conversational interface, into a board/screen 2D, 2.5D format. For example, a live board may combine multiple model files from a CAD software with collaboration chat rooms over a 2D screen rendered on a 2D display (traditional display), a 2.5D display, or a 3D semi immersive or fully immersive display. In one embodiment, the live board combines multiple view screens.

Finally, a live digital object may take the form of a live digital space (or live space), a 3D virtual environment or an augmented environment. In some embodiments, a live digital space displays one or more documents and one or more other applications in a virtual space rendered through a 3D spatial display. Live digital spaces may combine multiple documents through VR/AR and/or conversational interfaces into a 3D spatial representation. For example, a live space may display multiple 3D model files from a CAD software with collaboration chat rooms over a 3D semi immersive or fully immersive display spatial display.

Live digital objects may be stored and accessed through an IDMP. Specifically, live digital objects may be used to provide the background context for a given digital thread, and may specifically be used to display and organize a digital thread's associated artifacts, as described herein.

Live digital objects may hence be known as magic objects (i.e., live documents may be denoted “magic documents”, live boards may be denoted “magic boards”, and live spaces may be denoted “magic spaces”) as changes implemented within a twin configuration (e.g., through a modification of a model file) may appear instantaneously within the relevant data fields of the live digital objects. Similarly, authoritative/trusted live digital objects may also be known as authoritative/trusted magic objects as they continuously reflect data from the authoritative twin, thus always representing the authoritative source of truth.

Given the massive quantities of data and potential modifications that are carried out during a product's lifecycle, the scripts implementing live digital objects may be configured to allow for a predefined maximum delay between the modification of a model file (e.g., the modification of a digital artifact) and the execution of the corresponding changes within a live digital object. Moreover, for similar reasons, the scripts implementing live digital objects may be restricted to operate over a specified subset of model files within a DTw or a system, thus reflecting changes only to key parameters and configurations of the DTw or the system.

The “printing” of a live digital document or board corresponds to the generation of a frozen (i.e., static) time-stamped version of a live digital document or board. Therefore, “printing”—for a live digital document or board—is equivalent to “instantiation” for a digital twin. Similarly, the “printing” of a live digital space may also be envisaged, yielding a frozen 3D representation of a given system or digital thread.

In one embodiment of the present invention, an IDMP script (e.g., an IDEP application) having access to model data via one or more model splices and digital document templates to create and/or update a live digital object may dynamically update the live digital object using software-defined digital threads over an IDMP platform. In such an embodiment, the IDMP script may receive user interactions dynamically. In response to the user updating data for a model and/or a specific parameter setting, the IDMP script may dynamically propagate the user's updates into the digital object through a corresponding digital thread.

In another embodiment of the present invention, an IDMP script may instantiate a digital object with sufficient specification to generate a physical twin (PTw). In such an embodiment, the IDMP script may receive a digital twin configuration of a physical twin, generate a live digital object associated with the digital twin configuration, receive a predetermined timestamp, and generate a printed digital object (i.e., a static, time-stamped version of the live digital object at the predetermined timestamp). Such an operation may be referred to as the “printing of a digital twin”.

In yet another embodiment of the present invention, an IDMP script may instantiate (i.e., “print”) a digital object specifying an updated digital twin upon detecting the update. In such an embodiment, the IDMP script may detect a modification of a digital model or an associated digital thread. In response to detecting the modification, the IDMP script may update relevant data fields and sections of the live digital object based on the detected modification, and generate an updated printed digital object with the updated relevant data fields and sections based on the always-updated live digital object.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, In one embodiment, a companion magic doc for a given digital thread may include key data points and key orchestration script examples illustrating a user's intent (e.g., “increase a drone's wing span by 1%”). In one embodiment, a script-generating ML model receiving as input pseudocode or detailed user instructions derived from a user's intent, is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Interconnected Digital Engineering and Certification Ecosystem

FIG. 2 shows an exemplary implementation of the IDEP as an interconnected digital engineering (DE) and certification ecosystem 200, and exemplary digitally certified products, in accordance with some embodiments of the present invention. Interconnected DE and certification ecosystem 200 may be viewed as a particular instantiation or implementation of IDEP 100 shown in FIG. 1. The IDEP may also be referred to as a “DE Metaverse.”

Interconnected DE and certification ecosystem 200 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 200 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 2 shows an example of an interconnected DE and certification ecosystem and examples of digitally certified products 212A, 212B, and 212C (collectively referred to as digitally certified products 212). For example, in some implementations, digitally certified product 212A may be an unmanned aerial vehicle (UAV) or other aircraft, digitally certified product 212B may be a drug or other chemical or biologic compound, and the digitally certified product 212C may be a process such as a manufacturing process. In general, the digitally certified products 212 can include any product, process, or solution that can be developed, tested, or certified (partially or entirely) using DE tools such as 202. In some implementations, digitally certified products 212 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 212 in FIG. 2 may be designed and/or certified using interconnected DE and certification ecosystem 200. Interconnected DE and certification ecosystem 200 may include a user device 206A, API 206B, or other similar human-to-machine, or machine-to-machine communication interfaces operated by a user. A user may be a human 204 of various skill levels, or artificial users such as algorithms, artificial intelligence, or other software that interface with ecosystem 200 through API 206B. Ecosystem 200 may further comprise a computing and control system 208 (“computing system 208” hereinafter) connected to and/or including a data storage unit 218, an artificial intelligence (AI) engine 220, and an application and service layer 222. In some embodiments, the artificial intelligence (AI) engine 220 is a machine learning (ML) engine. References to “machine learning engine 220 “or “ML engine 220” may be extended to artificial intelligence (AI) engine 220 more generally. For the purposes of clarity, any user selected from various potential human or artificial users are referred to herein simply as the user 204. In some implementations, computing system 208 may be a centralized computing system; in some implementations, computing system 208 may be a distributed computing system. In some cases, user 204 may be considered part of ecosystem 200, while in other implementations, user 204 may be considered separately from ecosystem 200. Ecosystem 200 may include one or more DE tools 202, such as data analysis tool 202A, computer-aided design (CAD) and finite element analysis (FEA) tool 202B, simulation tool 202C, drug modeling and simulation (M&S) tools 202D-202E, manufacturing M&S tools 202F-202G, etc. Ecosystem 200 may also include a repository of common V&V products 210, such as regulatory standards 210A-210F related to the development and certification of a UAV, medical standard 210G (e.g., CE marking (Europe), FCC Declaration of Conformity (USA), IECEE CB Scheme (Europe, North America, parts of Asia & Australia), CDSCO (India), FDA (USA), etc.), medical certification regulation 210H (e.g., ISO 13485, ISO 14971, ISO 9001, ISO 62304, ISO 10993, ISO 15223, ISO 11135, ISO 11137, ISO 11607, IEC 60601, etc.), manufacturing standard 2101 (e.g., ISO 9001, ISO 9013, ISO 10204, EN 1090, ISO 14004, etc.), and manufacturing certification regulation 210J (e.g., General Certification of Conformity (GCC), etc.), etc.

In FIG. 2, computing system 208 is centrally disposed within the architecture and is configured to communicate with (e.g., receive data from and transmit data to) user device 206A or API 206B such as an API associated with an artificial user, DE tools 202 via an API or software development kit (SDK) 214, and repository of common V&V products 210 via an API/SDK interface 216. For example, computing system 208 may be configured to communicate with user device 206A and/or API 206B to send or receive data corresponding to a prototype of a design, information about a user (e.g., user credentials), engineering-related inputs/outputs associated with DE tools 202, digitized common V&V products, an evaluation of a product design, user instructions (e.g., search requests, data processing instructions, etc.), and more. Computing system 208 may also be configured to communicate with one or more DE tools 202 to send engineering-related inputs for executing analyses, models, simulations, tests, etc. and to receive engineering-related outputs associated with the results. Computing system 208 may also be configured to communicate with repository of common V&V products 210 to retrieve data corresponding to one or more digitized common V&V products 210 and/or upload new common V&V products, such as those received from user 204, to repository of common V&V products 210. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 208 may process and/or store the data that it receives to perform analysis and control functionalities, and in some implementations, may access machine learning engine 220 and/or application and service layer 222, to identify useful insights based on the data, as further described herein. The central disposition of computing system 208 within the architecture of the ecosystem has many advantages including reducing the technical complexity of integrating the various DE tools; improving the product development experience of user 204; intelligently connecting common V&V products such as standards 210A-210F to DE tools 202 most useful for satisfying requirements associated with the common V&V products; and enabling the monitoring, storing, and analysis of the various data that flows between the elements of the ecosystem throughout the product development process. In some implementations, the data flowing through and potentially stored by the computing system 208 can also be auditable to prevent a security breach, to perform data quality control, etc. Similarly, any analysis and control functions performed via computing system 208 may be tracked for auditability and traceability considerations.

Referring to one particular example shown in FIG. 2, user 204 may use the DE and certification ecosystem to produce a digitally certified UAV 212B. For example, user 204 may be primarily concerned with certifying the UAV as satisfying the requirements of a particular regulatory standard 210E relating to failure conditions of the UAV (e.g., “MIL-HDBK 516C 4.1.4—Failure Conditions”). In this usage scenario, user 204 may develop a digital prototype of the UAV on user device 206A or using API 206B and may transmit prototype data (e.g., as at least one of a CAD file, a MBSE file, etc.) to computing system 208. Along with the prototype data, user 204 can transmit, via user device 206A, additional data including an indication of the common V&V product that user 204 is interested in certifying the product for (e.g., regulatory standard 210E), user credential information for accessing one or more capabilities of computing system 208, and/or instructions for running one or more digital models, tests, and/or simulations using a subset of DE tools 202.

Referring to another example shown in FIG. 2, user 204 can use the DE and certification ecosystem to produce a digitally certified drug, chemical compound, or biologic 212A. For example, user 204 may be primarily concerned with certifying drug, chemical compound, or biologic 212A as satisfying the requirements of a particular medical standard 210G and medical certification regulation 210H. In this usage scenario, user 204 can develop a digital prototype of the drug, chemical compound, or biologic on user device 206A or using API 206B and can transmit the prototype data (e.g., as a molecular modeling file) to computing system 208. Along with the prototype data, user 204 can transmit, via user device 206A, additional data including an indication of the common V&V products that user 204 is interested in certifying the product for (e.g., medical standard 210G and medical certification regulation 210H), user credential information for accessing one or more capabilities of computing system 208, and/or instructions for running one or more digital models, tests, and/or simulations using a subset of DE tools 202 (e.g., drug M&S tools 202D-202E).

Referring to yet another example shown in FIG. 2, user 204 can use the digital engineering and certification ecosystem to produce a digitally certified manufacturing process 212C. For example, user 204 may be primarily concerned with certifying manufacturing process 212C as satisfying the requirements of a particular manufacturing standard 2101 and manufacturing certification regulation 210J. In this usage scenario, user 204 can develop a digital prototype of the manufacturing process on user device 206A or using API 206B and can transmit the prototype data to computing system 208. Along with the prototype data, user 204 can transmit, via the user device 206A, additional data including an indication of the common V&V products that user 204 is interested in certifying the process for (e.g., manufacturing standard 2101 and manufacturing certification regulation 210J), user credential information for accessing one or more capabilities of computing system 208, and/or instructions for running one or more digital models, tests, and/or simulations using a subset of DE tools 202 (e.g., manufacturing M&S tools 202F-202G).

In any of the aforementioned examples, computing system 208 can receive the data transmitted from user device 206A and/or API 206B and can process the data to evaluate whether the common V&V product of interest (e.g., regulatory standard 210E, medical standard 210G, medical certification regulation 210H, manufacturing standard 210I, manufacturing certification regulation 210J, etc.) is satisfied by the user's digital prototype, in the context of analysis and control plane 150 shown in FIG. 1. For example, this can involve communicating with the repository of common V&V products 210 via the API/SDK 216 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 210 can be hosted by a regulatory and/or certification authority (or another third party), and retrieving the regulatory and/or certification data can involve using API/SDK 216 to interface with one or more data resources maintained by the regulatory and/or certification authority (or another third party). In some implementations, the regulatory and/or certification data can be provided directly by user 204 via user device 206A and/or API 206B (e.g., along with the prototype data).

Evaluating whether the common V&V product of interest is satisfied by the user's digital prototype can also involve processing the prototype data received from user device 206A or API 206B to determine if the one or more identified requirements are actually satisfied. In some implementations, computing system 208 can include one or more plugins, local applications, etc. to process the prototype data directly at the computing system 208. For example, model splicing and digital threading applications are discussed in detail later with reference to FIG. 6 to 9. In some implementations, the computing system can simply pre-process the received prototype data (e.g., to derive inputs for DE tools 202) and can then transmit instructions and/or input data to a subset of DE tools 202 via API/SDK 214 for further processing.

Not all DE tools 202 are necessarily required for the satisfaction of particular regulatory and/or certification standards. Therefore, in the UAV example provided in FIG. 2, computing system 208 may determine that only a data analysis tool 202A and a finite element analysis tool 202B are required to satisfy regulatory standard 210E for failure conditions. In the drug, chemical compound, or biologic example provided in FIG. 2, computing system 208 may determine that only drug M&S tools 202D-202E are required to satisfy medical standard 210G and medical certification regulation 210H. In the manufacturing process example provided in FIG. 2, computing system 208 may determine that only manufacturing M&S tools 202F-202G are required to satisfy manufacturing standard 2101 and manufacturing certification regulation 210J. In other implementations, user 204 may themselves identify the particular subset of DE tools 202 that should be used to satisfy the common V&V product of interest, provided that user 204 is a qualified subject matter expert (SME). In other implementations, user 204 may input to computing system 208 some suggested DE tools 202 to satisfy a common V&V product of interest, and computing system 208 can recommend to user 204 a modified subset of DE tools 202 for final approval by user 204, provided that user 204 is a qualified SME. After a subset of DE tools 202 has been identified, computing system 208 can then transmit instructions and/or input data to the identified subset of DE tools 202 to run one or more models, tests, and/or simulations. The results (or “engineering-related data outputs” or “digital artifacts”) of these models, tests, and/or simulations can be transmitted back and received at computing system 208.

In still other implementations, user 204 may input a required DE tool such as 202F for meeting a common V&V product 2101, and the computing system 208 can determine that another DE tool such as 102G is also required to satisfy common V&V product 2101. The computing system can then transmit instructions and/or input data to both DE tools (e.g., 202F and 202G), and the outputs of these DE tools can be transmitted and received at computing system 208. In some cases, the input data submitted to one of the DE tools (e.g., 202G) can be derived (e.g., by computing system 208) from the output of another of the DE tools (e.g., 202F).

After receiving engineering-related data outputs or digital artifacts from DE tools 202, computing system 208 can then process the received engineering-related data outputs to evaluate whether or not the requirements identified in the common V&V product of interest (e.g., regulatory standard 210E, medical standard 2110G, medical certification regulation 210H, manufacturing standard 2101, manufacturing certification regulation 210J, etc.) are satisfied. For example, applications and services 222 may provide instructions for orchestrating validation or verification activities. In some implementations, computing system 208 can generate a report summarizing the results of the evaluation and can transmit the report to device 206A or API 206B for review by user 204. If all of the requirements are satisfied, then the prototype can be certified, resulting in digitally certified product 212 (e.g., digitally certified drug, chemical compound, or biologic 212A; digitally certified UAV 212B; digitally certified manufacturing process 212C, etc.). However, if some of the regulatory requirements are not satisfied, then additional steps may need to be taken by user 204 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 202, computing systems 208 may provide user 204 with a report recommending partial certification, compliance, or fulfillment of a subset of the common V&V products (e.g., digital certification of a subsystem or a sub-process of the prototype). The process of generating recommendations for user 204 is described in further detail below.

In response to reviewing the report, user 204 can make design changes to the digital prototype locally and/or can send one or more instructions to computing system 208 via user device 206A or API 206B. These instructions can include, for example, instructions for computing system 208 to re-evaluate an updated prototype design, use one or more different DE tools 202 for the evaluation process, and/or modify the inputs to DE tools 202. Computing system 208 can, in turn, receive the user instructions, perform one or more additional data manipulations in accordance with these instructions, and provide user 204 with an updated report. Through this iterative process, user 204 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 202, computing system 208 may provide user 204 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 208 within the architecture of the ecosystem enables computing system 208 to monitor and store the various data flows through the ecosystem. Thus, as an increasing number of users utilize the ecosystem for digital product development, data associated with each use of the ecosystem can be stored (e.g., in storage 218), traced (e.g., with metadata), and analyzed to yield various insights, which can be used to further automate the digital product development process and to make the digital product development process easier to navigate for non-subject matter experts.

Indeed, in some implementations, user credentials for user 204 can be indicative of the skill level of user 204, and can control the amount of automated assistance the user is provided. For example, non-subject matter experts may only be allowed to utilize the ecosystem to browse pre-made designs and/or solutions, to use DE tools 202 with certain default parameters, and/or to follow a predetermined workflow with automated assistance directing user 204 through the product development process. Meanwhile, more skilled users may still be provided with automated assistance, but may be provided with more opportunities to override default or suggested workflows and settings.

In some implementations, computing system 208 can host applications and services 222 that automate or partially automate components of common V&V products; expected or common data transmissions, including components of data transmissions, from user 204; expected or common interfaces and/or data exchanges, including components of interfaces, between various DE tools 202; expected or common interfaces and/or data exchanges, including components of interfaces, with machine learning (ML) models implemented on computing system 208 (e.g., models trained and/or implemented by the ML engine 220); and expected or common interfaces and/or data exchanges between the applications and services themselves (e.g., within applications and services layer 222).

In some implementations, the data from multiple uses of the ecosystem (or a portion of said data) can be aggregated to develop a training dataset. For example, usage records 217 collected via computing system 208 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 202 that should be used to satisfy a common V&V product of interest.

This training dataset can then be used to train ML models (e.g., using ML engine 220) to learn the steps and actions for certification processes and to perform a variety of tasks including the identification of which of DE tools 202 to use to satisfy a particular common V&V product; the identification of specific models, tests, and/or simulations (including inputs to them) that should be performed using DE tools 202; the identification of the common V&V products that need to be considered for a product of a particular type; the identification of one or more recommended actions for user 204 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 202) based on previously entered inputs, forecasting time and cost requirements for developing a product, predictively estimating the results of sensitivity analyses, and even suggesting design changes, original designs or design alternatives (e.g. via assistive or generative AI) to a user's prototype to overcome one or more requirements (e.g., regulatory and/or certification requirements) associated with a common V&V product. In some implementations, with enough training data, ML engine 220 may generate new designs, models, simulations, tests, common V&V products and/or digital threads on its own based on data collected from multiple uses of the ecosystem. Furthermore, such new designs, models, simulations, tests, common V&V products and digital threads generated by ML engine 220, once approved and adjusted by a user, may be added to the training set for further fine-tuning of ML algorithms in a reinforcement learning setup.

As shall be discussed in the context of FIGS. 7 to 9, the aforementioned collection of training datasets and the training of ML and AI modules including ML engine 220 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 2, ML engine 220 may manage or orchestrate the interactions between spliced DE models, DE tools, and common V&V products (e.g., DE requirements), based on digital thread options specific to user's intent and input. Sample DE tasks that may be carried out by ML engine 220 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 220 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 218) to enable users to search for and build upon the work of others. For example, previously designed components, systems, models, simulations and/or other engineering representations thereof can be searched for by user 204 and/or suggested to user 204 by computing system 208 in order to satisfy one or more requirements associated with a common V&V product. The previously designed components, systems, models, simulations and/or other engineering representations thereof can be utilized by user 204 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 204 can be checked by computing system 208 to determine which designs and/or solutions stored in the repository can be accessed by user 204. In some implementations, usage of the previously designed components, systems, models, simulations and/or other engineering representations thereof may be available only to other users who pay a fee for a usage.

Exemplary IDEP Implementation Architecture with Services and Features

FIG. 3 shows another exemplary implementation of the IDEP illustrating its offered services and features, in accordance with some embodiments of the present invention. Specifically, an exemplary implementation architecture diagram 300 is shown in FIG. 3 to include multiple illustrative components: an IDEP enclave 302, cloud services 304, and a customer environment 310 which optionally includes an IDEP exclave 316. This exemplary architecture 300 for the IDEP is designed in accordance with zero-trust security principles and is further designed to support scalability as well as robust and resilient operations. IDEP enclave 302 and IDEP exclave 316 together instantiate IDEP 100 shown in FIG. 1, with IDEP exclave 316 implementing model splicing and splice plane 170 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 302 may serve as a starting point for services rendered by the IDEP, and may be visualized as a central command and control hub responsible for the management and orchestration of all platform operations. For example, enclave 302 may be implemented using computer system 208 of the interconnected DE and certification ecosystem shown in FIG. 2. DE platform enclave 302 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 302 also supports an ML engine such as 220 for real-time analytics, auto-scaling features for workload adaptability, and API-based interoperability with third-party services. Security and resource optimization are enhanced through multi-tenancy support, role-based access control, and data encryption both at rest and in transit. DE platform enclave 302 may also include one or more of the features described below.

First, IDEP enclave 302 may be designed in accordance with zero-trust security principles. In particular, DE platform enclave 302 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 302 can also be designed to maintain isolation and independence. A key aspect of the enclave's architecture is its focus on impartiality and isolation. DE enclave 302 disallows cryptographic dependencies from external enclaves and enforces strong isolation policies. The enclave's design also allows for both single-tenant and multi-tenant configurations, further strengthening data and process isolation between customers 306 (e.g., users 204). Additionally, DE enclave 302 is designed with decoupled resource sets, minimizing interdependencies and thereby promoting system efficiency and autonomy.

IDEP enclave 302 can further be designed for scalability and adaptability, aligning well with varying operational requirements. For example, the enclave 302 can incorporate hyperscale-like properties in conjunction with zero-trust principles to enable scalable growth and to handle high-performance workloads effectively.

IDEP enclave 302 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 300's adaptability makes it highly versatile for a multitude of use-cases, while ensuring consistent performance and robust security.

IDEP enclave 302 can further be designed to enable analytics for robust platform operations. At the core of the enclave's operational efficiency is a machine learning engine (e.g., machine learning engine 220) capable of performing real-time analytics. This enhances decision-making and operational efficiency across platform 300. Auto-scaling mechanisms can also be included to enable dynamic resource allocation based on workload demand, further adding to the platform's responsiveness and efficiency.

In the exemplary embodiment shown in FIG. 3, IDEP enclave 302 includes several components as described in further detail herein.

A “Monitoring Service Cell. may provide “Monitoring Service” and “Telemetry Service.” A cell may refer to a set of microservices, for example, a set of microservices executing within a kubernetes pod. These components focus on maintaining, tracking and analyzing the performance of platform 300 to ensure good service delivery, including advanced machine learning capabilities for real-time analytics. A “Search Service Cell” provides “Search Service” to aid in the efficient retrieval of information from DE platform 300, adding to its overall functionality. A “Logging Service Cell” and a “Control Plane Service Cell” provide “Logging Service,” “File Service”, and “Job Service” to record and manage operational events and information flow within platform 300, and are instrumental in the functioning of platform 300. A “Static Assets Service Cell,” provides “Statics Service”, and may house user interface, SDKs, command line interface (CLI), and documentation for platform 300. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 316 to provide splice functions for model splicing purposes.

As shown in FIG. 3, the architecture of DE platform 300 may also include a cloud services 304 that provide services which cannot interact with customer data but can modify the software for the orchestration of DE platform operations. In example implementations, several cloud resources provide support and foundational services to the platform. For example, in the embodiment of the DE platform 300 shown in FIG. 3, cloud services 304 includes a “Customer Identity and Access Management (IAM) Service” that ensures secure and controlled access to platform 300. Cloud services 304 also includes a “Test Service” that tests tools to validate platform operations. In the context of software testing, the Test Service can be thought of as the execution layer that manages and orchestrates the different types of tests on the platform. The Test Service may utilize the test scripts generated, and additionally has functionality to generate tests for specific UI or API level testing. Cloud services 304 may also include an “Orchestration Service” that controls and manages the lifecycle of containers on the platform 300. Cloud services 304 may also include an “Artifact Service” and “Version Control and Build Services,” which may be used to maintain the evolution of projects, codes, and instances in the system, while also managing artifacts produced during the product development process.

As shown in FIG. 3, the architecture of DE platform 300 may also include a customer environment 310 with an “Authoritative Source of Truth” 312, customer tools 314, and an optional DE platform exclave 316. Customer environment 310 is where customer data resides and is processed in a zero-trust manner by DE platform 300. As described previously, DE platform enclave 302, by focusing on both zero-trust principles and hyperscale-like properties, provides a robust and scalable environment for the secure processing of significant workloads, according to the customer's unique needs. In some examples, DE platform exclave 316 may be situated within customer environment 310 in order to assist the customer(s) 306 with their DE tasks and operations, including model splicing and digital threading.

When a customer 306 (e.g., user 204) intends to perform a DE task using DE platform 300 (e.g., IDEP 100), typical operations may include secure data ingestion and controlled data retrieval. Derivative data generated through the DE operations, such as updated digital model files or revisions to digital model parameters, may be stored only within customer environment 310, and DE platform 300 may provide tools to access the metadata of the derivative data. Here metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 310 through a pre-validated secure tunnel, such as Secure Socket Layer (SSL) tunnel. This can enable direct and secure file transfer to a designated cloud storage, such as a simple storage service (S3) bucket, within customer environment 310. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 310 while adhering to zero-trust security protocols. Example implementations may also include tokenization utility, in which a specialized DE platform tool referred to as a “tokenizer” is deployed within customer environment 310 for secure management of derivative metadata, conforming to zero-trust guidelines.

Customer environment 310 may interact with other elements of secure DE platform 300 and includes multiple features that handle data storage and secure interactions with platform 300. For example, one element of the customer environment 310 is “Authoritative Source of Truth” 312, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 310 while providing smooth interactions with other elements of DE platform 300.

Customer environment 310 may also include additional software tools such as customer tools 314 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 310 and elements of DE platform 300. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 310, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 316 may be employed within customer environment 310 to assist with customer DE tasks and operations, supervise data processing, and rigorously adhering to zero-trust principles while delivering hyperscale-like platform performance. IDEP exclave 316 is maintained by the IDEP to run DE tools for customers who need such services. IDEP exclave 316 may contain a “DE Tool Host” that runs DE tools and a “DE Platform Agent” necessary for the operation. Again, native DE tools are typically access-restricted by proprietary licenses and end-user license agreements paid for by the customer. IDEP exclave 316 utilities and manages proprietary DE tools hosted with customer environment 310, for example, to implement model splicing and digital threading functionalities.

In some embodiments, the machine learning (ML) models and artificial intelligence (AI) assistance approaches as described herein adapt to suit different customer instances of the IDEP (see FIG. 4) and the availability of training data. In an example, a pre-trained ML or AI model (e.g. within the IDEP enclave 302) is deployed in instances where there are restrictions around sharing customer data. In another example, AI models are deployed in a federated manner adjacent to DE agents and DE tools in the customer environment (e.g., within IDEP exclave 316). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 4 shows potential scenarios for instantiating an IDEP in connection to a customer's physical system and IT environment, in accordance with some embodiments of the present invention. Specifically, FIG. 4 illustrates various potential configurations for instancing or instantiating an IDEP (“DE platform) 402 in connection to a customer's IT environment and physical system 404. The IT environment may be located on a virtual private cloud (VPC) protected by a firewall. The physical system may refer to a physical twin as discussed with reference to FIG. 1. In some embodiments, IDEP 402 may be instanced as an enclave such as 302 shown in FIG. 3. For example, IDEP 402 may be instanced on the cloud, possibly in a software-as-a-service (SaaS) configuration. The platform instances in these embodiments include software and algorithms, and may be described as follows:
1. External Platform Instance 410: This option showcases the IDEP as a separate platform instance. The platform interacts with the physical system through the customer's virtual environment, or a Customer Virtual Private Cloud (“Customer VPC”), which is connected to the physical system.
2. External Platform Instance with Internal Agent 420: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 430: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 440: This option shows the DE platform linked directly to an DE edge instance on the physical system. The DE platform and the physical system are depicted separately, connected by an edge computing instance in the middle, indicating the flow of data.
5. Direct API Connection 450: This deployment scenario shows the DE platform connecting directly to the physical system via API calls. In this depiction, an arrow extends directly from the platform sphere to the physical system sphere, signifying a direct interaction through API.
6. Air-Gapped Platform Instance 460: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

FIG. 5 illustrates the use of multimodal user interfaces 590 for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 502 and 504 are processed in the Analysis & Control Plane (ACP) 150 of FIG. 1. The user interface may receive data streams from physical and virtual feedback loops 102 and 104, as well as external expert feedback 114, analysis module 154, and twin configuration set 156 of ACP 150.

The multimodal interfaces illustrated in FIG. 5 are configured to carry out all the DE tasks and actions described in the context of FIG. 1, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 594, a workflow-based interface 596, conversational interfaces 598, spatial computer interfaces 592, and code interfaces 599.

Dashboard-style interface 594 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 596 guides users through the decision-making process, presenting relevant data, options, and contextual information at each stage. It integrates external feedback and is designed as a progressive web app or a mobile app. In the context of alternative tool selection, workflow-based interface 596 may provide options on individual tools at each stage, or provide combinations of tool selections through various stages to achieve better accuracy or efficiency for the overall workflow.

Conversational interfaces 598 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

According to the latest prior art, a “conversational interface” or “conversational user interface” refers to a human-computer interaction model that enables users to interact with digital systems through natural language, either via text or voice. These interfaces utilize advanced natural language processing (NLP), machine learning, and artificial intelligence technologies to understand and respond to user inputs in a manner that mimics human conversation. Conversational interfaces can take various forms, including chatbots, voice assistants, and messaging platforms, allowing users to communicate with systems using everyday language rather than traditional graphical user interface elements. The goal of these interfaces is to provide a more intuitive, accessible, and personalized user experience by leveraging the familiar paradigm of conversation, enabling users to accomplish tasks, retrieve information, or control devices through natural dialogue without requiring specialized knowledge of complex commands or navigation structures.

FIG. 5 also illustrates the use of spatial computing interfaces 592 and code interfaces 599 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

A “spatial interface” or “spatial user interface” refers to a user interaction paradigm that leverages three-dimensional space and spatial relationships to present and manipulate digital information. This approach goes beyond traditional 2D graphical user interfaces by incorporating depth, volume, and spatial positioning to create more intuitive and immersive user experiences. Spatial interfaces often utilize technologies such as augmented reality (AR), virtual reality (VR), or mixed reality (MR) to overlay digital content onto the physical world or create entirely virtual environments. These interfaces allow users to interact with digital objects and information as if they were physical entities in space, using natural gestures, body movements, direction of audio or eye gaze, and spatial awareness to navigate, manipulate, and organize content in ways that more closely mimic real-world interactions.

Note that in the context of multimodal interfaces, “2.5 dimension” (often referred to as 2.5D) describes a visual representation that falls between traditional 2D and full 3D interfaces. It typically involves adding depth and perspective to 2D elements to create a pseudo-3D effect, without fully rendering a complete 3D environment. The 2.5D approach is typically designed to create the illusion of depth and dimensionality on flat, two-dimensional displays such as computer monitors, smartphone screens, or tablets, although it may be used within a 3D setting (e.g., 2D screens overlaid into 3D). This approach often uses techniques such as layering, parallax scrolling, or isometric projections to give the illusion of depth and volume while maintaining the simplicity and familiarity of 2D interfaces.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 6 describes the architecture and inherent complexity of digital threads, in accordance with the examples disclosed herein. Specifically, FIG. 6 is a schematic diagram comparing exemplary digital threads 600 of various complexities that manipulate and/or connect DE models, in accordance with some embodiments of the present invention. In the most basic sense, a digital thread may “thread” together DE models into a simple daisy-chain architecture 602 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 604 represents a more complex digital thread where a change in one DE model may affect more than one downstream model. In both 602 and 604, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 604, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 606 is a partial representation of a real-world digital thread, illustrating the complexity of digital threads and its multiplicative growth.

FIG. 6 further shows special cases 603, 605, 607, 608, and 609 of exemplary simple digital threads. Diagram 607 represents a degenerate digital thread where data is shared from a single DE model. Diagram 608 represents a model-to-document digital thread where data (e.g., system attributes, performance attributes) extracted from a single DE model may be used to generate or update a text-based document (e.g., a Capability Development Document (CDD)). Diagrams 603 and 605 are generalized from 608 to represent cases where data extracted from a single model may be used to update multiple models, or vice versa. Specifically, diagram 605 may represent the dynamic updates of live or magic documents discussed in the context of FIG. 1. Here, the logic to connect the DE models shown is clear: data are extracted from multiple DE models A, B, and C to update a document model D. There are no interactions between the extracted data. Furthermore, diagram 609 shows a special case of a digital thread where data is loaded to and extracted from only a single model A. For example, as discussed in the context of FIG. 7 next, input splice functions of the model A shown in 609 may be executed to update the model, and output splice functions of model A shown in 609 may be executed to produce digital artifacts for sharing. For these special simple threads, the IDEP may provide a GUI-based interface to the user to connect the models and execute the digital threads. For complex threads such as 606, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 1. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 7 is a schematic 700 showing an exemplary model splicing setup, according to some embodiments of the present invention. Specifically, FIG. 7 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable files that can be read without specialized software, as well as machine-readable documents that can be viewed and manipulated by a human with the help of specialized software such as word processor and/or web services. Thus, a document may contain natural language-based text and/or graphics that are directly readable by a human without the need of additional machine compilation, rendering, visualization, or interpretation. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 7, a CAD model file diesel-engine.prt 704 proceeds through a model splicing process 710 that comprises a data extraction step 720 and a splice function generation step 730. This input DE model 704 is in a file format.prt native to certain DE tools. Data extraction may be performed via a DE model crawling agent implemented as model crawling scripts within a model splicer to crawl through the input DE model file and to distill model data with metadata 722. Metadata are data that can be viewed without opening the entire input DE model file, and may include entries such as file name, file size, file version, last modified date and time, and potential user input options as identified from a user input 706. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 702 that is being used in splicing the DE model, and establishes a model data schema. This data schema describes the structure and format of the model data, some of which are translated into, or used to create input/output API endpoints with corresponding input/output schemas. In some embodiments, model data with metadata 722 may be stored in an access-restricted storage 726, such as the “customer buckets” 312 within customer environment 310 in FIG. 3, so that model splices such as 742, 744, and 746 may be generated on-demand once an input DE model 704 has been crawled through.

The model splicer further generates splice functions (e.g., API function scripts) 732 from native APIs 702 associated with the input CAD model. In the present disclosure, “native” and “primal” refer to existing DE model files, functions, and API libraries associated with specific third-party DE tools, including both proprietary and open-source ones. Native API 702 may be provided by a proprietary or open-source DE tool. For example, the model splicer may generate API function scripts that call upon native APIs of native DE tools to perform functions such as: HideParts(parts_list), Generate2DView( ), etc. These model-type-specific splice functions may be stored in a splice function database 736, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 702 of any native DE tool integrated into the IDEP, thus enabling engineers from different disciplines to interact with unfamiliar DE tools, and previously non-interoperable DE tools to interoperate freely.

Next, based on user input or desired user application 706, one or more model splices or wrappers 742, 744, and 746 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 722 and the API function scripts such as 732. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 733 are model modification scripts that allow updates or modifications to an input DE model. For example, a model update may comprise changes made via an input splice function to model parameters or configurations. “Output” splice functions or “output nodes” 734 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 726, or other similar access-restricted customer buckets.

One advantage of model splicing is its inherent minimal privileged access control capabilities for zero-trust implementations of the IDEP as disclosed herein. In various deployment scenarios discussed with reference to FIG. 4, and within the context of IDEP implementation architecture discussed with reference to FIG. 3, original DE input model 704 and model data storage 726 may be located within customer buckets 312 in customer environment 310 of FIG. 3. Splice functions 732 stored in database 736 call upon native APIs 702. The execution or invocation of splice functions 732 may rely on job-specific authentication or authorization via proprietary licenses of DE tools (e.g., residing within customer environment 310 of FIG. 3 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models Via Model Splicing

FIG. 8 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 8, an orchestration script 894 is written in Python code and designed to interact via API endpoints such as 892 to determine if a CAD model meets a total mass requirement. API endpoint 892 is an output splice function and part of a platform API 890. Platform API 890 comprises not only splice functions but also platform scripts or orchestration scripts such as 894 itself.

Orchestration script 894 is divided into three main steps:
1. Get Data From a CAD Model Splice: A POST request may be sent via the IDEP platform API to execute a computer-aided design (CAD) model splice 871. This model splice provides a uniform interface to modify and retrieve information about a CAD model 881. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 881, and a Uniform Resource Identifier/Locator (URL) for the CAD model. The response may further comprise a URL for an image of the CAD model.
2. Get Data From a SysML Model Splice: Another POST request may be sent via the IDEP platform API to execute a Systems Modeling Language (SysML) model splice 872. SysML is a general-purpose modeling language used for systems engineering. Output function 892 of model splice 872 retrieves the total mass requirements for the system from a SysML model 882. The response from the platform API includes the total mass requirement for the system.
3. Align the Variables and Check If Requirement Met: The total mass from CAD model 881 is compared with the total mass requirement from SysML model 882. If the two values are equal, a message is printed indicating that the CAD model aligns with the requirement. Otherwise, a message is printed indicating that the CAD model does not align with the requirement.

In short, orchestration script 894, which may be implemented in application plane 160 of IDEP 100 shown in FIG. 1, links digital models 881 and 882 via model splice API calls. Orchestration script 894 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

FIG. 9 is a schematic illustrating the linking of DE model splices in a splice plane and comparing digital threading with and without model splicing, according to some embodiments of the present invention. The bottom model plane 180 demonstrates current digital threading practices, where each small oval represents a DE model, and the linking between any two DE models, such as models 982 and 984, requires respective connections to a central platform 910, and potential additional linkages from every model to every other model. The central platform 910 comprises program code that is able to interpret and manipulate original DE models of distinct model types. For example, platform 910 under the control of a subject matter expert may prepare data from digital model 982 into formats that can be accessed by digital model 984 via digital model 984's native APIs, thus allowing modifications of digital model 982 to be propagated to digital model 984. Any feedback from digital model 984 to digital model 982 would require similar processing via platform 910 so that data from digital model 984 are converted into formats that can be accessed by digital model 982 via digital model 982's native APIs. This hub-and-spoke architecture 934 is not scalable to the sheer number (e.g., hundreds or thousands) of digital models involved within typical large-scale DE projects, as model updates and feedback are only possible through central platform 910.

In contrast, once the DE models are spliced, each original model is represented by a model splice including relevant model data, unified and standardized API endpoints for input/output, as shown in the upper splice plane 170. Splices within splice plane 170 may be connected through scripts (e.g., python scripts) that call upon API endpoints or API function scripts and may follow a DAG architecture, as described with reference to FIG. 1 and FIG. 6. Note that in FIG. 1, only a set of generated splices is shown within splice plane 170, while in FIG. 9, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 170 is shown in FIG. 1 as part of IDEP 100 for illustrative purposes, in some embodiments, splice plane 170 may be implemented behind a customer firewall and be part of an agent of the DE platform, as discussed in various deployment scenarios shown in FIG. 4. That is, individual API function scripts generated via model splicing by a DE platform agent may be tailored to call upon proprietary tools the customer has access to in its private environment. No centralized platform 910 with proprietary access to all native tools associated with all individual digital models shown in FIG. 9 is needed. Instead, orchestration scripts call upon platform API function scripts that may be implemented differently in different customer environments.

Hence, model splicing allows model splices such as model splice 972 from digital model 982 and model splice 974 from digital model 984 to access each other's data purposefully and directly, thus enabling the creation of a model-based “digital mesh” 944 via platform scripts and allowing autonomous linking without input from subject matter experts.

An added advantage of moving from the model plane 180 to the splice plane 170 is that the DE platform enables the creation of multiple splices per native model (e.g., see FIG. 7), each with different subsets of model data and API endpoints tailored to the splice's targeted use. For example, model splices may be used to generate multiple digital twins (DTws) that map a physical product or process or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twinning capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 950 for the IDEP is shown on the right side of FIG. 9, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 10 shows an exemplary directed acyclic graph (DAG) representation 1000 of pipelined DE tasks related to digital threads, in accordance with some embodiments of the present invention. In diagram 1000, tasks performed through a digital thread orchestration script (e.g., 894) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 1 and 8, DAGs of threaded tasks are built from digital threads and are part of the DE platform's application plane 160. Different DAGs may target different DE actions. For example, in FIG. 1, building or updating a DTw 122 in the virtual environment 120 has its own DAG 124. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

### Inner/Outer Loop Architecture for Digital Threads in Cyber-Physical Systems

FIG. 11 is an exemplary schematic 1100 illustrating the interplay between a digital thread and the individual digital models or digital artifacts it uses, thus defining outer and inner loop processes, in accordance with some embodiments of the present invention.

In various embodiments of the IDMP, the architecture for managing digital threads and their associated digital models in cyber-physical systems involves an interaction between an Outer Loop (representing the digital thread) and an Inner Loop (representing individual models or artifacts). This structure enables secure, permission-based collaboration across multiple models, ensuring traceability, controlled data flow, and efficient interaction within the digital workflow. Based on software engineering principles, this inner/outer loop design is modular: the Outer Loop manages high-level coordination and communication, while the Inner Loop handles the detailed, iterative operations of each model or system. While the Outer Loop and Inner Loop interactions commonly seen in software packages may involve access to all of the software packages within the same Integrated Development Environment (IDE), the Outer Loop/Inner Loop interactions for cyber-physical systems must manage to link interoperably with different digital models and tools, while also ensuring zero trust security. Various embodiments of the IDMP are well suited to manage such digital threads for cyber-physical systems as the platform is able to interoperably link with various digital models and tools (in different Inner Loops) through the model splicer architecture (see FIGS. 7 and 8). Additionally, the IDMP uses zero trust and zero knowledge security, ensuring that every interaction, whether within the same security network or across different networks, is strictly authorized, while keeping sensitive data private (e.g., through tokenization).

In the embodiment shown in 1110, an Outer Loop 1104 manages the sequence of tasks in a digital workflow, where user actions are authorized for access through a process 1120 in an Inner Loop 1116. Outer Loop 1104 can issue instructions to Inner Loop 1116 to:
Create models by defining structure, behavior, and parameters.
Fetch data artifacts from a model.
Update artifacts with controlled, traceable changes.

For example, when Outer Loop 1104 commands a data artifact retrieval, the IDMP platform may manage it using zero trust principles, as described in FIG. 3. Each user request in Outer Loop 1104 is authorized through an enclave 302 and its Control Plane service cell, coordinated with platform exclave 316. Different Inner Loops exist within Customer Tools 314, each operating in specific Customer Environments 310 where each request is authorized for access to the necessary data operations.

After retrieving data artifacts from Inner Loop 1116, Outer Loop 1104 handles configuration control 1106, versioning, and integrates the artifacts into the broader digital thread 1108 for testing or validation at a process step 1112.

Inner Loop 1116, by contrast, is responsible for localized operations related to individual digital models, including:
Model creation, where digital models are initialized or updated.
Model execution, through automation, simulations or data analysis.
Saving results, preserving outcomes from model runs.
Analyzing data, providing insights and validation for digital workflow improvements.

Outer Loop 1104 interacts with any step in Inner Loop 1116 to access or update data artifacts. Outer loop computations often compare the current workflow to a baseline 1110.

Outer and Inner Loops 1104 and 1116 work together in an iterative process, integrating localized model adjustments with system-wide digital workflow coordination and validation. The Outer Loop manages tasks like configuration control, system integration, and VVUQ (Verification, Validation, and Uncertainty Quantification), while the Inner Loop handles model-based operations. FIG. 11 shows the Outer Loop performing authorized access 1120, configuration control 1106, digital thread integration 1108, and VVUQ/testing 1112. In various implementations of digital threads in the IDMP, these steps can vary in sequence or iterate as needed. Ultimately, the outer and inner loop architecture enables continuous integration and development (CI/CD) of digital workflows and digital threads across the digital platform.

### Decentralized Digital Threads in the IDMP

The IDMP enables decentralized management of digital threads across different models, security networks, and user permissions under a zero trust security principle. This architecture enforces strict access controls and permission-based interactions between models, ensuring security across diverse environments. In some embodiments, a zero knowledge approach further secures sensitive data during orchestration, ensuring no unauthorized access (e.g., by using tokenization).

In FIG. 11, two exemplary setups 1122 and 1132 illustrate IDMP embodiments with decentralized digital threads across different security networks. In 1122, Outer Loop 1 operates within Security Network 1, connecting to multiple Inner Loops (e.g., Inner Loop 1, Inner Loop 2, and Inner Loop 3). These Inner Loops manage data operations within the same security framework, allowing collaboration while maintaining security.

In 1132, Outer Loop 2 operates in a separate Security Network 2, linking to additional Inner Loops (e.g., Inner Loop 4, Inner Loop 5, and Inner Loop 6). For links from Outer Loop 1, dotted lines and “X” symbols represent isolated models or components, indicating access restrictions enforced by the zero trust framework. Only authenticated users can access authorized models and artifacts.

In various implementations, 1122 and 1132 can be regarded as different instances of the Customer environment 310 shown in FIG. 3.

In the IDMP, digital threads handle both simple and complex model connections. FIG. 6 shows simple threads with sequential model links (e.g., 602, 604), while the more complex thread 606 is shown in FIG. 11 as an illustrative element 1142. Simple threads propagate changes in a linear fashion, while complex threads manage branching dependencies, where changes in one model affect multiple downstream models. In complex threads implemented by the IDMP, the Outer Loop coordinates interactions across multiple Outer loops and Inner loops, ensuring secure, scalable execution of the entire digital workflow with appropriate permission controls.

Converting Digital Workflows into Digital Threads with Data Relationships

The IDMP links different types of digital model files in a decentralized fashion with zero-trust security. When a user requests a data operation on a digital model file using a specific digital tool, IDMP executes the request via digital tool-specific and platform agents within the customer's environment. These agents extract data artifacts and, when changes to a digital artifact occur, a newer version of the digital model file is made. During the versioning step, platform agents ensure sensitive data is protected through tokenized version control.

Extracted data artifacts are securely stored in the customer's cloud data storage (e.g., an S3 bucket). If changes are made to the digital model, the agents save the updated version of the model or data artifact, extract the relevant data artifacts, and store it securely.

Using the IDMP, users are able to link data artifacts into a magic doc for documentation and commentary, which can include AI-assistance in various embodiments. A digital thread accompanying the magic doc lists data artifacts in sequence, creating a digital workflow. The IDMP further tracks data relationships between data artifacts (e.g., derivation, grouping, or data flow). This digital workflow of user actions and data relationships is stored in a non-proprietary format within the customer's environment.

Emergent digital workflows and sequence of tasks captured by data relationships of various types:
1. Generational—(Between version 1 and version 2 of a model)
2. Parent/Child—(The Model and Derived information from a model)
3. Sibling—(Different bits of derived data from the same model (e.g., an image view of a CAD model and an associated parameter)
4. Generational (derived)—The same piece of data extracted from version 1 or version 2 of a model
5. Data Context (Connected by how they are used for a mission or business purpose in a Magic Doc)
6. Data Flow (Connected via digital threads—data from one model into another)

Such data relationships can vary from one user to another even for the same overall digital workflow task.

Converting Digital Workflows into Digital Thread Scripts in an API-First Manner

FIG. 12 illustrates an exemplary digital engineering process in the aerospace industry, showing outer loop processes, according to one embodiment of the present invention. The left of FIG. 12 contains a simplified depiction 1202 of current engineering processes related to a digital engineering operation in the aerospace industry. The digital platform is instrumental in mapping those processes 1204 to digitized (software-defined) workflows. Each process step may be connected to software-defined digital threads (outer loop) using Git Workbooks or Runbooks. The generated workflows may belong to the inner or outer loops, as depicted in FIG. 11. For completeness and compliance, the digital platform may further add tests for the key steps and tasks of the digitized workflows in the outer loop 1206. These outer-loop threads incorporate built-in feature tests and unit tests, ensuring the digital thread is validated as it is being created. Finally, the scripts for the digital threads are executed, generating outputs that can be presented as dynamic reports, such as magic docs, linked to digital models or data artifacts. The digital platform may hence generate dynamic reports 1208 (e.g., Magic Docs) linked to the inner-loop models used by the digital workflows. In various implementations, the IDMP adopts an API-first approach, where digital workflows are structured around secure and modular API integrations. In the IDMP, digital threads link to specific data artifacts through authorized API endpoints in a zero-trust framework, ensuring secure access. Process steps are connected to software-defined workflows using tools like Git Workbooks or Runbooks, with user intent driving both platform and tool-specific API calls. This approach enables seamless integration, modularity, and validation, with built-in feature and unit tests ensuring the reliability of each API interaction throughout the system.

### Overview of AI-Assisted End-to-End Workflow Integration for Software Development

Broadly, the present invention relates to methods and systems for an artificial intelligence (AI)-assisted approach to integrate discrete workflows for software development within a digital model platform. This integrated workflow streamlines script generation, unit testing, and documentation, encompassing several interdependent stages of the software development process. These stages include one or more of digital model-specific or digital tool-specific function script generation, digital thread orchestration script generation, test script generation, script execution, revision, reporting, and comprehensive software documentation including commenting and annotation, each of which may be enhanced by AI assistance. By enabling the integration of these stages into a cohesive, unified, end-to-end workflow, embodiments of the invention allow smoother transitions between developmental stages, mitigating discrepancies and misalignments that may arise from traditional disconnected workflows during software development, ensuring efficient utilization of human SMEs” time while assisting with the inclusion of new digital model types or new digital tools, even when such new digital tools are non-interoperable with existing ones on the digital model platform.

Specifically, the methods and systems described herein leverage AI-assistance in a code-based digital model platform to implement, integrate, and streamline one or more of the following software development stages:
(a) model splice function script generation and/or digital thread orchestration script generation
(b) unit test scenario and/or unit test script generation
(c) unit test execution
(d) preparation of test reports upon execution of unit test scripts

Further after scripts of a model splicer and associated unit tests are created and verified to be correct, AI-assistance may be used to:
(e) comment/annotate the code
(f) generate customer-facing technical product documentations.

One feature of the invention is AI-assisted scripting of digital workflow operations from disparate software tools into a corpus of normative program code. Trained and/or fine-tuned on prior user-verified scripts and on resource-capability mappings provided by the digital model platform, an AI-assistance module may identify data schemas for newly incorporated digital models and generate function scripts that interface with various digital tool application programming interfaces (APIs) and the digital model platform API, allowing for seamless integration of new tools and models into the digital model ecosystem.

More specifically, as described in the context of FIGS. 8, 9, and 10, a “model splicing” process encapsulates and compartmentalizes digital model data and model data manipulation and access functionalities. Model splicer generation creates input and output schemas for model splices, as well as a library or pipeline of splicer function scripts that can be selectively integrated into any particular model splice. A model splicer for a given digital model type, when applied to a specific digital model file of the digital model type, extracts model data from the model file, instantiates API endpoints according to input/output schemas, and encapsulates a set of selected splicer function scripts that allow access to and derivation from the model data in the form of digital artifacts. The scripting of digital model operations enables universal customization and automation within a unified digital model platform for the creation and manipulation of complex systems comprising digital models, digital threads, and digital twins. This enables powerful artificial intelligence (AI) tools to be applied to model splicing, as well as to scripting of any testing operations involving individual scripts, digital engineering model files, digital threads, and digital twins.

For example, embodiments of the present invention may further employ AI-assisted cross-tool scripting for digital model operations, enabling the creation, manipulation, and testing of digital thread orchestration scripts that link multiple digital models using respective digital tool functions. It utilizes ML and AI techniques to create orchestration scripts that analyze and extract relevant information, implement appropriate operations, and control software tools, based on user request and user intent. For example, a script may be generated using a scripting AI module to validate a digital model against a specific criterion stated within a specific subsection of a compliance document, by linking a digital model splice and a document splice using an orchestration script (e.g., see FIG. 8). The automation of orchestration script generation and unit testing accelerates the ability to cover compliance regimes, thus significantly reducing the cost of validation and verification activities.

In the context of AI-assisted unit testing within the digital model platform as disclosed herein, the purpose of unit testing is to validate that each unit of software code performs as expected. Unit test scripts are specific sets of instructions that test the functionality and performance of these individual units of code. By utilizing ML techniques, embodiments of the present invention can create testing scripts to verify individual units or components of code, focusing on code logic and functionality of individual code units including AI-generated function scripts and orchestration scripts, and enhancing the efficiency and thoroughness of the unit testing process. By analyzing the resource-capability mapping of the digital model platform and the function script to be tested, AI modules employed for unit testing may generate comprehensive unit test scripts that cover various scenarios, input combinations, and expected outputs. An AI-generated test script may include assertions to verify the correctness of individual function scripts or methods within a digital thread or digital workflow. For example, a function script may be tested against a user-provided description to verify that it achieves the user intent correctly. Additionally, the AI module may optimize test coverage by prioritizing high-risk areas and generating tests for user-modified code in an iterative process. That is, AI-assisted unit testing facilitates efficient user feedback and enables programmable and dynamic changes to the testing scripts. This approach may significantly reduce the time and effort required for manual test script creation, while potentially improving the overall quality and reliability of the software by ensuring thorough unit testing of function scripts involving digital models and digital tools that are not necessarily interoperable with existing tools on the digital platform.

A specific use case for AI-assisted unit testing is the implementation of Continuous Compliance (CC) as an automated, unit-test-driven system that ensures digital threads and workflows adhere to verification and validation requirements throughout their lifecycle. CC integrates unit-tests to monitor compliance of individual artifacts or tasks within a digital thread in real-time, alerting users to non-compliance issues and pinpointing specific artifacts or updates that trigger failures. Specifically, generated function scripts derive digital artifacts, and corresponding unit testing scripts validate these artifacts against compliance requirements. The unit testing result of a generated function script may be cascaded through subsequent steps to infer its impact on the overall outcome of the digital thread. This approach allows for dynamic adjustment to changes in workflow parameters, individual steps, or artifacts, facilitating rapid iteration while minimizing non-compliance risks. The system leverages AI assistance to generate function scripts and unit tests, enabling continuous monitoring and providing real-time insights to ensure compliance across the entire digital thread.

AI-assistance may be further leveraged to enhance code annotation and the creation of test reports and end-user documentation within the digital model platform. Code annotation, or commenting, is a practice in software development where developers add explanatory notes in the source code. For example, code annotations can provide accurate insights into the input/output schemas and integration points. Comments provide context and understanding for the code, making it easier for other developers to understand the purpose and functionality of specific sections of the code. Technical product documentation or end-user documentation is a comprehensive explanatory document that provides information on the functionality, architecture, and usage of a software product. It serves as a guide for users and developers, providing detailed instructions on how to use and interact with the software product. While code annotation/commenting is applied on the granular code level, it supplements product documentation to provide means for knowledge transfer, maintenance, debugging/troubleshooting, auditing, and product scaling.

Embodiments of the present invention use AI modules to analyze the outcomes of test script executions, generate comprehensive test reports that highlight key findings, identify potential issues, and suggest areas for improvement. Such AI-generated reports may include detailed performance metrics, error logs, and visual representations of test results, potentially saving significant time for human SMEs. For end-user documentation, AI systems may analyze the resource-capability mapping of the digital model platform, user interactions, and any other existing documentation to automatically generate or update user manuals, API references and guides. The AI may also adapt the documentation style and content based on the target audience, ensuring that the information is presented in the most accessible and relevant manner. This AI-driven approach to documentation results in more consistent, up-to-date, and user-friendly resources, while reducing the workload on human SEMs and allowing them to focus on higher-level content strategy and quality assurance.

Thus, the disclosed methods and systems minimize context switches and reduce gaps in understanding between various software development stages on the digital model platform, including function and orchestration script generation, testing script generation, testing procedures, and documentation processes. The AI-assisted approach enables a seamless transition from initial scripting to rigorous testing, and ultimately to the creation of comprehensive end-user documentation. This integrated workflow may optimize the utilization of human SMEs while leveraging the capabilities of AI to ensure a cohesive and thorough development process from start to finish. Additionally, streamlined bidirectional information flow and data-driven action triggers assist the integration of the aforementioned stages of the software development workflow with expert feedback.

### Exemplary Use Cases for AI-Assistance in Model Splicing and Digital Threading

Before discussing AI-assisted end-to-end workflow integration for software development, several use cases for AI-assistance are discussed next in the context of model splicing and digital threading.

### AI-Assisted MBSE Model Splicing and its Applications

FIG. 13 shows an exemplary use case of AI assistance in model splicing an input Model-Based Systems Engineering (MBSE) model file and scalable sharing of the model on an interconnected digital engineering platform (IDEP), in accordance with some embodiments of the present invention. Recall that model splicing is the processing of an input model file by a model splicer, and model splicer generation refers to the process of setting up a model splicer, or establishing an all-encompassing framework or template, in the form of a collection of generated scripts from which individual model splices can be deduced. In other words, model splicing, or the generation of individual model splice functions may be considered as a special case of model splicer generation. Different users with different application use cases may create or customize, with or without AI-assistance, input/output schemas and individual splice functions for a digital model type and/or digital tool, and these input/output schemas and splice functions may be collected by the IDEP as part of a model-specific or tool specific model splicer, for splicing future input DE models.

In FIG. 13, A user uploads a file (e.g., MBSE) to the IDEP, which then analyzes the file to extract relevant information. One or more AI algorithms are deployed to analyze the input data file to extract relevant information, to suggest appropriate API functions and parameters for the file, to create splice function scripts to control digital tools, and to suggest sequences of scripts. User inputs may be incorporated to create a variant of the input file. The digital tool may be commanded to create or modify digital files, which enables the system to create functions that allow dynamic changes to the files. Finally, the system may provide the user with a wrapper, allowing a sandbox for a model.

As described earlier with reference to FIG. 2, an interconnected DE and certification ecosystem or an IDEP may include a user device 1306A, API 1306B, or other similar human-to-machine, or machine-to-machine communication interfaces operated by a user 1304. The ecosystem may further comprise a computing and control system 1308 (“computing system 1308” hereinafter) connected to and/or including a data storage unit 1318, a machine learning (ML) and artificial intelligence (AI) engine 1320 (“AI engine” hereinafter), and an application and service layer 1322. In some implementations, the data from multiple uses of the ecosystem (or a portion of said data) can be aggregated to develop a training dataset. For example, usage records 1317 collected via computing system 1318 may be de-identified or anonymized, before being added to the training set. In some embodiments, a typical workflow may take in as input various DE tools 1331 and information from a repository of common V&V products (not shown).

In a first sequence of steps, user 1304 uploads, at a step 1351, an MBSE file onto the IDEP, which receives, at a step 1353, the MBSE file. The ML engine on the digital engineering platform then analyzes, at a step 1355, the MBSE file to extract relevant information. AI engine 1320 that implements one or more ML or AI algorithms then suggests, at a step 1357, appropriate API functions of a DE tool applicable on the MBSE file and parameters for the MBSE file. Next, AI engine 1320 creates, at a step 1359, scripts to control the DE tool. Then, the system commands, at a step 1367, the appropriate DE tool to create or modify the MBSE file.

In an alternative sequence, AI engine 1320 suggests, at a step 1361, the sequence of the scripts, and the user 1304 provides text inputs at a step 1363. The user inputs can help create, at a step 1365, a variant of the MBSE file. The sequence then proceeds to step 1367 as described earlier.

After step 1367, AI engine 1320 creates, at a step 1369, functions that allow dynamic changes to the MBSE file. Finally, the system outputs, at a step 1371, a model splice or a wrapper allowing a sandbox for a model.

The AI-assistance algorithms (1), (2), and (3) shown in FIG. 13 may be created in AI engine 1320 by utilizing a combination of supervised and unsupervised learning techniques. Once an AI model is trained, it can then be applied to the MBSE file to suggest appropriate functions and parameters, create scripts to control the DE tool, or suggest the sequence of scripts for optimal results. Additionally, AI engine 1320 may also be trained on new data, improving its performance over time.

An implementation example for the AI-assistance algorithms is through the use of fine-tuned language models. In this scenario, AI engine 1320 may be trained on a dataset of user inputs and example scripts based on MBSE files. The fine-tuned language model is then able to understand the specific language and context of the MBSE files, making it better suited to suggest appropriate functions and parameters, create scripts to control the DE tool, and suggest the sequence of scripts for optimal results. Additionally, as new data is added, AI engine 1320 may continually improve its performance over time. This approach allows for greater customization and flexibility, as the AI engine can be tailored to the specific needs and requirements of the user.

In some embodiments, external feedback (e.g., from a subject matter expert) can occur in locations of the process. For example, when an AI algorithm suggests API functions and/or parameters, an external expert user can provide feedback to accept the suggestions or to suggest revisions. In another example, when another AI algorithm suggests scripts to run one or more DE tools for the input MBSE file, an external expert user can accept the scripts or suggest revisions if needed. In a third example, when another AI algorithm suggests the linking of scripts in sequence, the external expert user can provide feedback to accept the proposed sequence or suggest revisions in sequence. Such expert user actions, system actions, and user inputs may all be logged for training AI systems capable of API script and splice function generation, AI-assisted generation of model splicers, and/or autonomous model splice linking.

### AI-Assisted Model Linking and Digital Threading

AI-assistance may also be employed in suggesting and linking digital model splices into a digital thread for a given digital task on the IDMP. For instance, a user may upload an example or template report (e.g., an Aircraft certification report) to be completed to the IDMP, and a set of requirements or user needs (e.g., an excel file with range, weight, cost, etc.) that has previously been prepared. The user may request that the IDMP assist in completing the certification report and generate a results report. The IDMP may identify from the requirements file one or more input digital model files and perform model splicing of uploaded or identified files. The system as disclosed herein may then analyze characteristic attributes of such input digital models obtained (e.g., via model splicing or model data parsing) to find a matching template that can be used to generate a digital thread orchestration script to link multiple digital models and generate the desired reports. For instance, a generated digital thread orchestration script may access several model splices and provide linkages or connections among these model splices. Thus, the IDMP provides to the user a set of digital models that are appropriately linked to meet the user's request of completing the certification report and generating a result report. Note that in a degenerate case, the user may request that a splice function script be created for accessing a digital artifact needed to complete a portion of the certification report, instead of a full digital thread orchestration script that accesses multiple digital models.

Thus, AI-assistance may be employed to recommend model types and linkages to existing model splices, to provide to a user a complete set of AI-generated and AI-linked models that satisfy human requirements along with a required certification report. The linking of different model splices and manipulation of digital models may be achieved via splicer scripts as disclosed herein. Many of such scripts used on the IDMP fall into one of two categories. A “model splice function script,” “function script,” “splicer script,” or “API script” provides access to and enables manipulation of digital model data and digital artifacts. A function script is built from an API library of a specific digital tool (e.g., CAD, CFD, FEA, etc.). Orchestration scripts manipulate digital threads and digital twins at an application plane or a control/analysis plane to control or analyze linked model splices. An orchestration script is capable of calling function scripts, for example via microservices or DAG tasks, to coordinate multiple different digital tools. A degenerate orchestration script involving a single digital tool is a function script. In what follows, any discussion of orchestration scripts is equally applicable to function scripts, and vice versa.

### AI-Assisted Streamlining of Script Generation, Unit Testing, and Documentation

Streamlining of AI-assisted model splicer script generation and unit testing improves on the modular paradigm of software development by promoting an inherently integrated and interdependent workflow. Individual stages including splicer script generation/update, unit test script generation/update, test execution, and test report generation and result analysis can be performed iteratively with expert feedback but minimal other human-intervention. Enabled by AI-assistance, additional stages such as code annotation and product documentation from the conventional software development lifecycle can be further integrated into this unified workflow. This AI-assisted workflow integration improves the efficiency and effectiveness of the software development processes, ensuring a smoother transition between developmental stages and a comprehensive understanding of the software product.

FIG. 14 shows an illustrative comparison between a conventional software engineering workflow and an AI-assisted, integrated workflow, according to some embodiments of the present invention.

In a conventional approach 1410, each process shown may be carried out by different human experts. For instance, based on an input process 1415 conducted via a user interface, an SME may create, at a process step 1420, a model splicer script, which then undergoes various types of system-wide testing 1425 (e.g., exhaustive unit testing, large-scale end-to-end testing etc.) conducted by a software engineer. Subsequently, a technical writer may undertake the documentation of the software product at a process step 1430. The generated function script, testing results, and product documentation may be presented on the user interface at a process step 1440. While testing results aid in revising and modifying model splicer scripts and provide accuracy and reliability data for product documentation, the human-led communication between these siloed processes, each handled by different human experts, can be susceptible to errors and delays. This fragmented and disjointed approach can lead to inconsistent, disparate information flow and potential inefficiencies throughout the software engineering lifecycle.

By comparison, an AI-assisted integrated workflow 1450 automates and streamlines a function script generation stage 1460, a unit testing stage 1468, and a code/product documentation stage. This streamlined process 1450 facilitates immediate interaction and feedback among the various stages, empowering a single human expert to handle nearly all the pivotal stages of software development within an IDMP. A smoother transition among development stages mitigates the possibility of discrepancies or misalignments that may arise due to the disconnected nature of transitional workflows. Embodiments of the present invention efficiently utilize the time of a human SME (e.g., for a digital tool) without risking context switches or gaps in understanding between a function script, its testing scripts, or any subsequent documentation. This integrated workflow harnesses the power of AI to enhance software development efficiency and ensure an end-to-end understanding of the software, starting from initial scripting to rigorous testing, and concluding with comprehensive end-user documentation.

Expanding upon the streamlined process 1450, FIG. 15 shows an exemplary implementation architecture for an integrated workflow, according to some embodiments of the present invention. In this illustrative example, the IDMP platform first receives a user input or request 1510 for a specific splicer function or orchestration script to be implemented with one or more specific digital tools. The IDMP may optionally another user input 1512 for specific digital tool libraries. In various embodiments of the present invention, user input 1510 may be a function name, a function definition with input and/or output arguments, a function description written in natural language or other human-readable formats, one or more exemplary use cases that indirectly describe the function's expected behavior, an indication of model updates or digital tool updates, or in any appropriate forms that conveys the function to be scripted.

Resource-Capability Mappings Including Reference about Digital Tools

In order to understand the context and syntax for function script generation using a desired digital tool, the IDMP may utilize a resource-capability mapping 1530 to provide a comprehensive framework for identifying and linking resources available on the IDMP with the capabilities they enable or support. An exemplary component of a resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Similarly, as a component of the resource-capability mapping or the IDMP API, documentation specific to the target digital tool, such as API references, command structures, and tool-specific syntax guidelines may be used in fine-tuning the scripting AI agent.

In FIG. 15, resource-capability mapping 1530 includes digital tool documentations 1532 which may include API documentation highlighting the structure and application of the code for potential developers and users. Digital tool documentation contains the definitions of functions, target audience, input-output data, and dependencies that the tool might have. Specifically, command references may be provided to list all available commands, options, parameters, with explanations of their usage and syntax. API documentation may further provide details on how to interact with the tool programmatically. In an exemplary implementation, a general purpose LLM (e.g. GPT4, LlaMa2) may be fine-tuned with a digital tool's documentation, elucidating its use in a step-by-step manner, with suggestions for scripts for specific functions.

In some embodiments, a second reference 1534 may be considered as part of resource-capability mapping 1530, involving existing open source libraries to accommodate the digital tool or related commonly used tools. Open source libraries are collections of pre-written code that developers can use to save time and effort in writing code from scratch. These libraries can be used to perform common tasks, and they can be integrated into larger software projects. In the context of digital tools, these libraries can provide functions and scripts that can be used to interact with and manipulate digital engineering models. For instance, the OpenpyXL library for EXCEL may be used to generate function scripts for EXCEL model files. In case the requisite open source libraries do not exist, an AI assistance module 1536 such as a fine-tuned general purpose LLM may be employed to create a reference library of functions and scripts 1538, with optional expert feedback to ensure the breadth, depth, and reliability of the resulting reference libraries.

### An Exemplary Streamlined Implementation

FIG. 15 further shows an exemplary streamlined implementation 1540 of four key development stages 1542, 1544, 1546, and 1548 for a given digital model-type file. Each development stage is discussed in detail below. Corresponding AI-assistance modules 1543, 1545, 1547, and 1549 enable time-efficient utilization of an SME's expertise and effort-less iterations among the various stages. The integration of AI assistance, reinforced with expert human feedback, extends the application of this implementation to a wide range of digital models and digital tools.

Function script generation 1542: as illustrated by exemplary implementations shown in FIGS. 25 to 28, model splicer script or function script generation based on user input 1510 may include defining the input/output schema for a model splicer, followed by utilization of AI-assistance module 1543 to create new scripts while adhering to the predefined schema. AI-assistance module 1543 may be implemented as a scripting AI agent fine-tuned for specific digital tools and specific clients.

Unit test description, generation, execution, and reporting 1544: to validate the functionality of the generated function script, unit test scripts may be created. For every splicer function script to be tested, one or more unit test scripts may be generated based on the function description and execution schema of the function script. Function description provides AI-assistance model 1545 with information about the purpose and expected behavior of the splicer function, while function execution schema provides information about the actual behavior of the splicer function when it is run. For example, the function description may be user input 1510 or generated from user input 1510. The function execution schema may comprise input/output arguments/schemas that indicate how the splicer script can be executed.

As illustrated by exemplary implementations shown in FIGS. 29 to 35, AI-assistance module 1545 may analyze the function description and execution and proposes test scenarios that verify the correct functionality of the model splicer scripts. These test scenarios are designed to cover a wide range of conditions, typical use cases, and necessary edge cases, ensuring that the function script performs as expected in all situations. In some embodiments, a context AI model may be utilized as part of the scripting AI agent to generate test scenarios. An exemplary context AI model may be based on one or more large transformers or LLMs (e.g., a closed-source LLM such as GPT4). The context AI model identifies steps that need to be carried out by a unit testing script, and may further identify permutations of input parameters that need to be tested and corresponding outputs.

The proposed test scenarios may then be converted into unit test scripts, which upon execution tests the functionality of the generated function script. In some embodiments, a syntax AI model may be utilized as part of the scripting AI agent to generate one or more scripts that implement the proposed testing steps. Such testing scripts may include placeholder variables for parameters to be substituted during test execution. A syntax AI model may be based on open-source transformers or LLMs, and may be fine-tuned to generate API scripts or orchestration scripts that call upon functions of specific digital tools.

By employing AI in unit test script generation, a traditionally manual and time-consuming stage of the software development process is automated and integrated into the workflow. This not only improves the efficiency of the process but also enhances the accuracy and comprehensiveness of the generated test scripts, as they are produced based on a detailed analysis of the function description and execution schemas and are not subject to human error.

Upon the generation of unit test scripts, the next phase in the workflow may involve the execution of these scripts and the preparation of test reports. The execution of the unit test scripts verifies the functionality of the generated function script. Each unit test script is run, and the function script's performance is evaluated against expected outcomes. This process ensures that the function script performs as expected under various conditions. Any detected discrepancies may be flagged for further investigation. This automated execution and evaluation process enhances the efficiency and accuracy of the unit testing phase, as it is capable of running a large number of tests in a short period of time and is not subject to human error.

In some embodiments, a fine-tuned syntax AI model generates template testing scripts that include a variable (i.e., a placeholder for a parameter related to the function script). The generation of variable parameter scripts (i.e., template scripts) enables the anonymization of enterprise-confidential parameters through the use of variable “parameter placeholders”, a process that may be referred to as “placeholder anonymization”. This process enables customer data sovereignty. During test script execution, a parameter substitution process replaces the variables with enterprise-confidential parameters. For example, the enterprise-confidential parameters may originate from enterprise documentation and may be inserted by the user, or selected by the user from a list extracted from enterprise documentation, may be selected by the user from a list generated by an enterprise AI module from enterprise documentation, may be inserted by an algorithm from a parameter table, or may be inserted by an enterprise AI module.

In some embodiments, test reports are prepared with AI-assistance from the execution of the unit test scripts, to provide a detailed account of the test results, including information about the performance of each unit test script, any discrepancies detected, and the overall functionality of the generated function script. A comprehensive testing report can provide a clear and concise overview of the test results, making it easy for SMEs to understand the performance of the function script and identify any areas that may require further investigation or improvement. That is, unit testing results may inform changes to function script design. For example, the user may interact with a Reinforcement Learning Human Feedback (RLHF) loop to approve or reject steps within the generated function script or testing script. The user may also update a script manually, if necessary. The streamlined nature of the workflow shown in FIG. 15 enables direct data flow and fast interactions between function script generation and unit testing stages.

Code annotation, commenting, and cleaning 1546: Following test creations, commentary and explanatory notes may be added to the source code at appropriate locations via AI-assistance module 1547, to outline the purpose, functionality, and any non-intuitive implementation details of a generated function script.

Code annotation or commenting is a practice in software development where developers add explanatory notes in the source code. These comments provide context and understanding for the code, making it easier for other developers to understand the purpose and functionality of specific sections of the code. Technical product documentation is a comprehensive explanatory document that provides information on the functionality, architecture, and usage of a software product. It serves as a guide for users and developers, providing detailed instructions on how to use and interact with the software product.

AI-assistance module 1547 may be capable of understanding the context and semantics of the code, enabling it to generate accurate and meaningful comments. For instance, if a function in the code performs a complex calculation, AI-assistance module 1547 may generate a comment that explains the calculation in a clear and understandable manner. Similarly, if a function has a non-intuitive implementation detail, such as a workaround for a known issue or a performance optimization, AI-assistance module 1547 may generate a comment that explains this detail. Such comments provide context and understanding for the code, making it easier for other developers to understand specific sections of the code, facilitating future development and maintenance activities. To inspire clarity, type signatures may be provided for all functions and variables. AI-assistance may then be utilized to offer suggestions for additional comments based on the code and its context analysis.

As indicated by the bidirectional arrow between function script generation stage 1542 and code commenting stage 1546, AI-assistance module 1543 and AI-assistance module 1547 may work hand-in-hand. In some embodiments, code annotation/comments are generated at the same time with the function script, rather than separately after testing. In some embodiments, expert feedback provided via the commenting stage 1546 may trigger modifications and revisions to the function script itself. For example, expert feedback provided via the commenting stage 1546 may include updates to the function description used in prompting AI-assistance module 1543 for function script generation.

Product Documentation 1548: Finally, customer-facing, product-specific external documentation for function scripts may be generated via AI-assistance module 1549. Product documentation serves as a comprehensive guide for users and developers to provide detailed instructions on how to use and interact with a software product. AI-assistance module 1549 is capable of understanding the code and generating accurate and comprehensive documentation to ensure that the documentation is up-to-date, accurate, and easy to understand, providing users and developers with a valuable resource for understanding and using the software product.

A model splicer is a specific example of a software product that may involve multiple interacting model splice functions or function scripts. Once individual units are tested, higher-level testing schemes such as QA/QC testing, usability testing, end-to-end testing, performance testing, security testing, and the like may be performed in a similar fashion. Suite testing scripts may be generated for the execution of multiple interdependent function scripts, orchestration scripts, digital models, or higher level system components, to validate the software or code on a system level. Accordingly, product documentation may involve development of reference documentation reflecting different classes, functions, and their respective records in a systematic manner. Additionally, an easy-to-follow guide on initializing the API use may be outlined with examples provided for essential functions. AI assistance module 1549 may be integrated into the streamlined implementation in FIG. 15 to maintain updated documentation reflecting codebase changes, forecasting what additional information might be beneficial, and generating supplementary examples.

In various embodiments of the present invention, AI-assistance modules 1543, 1545, 1547, and 1549 may be the same implementation, for example, using Github CoPilot and fine-tuned from general purpose language models such as GPT4 or LlaMa2, which are capable of generating human-like text based on the input provided to them. Fine-tuning to the task of software development within the IDMP involves training the model on a corpus of text related to software development, including code, documentation, tool libraries, and other relevant materials. The training process involves presenting the model with examples of input-output pairs, where the input is a piece of text related to software development and the output is the desired response, such as a piece of code, a comment, or a piece of documentation. The modules learn to generate the desired response based on the input, improving its performance over time. In some embodiments, different AI architectures or implementations may be used for AI-assistance modules 1543, 1545, 1547, and 1549, where output from one module may become the input to another. For example, code generated by AI-assistance module 1543 may be provided as prompts to AI-assistance module 1547 to generate comments.

Thus, once an AI-assistance module has been fine-tuned, it may be employed in various stages of the software development workflow shown in FIG. 15. In the generation of model splicer function scripts and unit testing scripts, the AI-assistance module may be provided with predefined input/output schemas for the model or the function description and execution of the function scripts, respectively. The module generates the scripts by analyzing the provided information and producing code that adheres to the input. In code annotation, the AI-assistance module may be provided with the code of the function scripts, and comments may be generated to provide a clear and concise explanation of the function and its implementation details. In the production of technical product documentation, the AI-assistance module may be provided with the code of the software product, and may generate documentation that accurately reflects the different classes and functions in the code.

### An Exemplary Process for Script Generation and Unit Testing Workflow Integration

FIG. 16 is an exemplary flowchart showing a process for AI-assisted workflow integration for software development on the IDMP, in accordance with some embodiments of the present invention.

At a step 1610, a user selection of a target digital tool is received. The target digital tool is selected from a plurality of digital tools that may not be directly interoperable with each other. In some embodiments, the IDMP may present the user with a list or menu of supported digital tools, such as a dropdown menu or a graphical interface displaying icons for each tool. The user can then explicitly choose the desired target digital tool from this presented set of options. This method ensures that the user is aware of all available tools and can make an informed selection. In cases where users are familiar with the IDMP's capabilities, they may provide the name or identifier of their chosen target digital tool directly. This approach assumes the user's awareness of the tools supported by the system. For example, a user might input “EXCEL,” “AutoCAD,” or “MATLAB” as part of their request, selecting that tool for the desired operation. The IDMP's capability may be described by a resource-capability mapping (e.g., platform documentation, API libraries, individual tool reference documents), which identifies digital tools already on-boarded onto the platform and digital model types supported.

At a step 1620, the IDMP may receive a user request comprising a description of a function script executable by the digital model platform on a target digital model type associated with the target digital tool. Such a description of the desired script may take on various forms, providing flexibility for users to communicate their needs. For example, the user may provide a specific name for the desired function, such as “FindCenterOfGravity,” “CalculateStress,” or “SortTable.”. Alternatively, the request may include a more formal definition of the function, specifying input and/or output arguments. For example: “Function: ConvertUnits(value: float, fromUnit: string, toUnit: string)->float.” The users may describe the desired functionality in plain natural language, such as “I need a function that exports a sheet using its name as CSV.” Similarly, the description may be provided in various human-readable formats, including pseudocode or a structured outline of the function's behavior. The user may also describe one or more example scenarios that illustrate how they expect the function to behave. For instance, “When given a CAD model of a gear, the function should output the number of teeth.” In some embodiments where function script generation and unit testing are triggered by digital model or digital tool updates, the user request may comprise a reference to or a description of the update. In various embodiments, the IDMP may accept other forms of input that effectively convey the intended functionality, such as flowcharts, diagrams, or references to similar existing functions. By accepting diverse forms of function descriptions, the IDMP accommodates users with varying levels of technical expertise and communication preferences, and allows imprecise or ambiguous representation of the desired functionality, accommodating users who have a general idea of what they need but may not be able to provide precise technical specifications. This flexibility allows the AI-assisted system to interpret and process user requirements effectively, regardless of how they are expressed. For example, the user may provide a high-level statement like “I need to analyze the stress points in this bridge design” or “Create a function that optimizes the airflow around the car body.” These descriptions convey the general intent without specifying exact parameters or methodologies, allowing the AI-assisted system to interpret and refine the requirements based on its understanding of the target digital tool and model type.

At at step 1630, based on the user selection and the user request, a scripting AI agent is fine-tuned on prior user actions involving the target digital tool on the digital model platform, and on a resource-capability mapping of the digital model platform, wherein the resource-capability mapping comprises documentation specific to the target digital tool. This fine-tuning process adapts the scripting AI agent to understand and work with the specific syntax and capabilities of the target digital tool within the context of the digital model platform. An exemplary process for model splicer generation via Large Language Models (LLMs) with prompt-response fine-tuning is discussed in the context of FIG. 29.

An AI agent or tool agent is a software entity or module that takes instructions from the IDMP (e.g. enclave 302) and acts on behalf of a user or another program to perform specific tasks or operations related to an AI model or a digital tool. An AI agent or a tool agent may be designed as part of the IDMP but deployed by a customer within a secured customer environment to interface in-between the IDMP, AI models, and/or proprietary tools the customer is licensed for. Inside the customer environment, modular agents interact directly with the domain-specific tools and models to allow for bi-directional data flow across distributed tools.

The fine-tuning process customizes the scripting AI agent according to particular requirements of the target digital tool. For example, if the target tool is a specific CAD tool, the scripting AI agent is fine-tuned to use tool-specific commands, syntax, APIs, and to understand tool-specific data structures, file formats, and operational constraints. Furthermore, fine-tuning of the scripting AI agent may offer customizability based on user needs, where the system may adapt to specific enterprise requirements, industry standards, or unique workflows that a client may have. For instance, if a client has specific naming conventions or preferred coding styles, the fine-tuned scripting AI agent may incorporate these preferences into its script generation process.

In various embodiments, the fine-tuning process may be based on various sources of information, including but not limited to, prior user actions involving the target digital tool on the digital model platform and a resource-capability mapping of the IDMP. Such prior user action data may include historical data on how users have interacted with the IDMP or target digital tool (e.g., triplets of user request, function script implementing the user request, and user verification results of the function script), common operations performed using the target digital tool, successful implementations of similar functions using analogous digital tools, user feedback and verification of system-generated function scripts, and the like. By leveraging information collected through the IDMP, the scripting AI agent may learn from past experiences and improve its ability to generate relevant and effective scripts. Note with a zero-trust, zero-knowledge implementation of the IDMP, any prior user action data may be appropriately de-sensitized.

In some embodiments, training data augmentation may be used to artificially increase the training dataset by creating synthetic data from existing, verified data, and to reduce model overfitting. For example, synthetic data such as variations of previously valid data elements may be created and formatted to reflect real-world, user-generated data. For function script generation, an abstract syntax tree may be used to inform what elements of existing user-verified scripts and platform API may be varied, and a rule-based approach may be used to generate specific variations. Such variations may be checked by leveraging validation and verification capabilities within a compiler. That is, a script variation can be queued at the compiler to check for syntax, and if it compiles, it is considered valid and can be added as synthetic training data; if not, alternate perturbations of the abstract syntax tree may be pursued.

A resource-capability mapping of the digital model platform provides a comprehensive framework for identifying and linking available resources with the capabilities they enable or support. An exemplary component of a resource-capability mapping is the IDMP API, or platform API, where the resource refers to third-party tools and functions integrated into and accessible via the IDMP, and where the exemplary capability refers to IDMP functions written in scripts for completing certain tasks using the available resource. Similarly, as a component of the resource-capability mapping or the IDMP API, documentation specific to the target digital tool, such as API references, command structures, and tool-specific syntax guidelines may be used in fine-tuning the scripting AI agent.

In addition to conventional fine-tuning approaches of AI agents, in some embodiments, a Retrieval Augmented Generation (RAG)-based approach or a Low-Rank Adaptation (LoRA) approach may be used to fine-tune the scripting AI agent. In a RAG-based approach, fine-tuning comprises augmenting the scripting AI agent's knowledge by retrieving relevant information from a knowledge base during a subsequent script generation process 1640, discussed next. This retrieval knowledge base may contain tool documentations, API references, and exemplary use cases specific to the target digital tool. This knowledge base may further contain user-specific information such as enterprise-specific guidelines or preferences. When generating scripts, the scripting AI agent queries the knowledge base to retrieve relevant information about the target tool's syntax, capabilities, and best practices, and/or user-specific information. This knowledge base may be regularly updated with new information (e.g., version updates to the target digital tool), allowing the scripting AI agent to adapt to changes in the target digital tool's capabilities or schema/syntax over time. On the other hand, LoRA efficiently tunes large AI models by reducing the number of trainable parameters, focusing on adding smaller, trainable, low-rank matrices to the pre-trained AI model's weight matrices, capturing tool-specific knowledge without significantly increasing the AI model's parameter count. The LoRA matrices may be trained on a dataset or knowledge base specific to the target digital tool and/or specific to the user. This LoRA-based approach allows for quick adaptation to different digital tools by swapping out the LoRA matrices, enabling the IDMP to efficiently support multiple tools and to rapidly adapt to unique client requirements.

Furthermore, in some embodiments, by training or fine-tuning on platform-wise resource capability mappings and historical usage data, the scripting AI agent may generate orchestration scripts involving multiple tools, some of which may not be directly interoperable, thus enabling complex digital workflows or digital threads that span across different digital tools within the IDMP. Such training or fine-tuning of the scripting AI agent may involve cross-tool workflow analysis to learn common digital model and digital tool usage and linkage patterns, information about tool compatibility and interoperability, syntax adaptation necessary to accommodate each digital tool involved in the orchestration script, and how to optimize the orchestration process to minimize data transfer overhead or to reduce errors and exceptions.

In short, by fine-tuning the scripting scripting AI agent in these manners, the IDMP may enhance its ability to generate accurate, efficient, and tool-specific function scripts, and complex orchestration scripts that seamlessly integrate multiple tools into a digital thread or digital workflow, potentially improving the overall effectiveness of the digital model platform in meeting user needs.

At a step 1640, a function script is generated using the scripting AI agent, where the function script calls a tool function from the target digital tool, and where the function script when interpreted by the IDMP, generates a digital artifact from a digital model representation of the digital model type. For example, a transformer-based scripting AI agent may first analyze the user request and the context provided by the fine-tuning process, and based on its understanding of the user's intent as well as the target digital tool's capabilities, identify appropriate tool functions to call within the script. The scripting AI agent may first create a data flow structure or framework for the target digital tool, including but not limited to necessary imports, temporary and placeholder files, variable declarations, dependencies, configurations, function input and output schemas, and error handling mechanisms (e.g., see FIG. 19). The scripting AI agent may further construct the function script with appropriate input and output schemas, and incorporate the call to the identified tool function within the script, ensuring proper syntax and parameters passing. The scripting agent further generates code to process an output of the invoked tool function and generate the desired digital artifact (e.g., a modified digital model representation, an extracted model datum, etc.). When executed by the IDMP, the generated function script may load the digital model presentation, prepare model data for a tool function, and call the tool function from the target digital tool, process the output of the tool function to generate the digital artifact, and store or return the digital artifact as specified by the user request.

Within the present disclosure, a “digital model representation” of a given digital model may be any embodiment of the digital model in the form of digital model file(s), model splices, or collections of digital artifacts retrieved or derived from the digital model. In some embodiments, a digital model representation comprises model-type-specific locators to digital model data and metadata, potentially including standardized input and output API endpoints for accessing and manipulating the digital model data. Discussions related to the usage of model splices in the present disclosure are applicable to any other forms of model representation as well.

An exemplary implementation for AI-assisted model splicer generation and digital model function script generation are provided in the context of FIGS. 26 to 29. In this particular example, new digital model types and digital tools are integrated into the IDMP, through three main stages: customer commercial assessment, scope and design definition, and model splicer development. Various AI assistance modules are employed throughout these stages to automate and integrate the workflow. Specifically, AI-assistance, particularly in the form of Large Language Models (LLMs) are employed to generate input/output schemas, design mockups, and function scripts for different digital tools and model types. The AI models are trained on a variety of data sources, including IDMP resource-capability mappings, API documentations, and historical user interactions collected through the IDMP. The function script generation process involves steps such as scraping API documentation, converting text into embeddings, storing information in vector databases, and using advanced LLMs to construct scripts based on user requests or queries. Furthermore, the AI models discussed may undergo continuous fine-tuning based on user feedback and interactions. This fine-tuning process allows the system to adapt to specific tools, tasks, and customer needs, by implementing respective components for processing user input, generating structured prompts, and customizing LLMs for enterprise-specific requirements. Measures for data security and privacy may also be incorporated, including tokenization and zero-knowledge implementations, to protect sensitive information while still leveraging the power of AI-assisted script generation. Again, discussions regarding AI-assisted function script generation in the context of FIGS. 26 to 29 are equally applicable to AI-assisted orchestration script generation.

At a step 1650, a unit test script is generated using the scripting AI agent. The unit test script is executable by the IDMP, wherein the unit test script when interpreted tests the function script against the description of the function script. In the present disclosure, unit testing refers to the testing of individual units or components of a software in isolation. That is, the unit test script generated at this step focuses on checking whether the tested function script behaves as expected, comparing actual outputs with predicted outputs based on given inputs, and thus verifying the functionality of the generated function script which itself may be a subunit of a digital thread that involves multiple functions in a digital thread orchestration script. Each unit test examines the generated script independently without considering its interactions with other parts of the digital thread. In the context of digital threading and continuous compliance discussed with reference to FIGS. 23 and 24, each generated function script, when executed, may derive a digital artifact to be validated, and a generated unit testing script, when executed, may check the digital artifact against a compliance requirement. That is, a successful unit test of a generated function script validates the digital artifact derived via the function script. Subsequently, the unit testing result of a generated function script may be cascaded throughout ensuing steps to infer its impact on the overall outcome of the digital thread.

In one exemplary embodiment, the scripting AI agent may first analyze the input function script description and the generated function script itself, and identify key test cases that should be covered, including normal operation scenarios, edge cases, and potential error conditions. The scripting AI agent may then create an overall structure for the unit test script, including necessary imports, setup and teardown methods, and individual test functions for the identified test cases. Each specific test function may set up any required input data or mock digital models, call the function script with appropriate parameters, and compare the actual output to an expected output based on the function description. The test script may further include assertions to verify that the function's behavior matches its description. In some embodiments, the scripting AI agent or a separate documentation AI agent may add annotation or comments to explain the purpose of each test and how it relates to the function description.

An exemplary implementation for AI-assisted unit testing and documentation are provided in the context of FIGS. 30 to 36. In this particular example, the streamlined AI-assisted unit testing workflow is implemented through four stages, including code integration for data collection, test scenario generation, test script generation, and test script execution. Code integration for data collection facilitates the recording and storage of user workflows and actions that may be used as training data for training or fine-tuning the scripting AI agent. For example, JavaScript code may be injected into web pages to record user actions and interactions with the IDMP. The same scripting AI agent, or a separate testing AI agent may be deployed to generate human-readable test scenarios and corresponding test scripts. Again, such AI agents may be trained or fine-tuned on historical data, user actions, and platform documentation such as resource-capability mappings. The generated scenarios and scripts may undergo human expert review and approval, allowing for iterative improvement based on feedback. This process may be applied to various unit testing types, including specification testing, feature testing, and API testing.

Next, at a step 1660, the unit test script is interpreted or executed by the IDMP to generate a verification result for the function script. When executed by the IDMP, the unit test script may set up any necessary test environment, execute each test function, call the generated function script with various input permutations, and verify that the function script's behavior matches its description.

At a step 1670, a test report may be generated based on the verification result, for example indicating any discrepancies between the function's behavior and its description. Such reports may also provide insights into the performance of the automation scripts and highlight potential issues. Furthermore, at a step 1680, a user feedback may be received, and at a step 1690, the function script may be updated based on the user feedback. Thus, the test results and user feedback may be collected to serve as additional training data for the AI models and contribute to the continuous improvement of the AI-assisted script generation and unit testing process. This approach allows for efficient error replication and the generation of tests for analogous scenarios, enhancing the overall resilience and reliability of the script generation and testing process.

### Parameter Substitution as a Zero-Knowledge Measure

Parameter substitution was previously discussed in the context of unit test generation and execution process 1546. In some embodiments, a zero-knowledge (ZK) architecture for the IDMP is implemented where the IDMP's Software Development Kit (SDK) prevents any customer data that is deemed sensitive to be sent through an IDMP API. This ZK objective is achieved through a process of cryptographic tokenization. Cryptographic tokenization identifies sensitive data (e.g., through customer input) and maps each sensitive data element (e.g., digital model, digital artifact, document) with a cryptographic token and a cryptographic identifier. Each cryptographic token includes metadata describing the data element. In cryptographic tokenization, metadata from the cryptographic tokens, rather than the data elements themselves, are used to train the AI-assistance modules. An AI-assistance module training data set may hence include a customer data sovereignty-preserving training data set that consists of sample contextual data associated with sample digital tasks, and corresponding sample template scripts. The generation of each sample template script includes the steps of receiving an orchestration script implementing an associated digital task, identifying sensitive data elements within the orchestration script, and replacing each sensitive data element with its mapped metadata.

Cryptographic tokenization replaces sensitive data with the cryptographic identifier when a data element is to be used outside the customer environment, and exchanges the cryptographic token back for the mapped data elements for use within the customer environment, in a process step called cryptographic de-tokenization. The ZK architecture hence stores the sensitive data elements within the customer's environment (e.g, on the customer's network).

Parameter substitution is a further component of the ZK architecture. Specifically, the parameter substitution process contributes to the ZK architecture by mapping generic parameter names or generic API function details (e.g., function names, inputs, outputs) to specific software tool resources or software tool functions within a customer environment. Consequently, the scripts generated by the scripting AI agent support the ZK architecture by requiring an explicit parameter substitution step within the customer environment.

### An Exemplary System Embodiment

FIG. 17 is an exemplary system diagram for implementing a streamlined process for AI-assisted script generation related to a user request and corresponding unit testing, in accordance with some embodiments of the present invention. Specifically, FIG. 17 provides an exemplary schematic representation of the modules and data for AI-assisted script generation and unit testing 1720 that may be used for carrying out AI-assisted testing of software functionalities related to a user request by generating a function script 1752 using a scripting AI module 1750, generating a test script 1756, possibly using using a substitution AI module 1754 that fills in test script parameters. In some embodiments, the scripting AI model 1750 directly generates test script 1756 with all test script parameters included.

The system may include access to at least one hardware processor 1794 responsible for executing program code 1792 to implement the modules described below. The system may include access to at least one non-transitory physical storage medium 1790, which stores program code 1792 that is accessible and executable by hardware processor 1794. In some embodiments, program code 1792 may be stored and distributed among two or more non-transitory physical storage media, and may be executed by two or more processors.

The system may include an IDMP application 1780 controlling a training module 1740 that may carry out training, fine-tuning, and/or validation of one or more AI modules. In one embodiment, the AI modules include scripting AI module 1750, substitution AI module 1754, and a documentation AI module 1758. In some embodiments, scripting AI module 1750 and substitution AI module 1754 may comprise a script-updating machine learning model. In some embodiments, the modules for AI-assisted unit testing may comprise a splice-generation and/or a splice-updating AI module.

In order to train and/or fine-tune the AI models 1750, 1754, and 1758, the training module 1740 may use training and tuning data 1742 which may include prior user action or sample user action data, valid or user-verified function scripts, sample test scenarios, sample test scripts, generated/updated scripts including template scripts, test script parameters, APIs, documentation, resource-capability mapping, and other relevant training data. In some embodiments, training and tuning data 1742 may be used by the IDMP application 1780 as retrieved context data added to the context windows of AI modules 1750, 1754, or 1758 as part of a Retrieval-Augmented Generation (RAG)-based approach. In other embodiments, the training and tuning data 1742 may be used by the IDMP application 1780 to fine-tune AI modules 1750, 1754, and 1758 as part of a Low-Rank Adaptation (LoRA) approach.

At run time, a user 1702 may carry out actions on a user interface 1704, generating user action data 1730 which is collected by the IDMP application 1780 and added to training and tuning data 1742. In one embodiment, user 1702 is a human interacting with the IDMP through a conventional user interface 1704 (e.g., a computer). In another embodiment, user 1702 is a software agent (e.g., a software module running in a client environment). In some embodiments, user 1702 is a software agent that includes an AI model, or an AI agent. AI modules 1750, 1754, and 1758 may each or collectively be implemented as an AI agent as well.

In different embodiments, user action data 1730 may be indicative of a user selection of a target digital tool, and a user request or user intent comprising a description of the desired function script, and/or a desired outcome when a generated function script is executed. Based on the user action data or user input, function script 1752 is generated. In some embodiments, scripting AI module 1750 is an AI-based recommender/generator engine 1236 trained on an IDMP resource-capability mapping that includes existing function scripts associated with existing model splices for the same digital model types, analogous digital model types, and/or analogous digital models. This recommender/generator engine may have been further fine-tuned based on user preferences, client information, or prior user action data. In some embodiments, scripting AI module 1750 may utilize a large language model (LLM) to write function scripts that call upon APIs of the target digital tool. In some embodiments, scripting AI module 1750 may retrieve a list of function scripts from a database, based on the user request, which may also indicate the intended digital model type that function script 1752 operates on, and/or intended purposes/use/audience of the function script. In some embodiments, scripting AI module 1750 may autonomously match model type with existing function scripts or splice functions to recommend a list of potential function scripts for the user to select from. In the present disclosure, analogous digital models or digital model types refer to digital models that are similar in some aspects, such as structure or behavior, but are not identical. Analogous digital models may be identified by analyzing the characteristics of different digital models and determining shared common features, attributes, or components that are relevant for model splicing. Analogous digital models may be used as reference, baseline, or starting point for function script generation, leveraging the similarities to improve efficiency and to capitalize on validated and user-verified function scripts. Analogous models are particularly useful when they follow the same standard guidelines or reuse the same components or modules. For example, different variants of an aircraft may share a common propeller design but have different avionics. Function scripts generated for one variant of the aircraft may be used as training data for scripting AI module 1750, to generate function scripts for other variants of the aircraft.

In some embodiments, based on the user request, scripting AI module 1750 directly generates a test script 1756 that tests the function script 1752 against its description as given by the user.

In some embodiments, a human-readable test scenario is first generated, comprising a sequence of human-readable testing steps and an expected outcome that are related to the user request/user intent or function description. This sequence of human-readable testing steps and the expected outcome are then converted into test script 1756 by scripting AI module 1750.

In some embodiments, scripting AI module 1750 generates a template test script based on the test scenario, where the template test script includes a variable which is a placeholder for a parameter related to the test scenario. Substitution AI module 1754 may then generate a test script 1756 by substituting the variable with a value for the parameter using a parameter substitution process. In the embodiment of FIG. 17, two exemplary placeholder function names are replaced in test script 1756 by two function IDs, “Function_ID_1” and “Function_ID_2”. In the context of parameter substitution, the term “parameter” encompasses numeric parameters such as arrays, matrices, and tensors of numeric values corresponding to real-world attributes (e.g., budget parameters, physical design parameters, etc.). The term “parameter” also extends to function names and API attributes (e.g., number and format of inputs/outputs in a function) that may be specific to a customer or a customer software tool.

To generate function script 1752 and test script 1756, the scripting AI module 1750 may require access to digital model data. In the embodiment of FIG. 17, the IDMP application 1780 may provide access to two models, a digital model A 1710 and a digital model D 1712, respectively. For example, digital model A 1710 may be a CAD model, while digital model D 1712 may be a document model. In one instance, model artifacts and associated digital tool functions may be accessed by function script 1752. In another instance, model artifact(s) from digital model A 1710 and associated tool function(s) may be accessed by function script 1752, while test script 1756 may further access artifact(s) from digital model D 1712 and associated tool function(s), for example in a continuous compliance use case as discussed in the context of FIGS. 23 and 24.

Test script 1756 may be interpreted on an interpreter operatively connected to IDMP application 1780. Interpreting the test script checks the function script against the description of the function script to verify that the function script performs as expected. Several exemplary function scripts and corresponding test scripts are discussed in the context of FIGS. 20 to 22, discussed next. While unit-testing for continuous compliance examples are discussed in the context of FIGS. 23 and 25. Subsequently, a test report can be generated based on the test outcome, and this test report may be stored in training and tuning data 1742. Additionally, documentation module 1758 may generate product-level or end-user documentations on the function script, test script, or test report.

In FIG. 17, a tested and verified function script such as 1752 may be included as a splice function in a model A splice 1760, which comprises splice data 1762 and splice functions 1764 accessible through splicing APIs 1766. More generally, a tested and verified function script 1752 may be included in a digital thread 1770 as part of a digital workflow implemented via an orchestration script 1774.

As illustrative examples of the process steps discussed in the context of FIGS. 15, 16 and 17, FIG. 18 shows illustrative user interface schematics 1800 for collecting user input and displaying script output, in accordance with some embodiments of the present invention. In a first embodiment 1810, an input window is provided for a user to describe the desired function script as well as specifying a digital tool to be utilized. A second embodiment 1820 further includes an input window for the user to suggest a digital tool library to use. A corresponding output window is provided for displaying the generated function script. These simplified examples illustrate the core panels of a user interface for function script generation. In other embodiments, such a user interface may be much more extensive, for example with the integration of an editor or a full-suite integrated development environment (IDE) for the user to access or modify a generated function script, or orchestration script.

FIG. 19 shows another illustrative user interface for user input during function script generation, in accordance with some embodiments of the present invention. In this example, the user requests for a digital tool EXCEL via an input window 1910, triggering the IDMP to create a project framework or dataflow architecture 1930 that includes placeholders for function input/output schemas, variables, test scripts, and documentation in a hierarchical structure. Further in FIG. 19, a notification window 1920 shows the user that the data flow architecture has been created successfully.

FIG. 20 shows an illustrative function script output 2030 generated according to a user-specified function script description and a user selection of a digital tool library, in accordance with some embodiments of the present invention. In this particular example, the user requests for an EXCEL function script to “export a sheet using its name as CSV” via an input window 2010, to be implemented with the OPENPYXL library. The exemplary AI-generated Python function script “exportSheetAsCSV” 2030 calls upon a load_workbooko function from the openpyxl library. A notification window 2020 shows the user that the function script has been created. Other scripting languages such as JavaScript and Pearl may also be possible, depending on the configuration of or input prompts to the AI-assistance module for function script generation.

Correspondingly, FIG. 21 shows an illustrative testing script output 2140, according to some embodiments of the present invention. This testing script 2140 calls the function script 2030 to test, and checks that the function script creates the CSV file with the correct data, then deletes the test file after test completion.

FIG. 22 shows another illustrative example of a user input window 2210 and correspondingly generated function script 2230 and testing script 2240, according to some embodiments of the present invention. In this particular example, the user requests for an EXCEL function script to “sort a table of entries alphabetically”, again to be implemented with the OPENPYXL library.

### Unit Testing for Continuous Compliance

Extending beyond the generation and unit testing of an isolated function script with AI-assistance, within the IDMP, this AI-assisted workflow integration process is applicable to any software-defined digital threads that connect individual units of code (e.g., function scripts) that realize individual tasks. A digital thread executes sequences of interconnected tasks in a zero-trust, zero-knowledge manner. Embodiments of the present invention enable the incorporation of unit tests or feature tests to ensure individual testing compliance is met at each step of the digital thread, thus providing end-to-end workflow validation as a complex software-defined digital thread such as 1142 shown in FIG. 11 is continuously updated. This approach allows for dynamic changes in code, workflow parameters, individual steps, and digital artifacts, facilitating continuous monitoring and rapid iteration while also ensuring compliance across an entire digital thread.

A specific use case of the aforementioned AI-assisted workflow integration process is in implementing continuous compliance (CC) across a digital thread. CC is an automated system that ensures digital threads and workflows adhere to verification and validation (V&V) requirements throughout their lifecycle. Within the IDMP, users may extract model artifacts and operational data to create digital threads that compute compliance continuously in real-time. This provides traceability, prevents errors from propagating downstream, and enables fast resolution by users. When a digital thread is visualized as an interconnected network of task nodes (e.g., see FIGS. 6 and 10), AI agents as discussed herein assist in generating function scripts for individual task nodes, based on user requests, customer-specific artifacts and associated APIs. Each generated function script, when executed, may derive a digital artifact, and a generated unit testing script, when executed, may check the digital artifact against a compliance requirement. That is, a successful unit test of a generated function script validates the digital artifact derived via the function script. Subsequently, the unit testing result of a generated function script is cascaded throughout ensuing steps to infer its impact on the overall outcome of the digital thread to ensure continuous compliance. AI-assisted unit testing at individual task nodes therefore dynamically evaluates computability and requirements satisfaction, and documents these evaluations at every update that occurs within the overall digital thread.

Thus, automated, unit-test-driven CC functions throughout the lifecycle of the digital thread, dynamically adjusting to changes in workflow parameters, individual steps, or artifacts. In a manner similar to software Continuous Integration and Continuous Deployment (CI/CD) processes, CC ensures that any changes to a digital thread are automatically checked against compliance metrics, covering the entire system. This facilitates rapid iteration and minimizes the risk of non-compliance during updates. In some embodiments, CC functions as “compliance as code,” applicable to regulatory or hardware specification compliance.

FIG. 23 is an exemplary screenshot 2300 illustrating inter-dependent validation tasks across a digital thread needed for end-to-end workflow validation, in accordance with some embodiments of the present invention. In this example, an aircraft build is checked against a set of regulation requirements in an airworthiness certification process, facilitated by the IDMP via unit-test-driven CC. Specifically, a pipeline #108 is shown, comprising a digital thread or hierarchy 2320 of individual validation jobs that check against individual element, criterion, subsection and section of a regulation requirements document. An indicator 2340 shows that the pipeline has passed validation.

Correspondingly, FIG. 24 is a screenshot of an exemplary execution log for a validation job #5640 “validate_element_5_1_1_element_1_load_factors” within pipeline #108 shown in FIG. 23. Different flight maneuvers with various load factors (e.g., “Steady Pitching with load factor 7.5 g,” “Rudder kick with load factor 3.0 g,” etc.) can be viewed as different test scenarios implemented by a test_element_load_factors.py testing script that checks against Section 5, Subsection 5.1, Criterion 5.1.1 within an airworthiness standard.

FIG. 25 is a screenshot 2500 of an exemplary validation report for jobs shown in FIG. 23, in accordance with some embodiments of the present invention. Digital thread 2320 shown in FIG. 23 comprises data artifacts, function scripts, and unit-tests. When a data artifact fails to meet format or metadata requirements, related unit-tests fail, and the IDMP runbook may propagate the error, highlighting the non-compliant update. In FIG. 25, pipeline #106 and #105 are reported to have failed, and the user is alerted to check the update that has caused non-compliance, including pointing to specific steps that failed compliance. Embodiments of the present invention that utilize automation and AI assistance as disclosed herein are able to pinpoint the specific artifact or update that triggered the failure, thus providing continuous monitoring and real-time insights, ensuring compliance throughout the digital thread.

Next, an exemplary implementation for AI-assisted model splicer generation and digital model function script generation are described in reference to FIGS. 26 to 29, in the context of incorporating a new digital tool into the IDMP. An exemplary implementation for AI-assisted testing and documentation are provided in the context of FIGS. 30 to 36.

### Exemplary Implementation for AI-Assisted Digital Model Splicer and Function Script Generation

FIG. 26 is a schematic 2600 showing an exemplary implementation of AI-assisted model splicer generation or update, in accordance with some embodiments of the present invention. Model splicing is discussed in the context of FIGS. 7 and 8, and includes processes for splicer function or function script generation. In what follows, any reference to model splicer generation is directly applicable to function script generation as discussed in the context of FIG. 15 to 17.

In this illustrative embodiment, AI-assisted model splicer generation or update comprises three main stages: customer commercial assessment 2610, scope and design definition 2620, and model splicer development 2630. Note that the scripting AI module 1750 as referenced in the context of FIG. 17 may encompass any of the AI assistance modules 2612, 2622, 2632, and 2642 shown in FIG. 26.

During customer commercial assessment stage 2610, a digital tool may be evaluated at a step 2614 for its business value upon a potential customers' request for integration into the IDMP. In some cases, the customer's End User License Agreements (EULA) for the target digital tool may be assessed at a step 2616 using an AI-assistance sub-module 2612 to determine any potential constraints or prohibitions on user authorization and digital tool access, with assessment reports recorded for auditability. For example, AI-assistance sub-module 2612 may be a transformer-based LLM model setup for document summarization or query, and fine-tuned on legal vocabulary. In some embodiments, the EULA assessment 2616 is replaced by a legal and security review. The use of AI-assistance is especially valuable when a tool has already been integrated into the IDMP and updates (e.g., new software release) are pushed onto the IDMP.

During model splicer scope and design definition stage 2620, model or tool documentation availability may first be checked at a step 2624, and a model splicer generation process may be triggered at a step 2627 if documentations are available, to initiate an AI-assisted model splicer input/output schema generation process by a module 2710. Exemplary documentations may include, but are not limited to, product documents for the digital tool, API libraries, and IDMP resource-capability mappings.

In some embodiments, an additional condition for triggering the model splicer generation process is an external input 2629. This external input may be from a human user, or may be received from another part of the IDMP. For example, a request for a model splicer may be received from the IDMP when the model splicer is needed for building a digital thread, or is suggested for completing some specific digital tasks. In other examples, the external input may be to build a model splicer for a new digital tool, or to update the model splicer for a digital tool which may have been updated to a newer version.

In one illustrative example, external input 2629 may be a prompt “I want to do a CFD analysis” from a human user, representing a user intent to perform a specific task. A digital model type may be handled by multiple digital tools. For example, ANSYS, ABAQUS, and NASTRAN are digital tools for CFD (computational fluid dynamics) models. Customer commercial assessment may have already been conducted for one or more of such digital tools beforehand, for example, for purposes other than model splicer generation, and the IDMP may converse with the user to determine if a model splicer is to be created for the one or more assessed digital tools.

In addition to AI-assisted module 2710, when all the conditions are met for model splicer generation, another AI-assistance sub-module 2622 may be triggered to review model type and/or tool-specific documentations at a step 2626. For example, AI-assistance sub-module 2622 may crawl through marketing materials for a digital tool to understand the digital tool's capabilities or what functions it can perform.

Furthermore, AI-assistance sub-module 2622 may optionally be used to assist in defining model splicers at a step 2628 for a given model type associated with the digital tool, based on input/output schemas provided by module 2710, and optionally based on any model splicer design mockup generated by a module 2720. A definition for a model splicer defines or describes capabilities of the model splicer. An exemplary definition for a model splicer is the API script specification 732 shown in FIG. 7.

During model splicer development stage 2630, the model splicer definition from stage 2620 may be converted at a step 2633 via AI-assistance sub-module 2632 into nodes with input/output parameters in the appropriate schemas. In some embodiments, this step may be combined with the previous model splicer definition step 2628, as together they provide a specification for the model splicer.

Next, a IDMP standardized schema 2639 may be used to define data that can be interchanged between digital tool scripts and the IDMP at a step 2635. An exemplary input to this process are input/output parameters and nodes that will be the API endpoints; an exemplary output of this process are input/output parameters with additional metadata aligned to the IDMP's standard schema. This may be viewed as schema alignment to IDMP standards, again simplifying the myriad formats from many different digital model types into a set of consistent data types available on the IDMP to easily edit, understand, and link models of various types.

An AI-assistance sub-module 2634 is then used to generate, at a step 2637, digital tool-specific splicer scripts that can be integrated seamlessly into the IDMP, can be selected to construct a model splice or to orchestrate interactions among multiple model splices, and to support customer specific use-cases 2640 accessible on the IDMP.

In exemplary implementations, a Zero-Knowledge implementation of AI-assisted model splicer generation (as shown in exemplary AI-assistance steps in FIG. 26 and in FIG. 27) tokenizes customer data when confirming input/output, design mockups and the functions for the specific DE tool. Tokenization is the process of exchanging sensitive data for a cryptographic identifier of that sensitive data. It is possible to use every function of the IDMP through the API alone, manually tokenizing data before submitting API requests.

A Zero-Knowledge architecture for the IDMP requires the API not to accept sensitive data. The platform's Software Development Kit (SDK) enforces this zero-knowledge constraint by tokenizing sensitive data before it is sent to the API. A zero-knowledge implementation of AI-assisted model splicing then must tokenize data in each of the three functions they rely on in the platform's standard schema or API to confirm I/O, design mockups, and the function name within the digital tool. Metadata that are part of the tokens are used to train AI models, while the sensitive data is encrypted into tokens and not used for training. The AI models predict representative input/output schema, design mockups and the function names. Additional AI models deployed as agents within the customer environment can match exact input/output schema, design mockups or function names of specific digital tools. Tokenization is the process of exchanging sensitive data for a cryptographic identifier of that sensitive data. De-tokenization is the process of exchanging that token for a copy of the sensitive data. The Zero-knowledge system as disclosed herein stores tokenized sensitive data on a customer's network rather than on the same network the systems run on.

In other implementations, the AI models may predict generic parameter names and generic function names in order to be consistent with a zero-knowledge approach.

### AI-Assisted Model Splicer Schema Generation and Mockup Creation

FIG. 27 is a schematic 2700 showing an exemplary AI-assisted model input/output schema generation module 2710 in an IDMP, and a corresponding AI-assisted model splicer design mockup generation module 2720, in accordance with some embodiments of the present invention. Again, “IDMP” refers to the universal, scalable, and adaptable interconnected digital model development platform that implements the modules and submodules as disclosed herein, including the ones shown in FIG. 27. Also note that the scripting AI module as referenced in the context of FIG. 16 may encompass any of the AI assistance modules 2712 and 2714 shown in FIG. 27.

In AI-assisted model input/output schema generation module 2710, generative AI algorithms as disclosed herein perform transductive learning to create input and output schemas for a new digital tool, or a new digital tool-digital model-type combination, based on existing schemas on the IDMP. Recall from the discussion with reference to FIG. 7, that how model data may be organized in a data structure and accessed through APIs is fundamentally defined by the digital tool that created the model and is being used in splicing the model, in manipulating the model splice, or in creating splicer scripts/function scripts. A model data schema describes the organization and formatting of model data, the input/output schemas as generated by module 2710 describe the organization and formatting of input and output endpoints to model splices, while scripts generated with an AI-assistance submodule such as 2634 shown in FIG. 26, process data according to respective schemas (e.g., processing a variable according to its type and unit), to provide model access, manipulation, and linking capabilities.

More specifically, in FIG. 27, one or more of the following process steps may be carried out:
1. Input prompt: A digital model type and/or a digital tool to be used with the model type is provided at a step 2714, to prompt the creation of input/output schemas for one or more use cases at a step 2716, by a first AI assistance sub-module 2712 in module 2710 within the IDMP.
   In some embodiments, a human or a machine user may provide the input by selecting a model type/tool pair from a predefined list, such as stored in a library 2715 of digital models and tools.
   Multiple digital tools may be available for use with any given model type, with some tools proprietary and some tools open-source. For example, CAD models may work with AutoCAD, SolidWorks, CATIA, OpenFOAM, and other similar tools; Finite Element Analysis (FEA) models may work with ANSYS, Abaqus, NASTRAN, and other similar tools; a circuit model may work with SPICE, LTspice, Multisim and the like.
   In some embodiments, a user may provide an existing model splicer or model splice as the input, and the module 2710 may extract existing API endpoints as exemplary use case inputs to AI-assistance sub-module 2712.
2. Input/output schema generation: AI-assistance sub-module 2712 creates an example of input/output schemas at step 2716 for an output use case relevant to the input model type and tool, based on the input model type and/or tool, and exemplary input use cases. Input or output schemas provide templates for API endpoints within a model splice, which in some embodiments are shown as functions in a GUI. For example for modeling and simulation use cases, an input schema lists potential input data options for various modeling or simulation parameters. An output schema lists potential output data options following a modeling or simulation task.
   AI-assistance sub-module 2712 may implement any appropriate non-generative or generative AI algorithms. For example, it may be a pre-trained foundation LLM model such as GPT-4. In one example, it may be further trained on IDMP resource-capability mappings. In another example, it may have been fine-tuned on data collected from model splicing processes described with reference to FIG. 7.
   The output use case may be customized based on additional initial user input or user feedback to AI-assistant sub-module 2712.
   The resulting input/out schemas may be further fine-tuned based on user feedback to AI-assistant sub-module 2712. For example, an LLM such as GPT4 may be run in open-loop fashion initially, then external human expert feedback may be used to refine the generated input/output schemas 2730.
   In some embodiments, the input/output schemas 2730 generated in this step are provided directly as the output of module 2710.

Below is an example for AI-assisted generation of input/output schemas for the tool OpenFOAM. Specifically, the following prompt may be provided to LLM-based AI-assistance sub-module 2712 to create an example of the input/output schema for an example use case:

### Exemplary Input Prompt:

“You are an expert in digital engineering. I am going to give you a digital engineering tool name, and you are going to give me an input and output schema for that tool, along with an example of how it could be used.

#### EXAMPLE ####
TOOL: Tool XYZ
FILE EXTENSION: .dxf
INPUTS:
{
″inputs″: [
{
″id″: 1,
″type″: ″Checkbox″,
″name″: ″Hide parts″
},
{
″id″: 2,
″type″: ″Radio Buttons″,
″name″: ″Resolution″,
″unit″: ″polygon count″
},
{
″id″: 3,
″type″: ″Number″,
″name″: ″Modify parameter″,
″unit″: ″mm″
}
]
}
OUTPUTS:
{
″outputs″: [
{
″id″: 1,
″type″: ″Image″,
″name″: ″2D Image″
},
{
″id″: 2,
″type″: ″File″,
″name″: ″3D viewer″
},
{
″id″: 3,
″type″: ″JSON″,
″name″: ″Complete set of parameters″
},
{
″id″: 4,
″type″: ″Array″,
″name″: ″List of parts″
},
{
″id″: 5,
″type″: ″Number″,
″name″: ″Parameter Value″,
″unit″: ″mm″
},
{
″id″: 6,
″type″: ″File″,
″name″: ″Download Native File″
}
]
}
#####
TOOL: OpenFOAM”

Note that only the DE tool name “OpenFOAM” is provided as an input prompt. In this setup, AI-assistance sub-module 2712 may provide input/output schemas that are associated with multiple digital model types or file extensions that work with the tool OpenFOAM. The user may prompt with specific model type and tool pair names as well.

An exemplary output provided by AI-assistance sub-module 2712 is as follows:

“FILE EXTENSION: .foam, .dict
INPUTS:
{
″inputs″: [
{
″id″: 1,
″type″: ″File″,
″name″: ″Mesh file″,
″file_extension″: ″.msh, .stl″
},
{
″id″: 2,
″type″: ″Dropdown″,
″name″: ″Simulation type″,
″options″: [″Steady-state″, ″Transient″]
},
{
″id″: 3,
″type″: ″Dropdown″,
″name″: ″Flow solver″,
″options″: [″Incompressible″, ″Compressible″, ″Multiphase″]
},
{
″id″: 4,
″type″: ″Dropdown″,
″name″: ″Turbulence model″,
″options″: [″Laminar″, ″RANS″, ″LES″, ″DNS″]
},
{
″id″: 5,
″type″: ″Number″,
″name″: ″Boundary conditions″,
″unit″: ″varies″
},
{
″id″: 6,
″type″: ″Number″,
″name″: ″Simulation time″,
″unit″: ″seconds″
},
{
″id″: 7,
″type″: ″Number″,
″name″: ″Time step″,
″unit″: ″seconds″
},
{
″id″: 8,
″type″: ″Checkbox″,
″name″: ″Parallel processing″
}
]
}
OUTPUTS:
{
″outputs″: [
{
″id″: 1,
″type″: ″File″,
″name″: ″Simulation results″,
″file_extension″: ″foam, .vtk, .csv″
},
{
″id″: 2,
″type″: ″Image″,
″name″: ″Contour plot″
},
{
″id″: 3,
″type″: ″Image″,
″name″: ″Vector plot″
},
{
″id″: 4,
″type″: ″JSON″,
″name″: ″Simulation parameters″
},
{
″id″: 5,
″type″: ″Array″,
″name″: ″Time history data″
},
{
″id″: 6,
″type″: ″File″,
″name″: ″Simulation log″,
″file_extension″: ″.log″
}
]
}

### Example Use Case

An aerospace engineer is tasked with analyzing the airflow around a new aircraft design to determine its aerodynamic performance. The engineer imports the aircraft geometry as an STL file into OpenFOAM and sets the simulation type as “Steady-state.” They choose the “Incompressible” flow solver and select an appropriate turbulence model based on the expected Reynolds number. The engineer specifies boundary conditions for the simulation, sets the desired simulation time, and sets the time step for the solver. To speed up the simulation, they enable parallel processing. After running the simulation, the engineer can analyze the simulation results, including contour and vector plots, time history data, and the simulation log to understand the aircraft's aerodynamic characteristics and identify any areas for improvement.”
3. Schema Alignment: the generated input/output schema 2730 may be aligned, or fitted to a standardized or standard set of input/output schema or “input/output building blocks”.
   A standardized schema refers to a standard set of types of variables. For example, web app input and output types or building blocks in standard HTML. An non-exhaustive list of web app input and output types is provided at the end of this subsection.
   Schema alignment is the process of simplifying the myriad formats from many different DE model types into a set of consistent data types such that it is easy to edit, understand, and link to other models.
   For example, for an input schema related to a GUI, corresponding standard types may be “text box”, “radio button” etc. For an output schema related to image outputs, corresponding standard types may be “URL” to an image.
   Alignment refers to having one of more variable types within the input or output schema that are part of a small set of standard types.
   In some embodiments, schema alignment 2718 is performed via an AI-assistance sub-module 2714, using standardized schemas 2719 retrieved from an internal database. In some embodiments, the AI-assistance sub-module 2714 is implemented as a ML classifier with feedback, or a generator with a transformer model.
   In various embodiments, both AI-assistance sub-modules 2712 and 2714 may be trained on data the IDMP has collected over a variety of digital tools, model type files, and of the standardized schema, which may be used to set the system context for an LLM like GPT 4.
   In some embodiments, the aligned input/output schemas generated in this step are provided as the output 2730 of module 2710.

For further illustration, below is an non-exhaustive list of standard web app input and output types:

Exemplary simple input types include, but are not limited to: text, number, dropdown (select), checkbox, radio button, textarea, file upload, date input, time input, range input (slide), color input, email input, password input, URL input, and Search input.

Exemplary advanced input types include, but are not limited to: autocomplete (typeahead), tag input, rich text editor, data range picker, time range picker, geolocation input, file dropzone, multiple file upload, star rating input, and slider with multiple handles.

Exemplary simple output types include, but are not limited to: plain text, numeric value, date (in predefined format), time, image, link (anchor), list, table, button, and tooltip.

Exemplary advanced output types include, but are not limited to: interactive chart or graph, data grid (advanced table), accordion, carousel (slide), modal (dialog), progress bar, tabs, map, timeline, and treeview.
4. Design mockup: while the generated input/output schemas 2730 may be sent to a model splicer design definition module 2628 discussed with reference to FIG. 26, the generated input/output schemas may also be used to generate a visual model splicer mockup. In the embodiment of the AI-assisted model splicer design mockup generation module 2720 shown in FIG. 27, the input/output schemas may first be uploaded at a step 2723 into a design mockup tool such as FIGMA to form the basis of a visual mockup without examples, and each variable in the generated input and output schemas may be iterated or looped through steps 2724, 2725, 2726, and 2727 to update the base design mockup. That is, the IDMP may iteratively search for example text or images/graphics to update the base design mockup, without or without user input, and optionally via an AI-assistance module 2722.
   Each search may be performed using a traditional or chatbot-based search engine
   For example, a traditional web search engine may be used to search for images related to the input digital tool or target digital tool and the variable under consideration. For instance, the phrase “OpenFOAM vector plot” may be used as a search key to look for vector plots (see FIG. 18). One or more example images found may be added to the design mockup based on the use case.
   Similarly, ChatGPT may be prompted to find text examples, to be copied into the designed mockup.
   Once all variables in the input and output schema have corresponding image and/or text examples, the mockup may be reviewed, updated based on user feedback, and finalized in the design mockup tool at a step 2728 into a full design mockup 2740.

### AI-Assisted Function Script Generation

FIG. 28 shows an exemplary open-source LLM implementation 2800 of AI-assisted function script generation in a model splicer generation engine, in accordance with some embodiments of the present invention. Specifically, this illustrative embodiment may be an implementation of AI-assistance submodule 2634 using LlamaAcademy, an open-source LLM that combines crawling, data generation using GPT3.5 and GPT4, and fine-tuning Vicuna-13B on synthetic data, to fine-tune on API documentation and generate API scripts using META's Large Language Model Meta AI (LLaMa), MICROSOFT's Low-Rank Adaptation of LLMs (LoRA), and the open-source LangChain.

In the illustrative implementation shown in FIG. 28, the system utilizes LLMs to generate model splicers for a generalized variety of model types and tools, effectively bridging the gap between various digital tools. For a desired digital tool, its respective API documentation webpages may be collated using advanced techniques such as autoGPT. The system then may scrape all text and API calls from these documentation webpages and related forums using web scraping tools such as Elinks and Selenium. The extracted text is converted into embeddings using a tokenizer and an embeddings API or similar technology. These API texts and their corresponding embedding vectors are stored in a vector database, which is further enhanced by summarizing each API text using a fast Language Model (e.g., GPT-3.5) and adding these summaries additionally in the database.

To facilitate seamless interaction with developers or users, the system may convert user questions about API usage into embeddings and identifies the closest embeddings in the vector database using techniques such as cosine similarity. The API summary and text of the closest embeddings may then be converted back into regular text, which serves as input for an advanced LLM (e.g., GPT-4) to construct a script for a wrapper. The generated script may be tested on the actual software (e.g., OpenFOAM) for compilation, and if unsuccessful, the advanced LLM is requested to fix the script until it compiles successfully. The successfully compiled code and the original request are added to the vector database, and the process iterates (e.g., for approximately 10,000 requests) to generate a diverse sample of API usage. This iterative approach may be repeated for each tool of interest, ultimately creating a comprehensive knowledge base for various digital tools. Optionally, additional human or alternative checkers may be employed to ensure code functionality, and fine-tuned LLMs may be developed for each specific tool, enhancing the system's overall performance.

Individual steps listed in FIG. 28 are as follows:
Step 1: List desired digital tools
Step 2: Locate API documentation webpages for these tools (e.g., using autoGPT)
Step 3: Scrape text and API calls from the API documentation webpages and forums (using web scraping tools such as Elinks and Selenium)
Step 4: Convert the scraped text into embeddings (using tokenizer and embeddings API or similar)
Step 5: Store the API text and corresponding embeddings vectors in a vector database
Step 6: Summarize each API text using a fast Language Model (e.g., GPT-3.5)
Step 7:Add the summaries as another column in the vector database (API Text: Text Embeddings, API Summary)
Step 8: Vectorize the Language Model summarizations using tokenizer and embeddings API
Step 9: Add the summary embeddings as another column in the vector database (API Text: Text Embeddings, API Summary: Summary Embeddings)
Step 10: When a developer/user/LLM asks a question about how to use the API, convert the question into an embedding
Step 11: Find the closest embeddings in the vector database (e.g., cosine similarity)
Step 12: Convert the API summary and API text of the closest embeddings back into regular text
Step 13: Use the retrieved data as input and ask an advanced LLM (e.g., GPT-4) to construct a script for a model splicer or wrapper
Step 14: Test the generated script on the actual software (e.g., OpenFOAM) to see if it compiles
Step 15: If the script doesn't compile, request the advanced LLM to fix it
Step 16: Repeat steps 14-15 until the script compiles successfully
Step 17: Add the successfully compiled code and the original request to the vector database
Step 18: Ask an LLM to make a slight modification to the original request
Step 19: Restart at step 10 and iterate for ~10,000 requests to get a diverse sample of API usage
Step 20: Once 10,000 requests have been completed, move on to the next tool in step 1.

In some embodiments, an additional human or alternative checker can ensure the code not only compiles but also implements the desired functionality according to the original request. In alternative embodiments, instead of solely using embeddings in a vector database, information from steps 10 and 17 may be used to fine-tune smaller, custom LLMs for each tool, creating a fine-tuned LLM for each specific tool.

In various embodiments, the aforementioned steps may be implemented by different components shown in FIG. 3. For example, steps 1-2 may refer to both agents in the exclave 316 (e.g., DE platform agent, DE tool agent), as well the DE platform API in the IDEP Enclave 302. Model splicer generation may be performed on the enclave (e.g., creating splice functions linked with universal IDEP API), and in other examples, in the exclave (e.g., where the tool API vector store is additionally located in customer data buckets). The various LLM examples shown within the splicer generation engine in FIG. 28 may be implemented as one or more language agents that are created with open-source models and deployed in the exclave. While public models such as GPT4 and OpenAI models work for the intended purposes, local instances (e.g. Mistral, Llama3) may be used instead to maintain data security.

FIG. 29 shows an exemplary process for model splicer generation via Large Language Models (LLMs) directly, with prompt-response fine-tuning, in accordance with some embodiments of the present invention.

AI-Assisted Script Generation Via LLM Models with Fine-Tuning

While FIGS. 26 and 267 provide generalized end-to-end process flow for model splicer creation, from customer request to generated model splicers on the IDMP, FIG. 29 shows an exemplary process for model splicer generation via Large Language Models (LLMs) directly, with prompt-response fine-tuning, in accordance with some embodiments of the present invention.

In particular, the process in FIG. 29 may be applied to exemplary implementations of the model splicer development stage 2630 discussed in FIG. 26, specifically of the implementation of AI-assistance sub-module 2634 shown in FIG. 26 for API function wrapping and script generation.

More specifically, process 2900 illustrated in FIG. 29 comprises four stages: a preliminary AI model selection and training stage 2920, an user input stage 2940, an AI-assisted API model splicer generation stage 2960, and an LLM fine-tuning stage 2980.

During the preliminary AI model selection and training stage 2920, a LLM or a generative pre-trained (GPT) transformer (e.g., GPT-3 da vinci) may first be selected at a step 2922. Pre-training of such AI models is usually performed on large swarms of publicly available data, but not tailored specifically for function script generation. Various embodiments of the present invention thus train or fine-tune the selected AI model. Training data are collected and formatted at a step 2923, and stored in a training data database, for training a selected new transformer or for fine-tuning an existing GPT at a step 2926. In the following description of FIG. 29, an LLM is used as an illustrative but non-limiting example of an AI model for script generation.

Exemplary training data may include, but are not limited to, IDMP resource-capability mappings, IDMP documentations, digital model function data such as modeling and simulation metadata, code to interact with a digital model, tool APIs or function calls. Note as the LLM is prompted to generate scripts, prompt-and-response pairs may be collected and aggregated from valid and user-verified tool function calls and API function scripts recorded during past model manipulation or model splicing processes. For example, consider a CAD model for an object (e.g, a shape) in SolidWorks, CATIA, or OpenCASCADE. A user or SME may have attempted to create the object, which has tessellations or facets defined by triangles, using API function scripts. That is, the user referenced specific API elements of a tool in particular sequences or orders to create the desired object. Such user actions may have been captured previously and stored in the training data database, as an object and corresponding tool and code that generated it. Alternatively, the digital tool may have functionalities to export the object to code.

In some embodiments, training data augmentation 2924 may be used to artificially increase the training dataset by creating synthetic data from existing, verified data, and to reduce model overfitting. For example, synthetic data such as variations of previously valid data elements may be created and formatted to reflect real-world, user-generated data. For function script generation, an abstract syntax tree may be used to inform what elements of the API may be varied, and a rule-based approach may be used to generate specific variations. Such variations may be checked by leveraging validation and verification capabilities within a compiler. That is, a script variation can be queued at the compiler to check for syntax, and if it compiles, it is considered valid and can be added as synthetic training data; if not, alternate perturbations of the abstract syntax tree may be pursued.

Below is an illustrative example. Assume the following AI model prompt and response are used to generate synthetic variations:

### Prompt:

“Create a cube with equal dimensions of 10 inches”

### Response:

#include <BRepPrimAPI_MakeBox.hxx>
#include <TopoDS_Shape.hxx>
int main( )
{
// Create a cube with a length, width, and height of 10 inches
BRepPrimAPI_MakeBox box(10*25.4, 10*25.4, 10*25.4); // convert inch to mm
TopoDS_Shape shape = box.Shape( );
return 0;
}

An exemplary synthetic data creation process comprises the following steps:
1. Take the above response and perform basic Abstract Syntax Tree (AST) decomposition
2. Assess the function call and its parameters as the primary API element for variation
3. Vary the parameters within the bounds of rules and constraints
4. From the AST, recompose a function similar to the original in structure but altered to effect the model differently
5. Validate the new function by analyzing the output of compilation
6. Verify and persist new function call in training data

After initial AI model training/fine-tuning 2926, a customer or user may provide or select a digital model or tool from a group of acceptable target softwares, in an user input stage 2940. As the AI model from the previous stage has been trained on similar digital models or tools, it understands what pieces of the input digital model or tool is codifiable.

Next, AI-assisted model splicer generation 2960 begins, where input/output schemas are created, and elements of the digital model (e.g., of a 3D entity) are identified to generate API scripts. Based on user demand, the AI model (e.g., LLM) may also output specific API scripts as part of the model splicer generation process.

As soon as API scripts are generated by the LLM, the user or other SMEs may evaluate, verify, and provide feedback to the LLM, in a LLM fine-tuning stage 2980 shown in FIG. 29. That is, as humans use the AI-assisted system, their input (e.g., selection or rejection of a generated data schema or API script) contributes additional model, tool, and API script data for AI-assistance modules shown in FIGS. 26-28. The system is therefore better informed, and such incremental training data on the particular digital model type and digital tool can contribute to fine-tuning the AI-assisted script generation for the particular script generation task on hand.

An illustrative architecture for fine-tuning the LLM in FIG. 29 is discussed below. Based on the use of platform data, this architecture may be reused on separate fine-tuning datasets to train and create a library of fine-tuned LLMs, each customized to specific AI-assistance use cases (e.g., documentation, model sharing), or targeted to a different DE software or tool.

In various embodiments, during LLM training and/or fine-tuning,
1. Training data may include IDMP resource-capability mappings, scripts and functions for models, as well as model transaction history.
2. Synthetic data creation may follow a rule-based approach for permutations on existing data, using an abstract syntax tree for variants, where a compiler is used to verify success.
3. Prompt-response pairs for fine-tuning the LLM may be increased through permutations following an abstract syntax tree.
4. System architecture may be reused to train and create a library of fine-tuned LLMs, each customized to a specific AI-assistance use case (e.g., documentation, model sharing).

Furthermore, training data examples may include any of the following:
1. API documentation, such as API reference guides, user guides, and tutorials.
2. Technical articles and blog posts, specifically discussing digital engineering APIs.
3. Code snippets and sample projects that demonstrate how to use the API in various programming languages.
4. Online forums (e.g., Stack Overflow) and other Question and Answer (Q&A) threads. a. The training dataset would include stack overflow and other Q&A threads that discuss digital engineering APIs.
5. Publicly available APIs, such as API endpoint descriptions, request/response examples, and other information that can be gathered from publicly available APIs.

In some embodiments, synthetic data generation may rely on:
1. Abstract syntax tree—customized for specific digital engineering applications.
2. Selectively run permutations on training data.
3. Test for compile, then recommend adding to synthetic data.
4. Expert feedback.

Again, this exemplary architecture may be implemented by multiple agents on the IDMP enclave and exclave shown in FIG. 3.

Within the IDMP enclave, the following may be implemented:
Any speech and text engines as agents using an automatic speech recognition (ASR) web service such as OPENAI's Whisper model, or open-source alternatives like NVIDIA's NeMo, or SpeechBrain.
Structured prompting may include a LLM agent to revise the prompting with a context window of syntax tree, or an ML model that is a recommender engine.
IDMP API may be used to customize the LLM. For example, an open source LLM agent can be customized with IDMP API and public documentation as a context window.

Within the IDEP enclave, the following may be implemented:
The LLM may be made enterprise-specific. For example, one or more open-source LLM agents may be customized with context windows such as DE tool-specific context or enterprise documentation-specific context.

### Exemplary Implementation for AT-Assisted Testing and Documentation

### Need for Scalable Approach to Testing

The IDMP houses a wide range of dedicated scripts for a range of digital model splicers and related functionalities intended to augment the reliability and security of the platform. Any testing process for the entire platform is complex and necessary, including individual unit tests of model splicer function scripts as new digital tools and/or digital model types are incorporated into the platform.

Testing is typically done manually by a software engineer who first undertakes a review of the code to understand its objective, whether it be for model splicers, or for front-end user interface (UI) operations, or for any specific functionality that supports the reliability or security of the platform. Following the review of the code and its objective, the manual approach continues towards developing test scenarios and building out test scripts to verify that the code performs to standard, and to the desired outcomes. Such a manual approach is not scalable within a platform that seeks to integrate a large library of DE models and tools.

The example of automation within the IDMP highlights the complexity of the code and the manual effort involved. The example scenario targets the act of logging into the IDMP. Automating the login process involves a software engineer manually reviewing code, developing test scenarios, and building out test scripts to verify code performance. Exemplary code is provided in Table 1 below:

TABLE 1
Test Code Example

/*#### TEST CODE EXAMPLE ####*/
package istari.web.pageFactory;
import org.openqa.selenium.JavascriptExecutor;
import org.openqa.selenium.WebDriver;
import org.openqa.selenium.WebElement;
import org.openqa.selenium.support.FindBy;
import org.openqa.selenium.support.PageFactory;
import org.testng.Assert;
import java.util.ArrayList;
import java.util.concurrent.TimeUnit;
public class LoginPage extends Common{
// Define the page locators
@FindBy(xpath = “/html/body/div/main/div/div/div[2]/div/button[1]”)
WebElement gmailBtn;
@FindBy(xpath = “//*[@id=\”identifierId\“]”)
WebElement gmailEmail;
@FindBy(xpath = “/html/body/div[1]/div[1]/div[2]/div/c-
wiz/div/div[2]/div/div[2]/div/div[1]/div/div/button/span”)
WebElement gmailNext;
@FindBy(xpath = “/*[@id=\”password\“]/div[1]/div/div[1]/input”)
WebElement gmailPass;
@FindBy(xpath = “/*[@id=\”passwordNext\“]/div/button”)
WebElement gmailPassBtn;
@FindBy(xpath = “//*[@id=\”_{——}next\“]/header/div[2]/div/div[2]/span”)
WebElement loginBtn;
@FindBy(xpath = “//*[@id=\”root\“]/main/header/div/div/div[3]/button[3]/div[1]/span[1]”)
WebElement loggedinUserName;
@FindBy(xpath = “//*[@id=\”details-button\“]”)
WebElement advancedBtn;
@FindBy(xpath = “//*[@id=\”proceed-link\“]”)
WebElement proceedBtn;
String usrEmail = “automation.domain-name”;
String userPass = “User-security-expert”;
String userName = “Automation”;
// Initialize the driver
public LoginPage(WebDriver driver) {
this.driver = driver;
//This initElements method will create all WebElements
PageFactory.initElements(driver, this);
}
//Click on login button
public void clickGmailLoginBtn( ) {
gmailBtn.click( );
}
//Set the user Gmail Email
public void setUserEmail(String strUserEmail) {
gmailEmail.sendKeys(strUserEmail);
}
//Move to Gmail Pass page
public void click Next Button( ) {
gmailNext.click( );
}
// Set the Gmail pass
public void setGmailPass(String strUserPass) {
gmailPass.sendKeys(strUserPass);
}
// Click continue after entering the gmail pass
public void clickPassNextBtn( ) {
gmailNext.click( );
}
// Click Advance button to proceed with the link
public void clickAdvanceBtn( ) {
advancedBtn.click( );
}
// Click proceed button to proceed with the link
public void clickProceedBtn( ) {
proceedBtn.click( );
}
//Get the page title after do Login
public String getMainPageTitle( ) {
return driver.getTitle( );
}
// Return the User Name after do login
public String getUserName( ) {
return loggedinUserName.getText( );
}
public void doLogin( ) throws InterruptedException {
// Click the Gmail button to login by Gmail
this.clickGmailLoginBtn( );
driver.manage( ).timeouts( ).implicitlyWait(10, TimeUnit.SECONDS);
//Fill the user email
this.setUserEmail(usrEmail);
driver.manage( ).timeouts( ).implicitlyWait(10, TimeUnit.SECONDS);
//click Next to enter the pass
this.clickNextBtn( );
driver.manage( ).timeouts( ).implicitlyWait(10, TimeUnit.SECONDS);
//Enter the Gmail pass
this.setGmailPass(userPass);
Thread.sleep(9000);
driver.manage( ).timeouts( ).implicitlyWait(20, TimeUnit.SECONDS);
// Click Next to Login
this.clickPassNextBtn( );
driver.manage( ).timeouts( ).implicitlyWait(20, TimeUnit.SECONDS);
// Open the files to proceed with the link permission
((JavascriptExecutor) driver).executeScript(“window.open( )”);
ArrayList<String> tabs = new ArrayList<String>(driver.getWindowHandles( ));
driver.switchTo( ).window(tabs.get(1));
driver.get(“<cloud-storage-URL>/api/files?perPage=10&currentPage=1&sort=-
created_at&ownership=all”);
driver.manage( ).timeouts( ).implicitlyWait(20, TimeUnit.SECONDS);
this.clickAdvanceD tn( );
Thread.sleep(9000);
this.clickProceedBtn( );
driver.manage( ).timeouts( ).implicitlyWait(20, TimeUnit.SECONDS);
Thread.sleep(5000);
// switch back to the first tab
driver.switchTo( ).window(tabs.get(0)); // switch back to main screen
//driver.navigate( ).refresh( );
driver.manage( ).timeouts( ).implicitlyWait(10, TimeUnit.SECONDS);
Thread.sleep(15000);
System.out.println(“Login-step-complete”+driver.getCurrentUrl( ));
Assert.assertEquals(this.getUserName( ), userName);
}
}
package istari.web.smokeTest;
import istari.web.pageFactory.Common;
import istari.web.pageFactory.LoginPage;
import org.testng.annotations.Test;
import java.util.concurrent.TimeUnit;
public class Login extends Common {
LoginPage objLogin;
/**
* This test case will verify the login
*/
public void gmailLogin( ) throws InterruptedException {
//Do login by gmail
objLogin = new LoginPage(driver);
objLogin.doLogin( );
driver.manage( ).timeouts( ).implicitlyWait(10, TimeUnit.SECONDS);
Thread.sleep(5000);
}
}
/*#### TEST CODE EXAMPLE END ####*/

Such a manual approach may fall short in terms of scalability, especially in a platform that requires the integration of a large library of digital tools and digital model types.

### AI-Assisted Testing Automation Approach

The approach for AI-assisted model splicer generation described above includes faster design mockups, model data understanding, and API script generation. This approach is hereby expanded to QA/QC, unit, and usability testing within the software engineering workflow. AI-driven automation tackles scalability issues in testing by generating test scenarios and scripts based on user input for both the frontend and the backend. It also accelerates testing while maintaining consistent and reliable results.

### QA/QC Testing

For QA/QC testing, AI models can help perform routine checks without human intervention, which may considerably diminish time and human resource costs. Additionally, AI models can combine multiple real-world scenarios at the same time and with higher accuracy, a feat that cannot be replicated manually, ensuring that the platform can withstand a variety of workloads and user behaviors.

### Usability Testing

AI models can automate usability testing by learning from user interaction patterns and recommending improvements for a more user-friendly interface. The AI-assisted approach streamlines the process by automatically generating and executing test scripts.

### End-to-End Testing

In end-to-end testing, AI models can use past patterns, bugs, and fixes to predict where issues may occur in new or edited code, significantly simplifying the testing process and helping to prevent potential errors.

### Overview of AI-assisted Testing Automation

The methods and systems described herein include an AI-assisted testing automation approach for an IDMP, where ML models are used to generate test scenarios for a given user input, and are subsequently used to create test scripts for testing a target piece of written code or software, whether it be for the frontend or the backend.

In various implementations of the development and deployment of the IDMP, two fundamental approaches to software testing are employed: black box testing and white box testing.

Black box testing focuses on validating the functionality of the software without examining its internal code structure. Testers provide input, observe the output, and verify if the software meets the specified requirements and user expectations. This approach includes methods such as equivalence partitioning, boundary value analysis, decision table testing, state transition testing, and usability testing. These methods emphasize user experience, feature validation, and overall system behavior.

White box testing, in contrast, involves a detailed examination of the internal workings of the code. Testers have access to the codebase and employ techniques such as code coverage analysis, unit testing, and integration testing to ensure each part of the code functions correctly. This approach facilitates early error detection, ensures code correctness, and aids in refactoring.

Both testing methods are essential for creating robust, reliable software, each providing unique insights and coverage.

Example implementations of the IDMP can incorporate AI-assisted testing as described below:

### Black Box Testing

Black box testing comprises specification testing, feature and API testing, and usability testing.
1. Specification testing focuses on verifying that the software, both as a whole and in individual modules, meets specified requirements based on specifications and requirements. Techniques include equivalence partitioning, boundary value analysis, decision table testing, state transition testing, and error guessing. AI assistance as described herein can be utilized for pre-deployment environment checks based on contract documentation, IT environment specifications, and individual software modules within the IDMP platform code.
2. Feature and API testing validates individual features or API implementations of splice functions, focusing on functionality and user experience. This involves manual and automated testing, A/B testing, and scenario-based testing. In an exemplary AI-assisted workflow, AI can assist in dependency management testing or API testing, linking feature design documents, customer feedback, and digital thread examples, with individual APIs generated and tested.
3. Usability testing evaluates user experience and interface design, considering user interactions, ease of use, and satisfaction. Techniques include user interviews, surveys, task analysis, A/B testing, and heatmaps. Exemplary AI-assisted usability testing can link front-end usage patterns with test scenarios.

### White Box Testing

White box testing comprises unit testing and integration testing.
1. Unit testing verifies individual units or components of code, focusing on code logic and functionality of individual units such as functions, methods, and classes. Techniques involve test-driven development (TDD), mocking, stubbing, and code coverage analysis. In an exemplary AI-assistance workflow, AI modules can be employed for unit testing and compilation of test scenarios, test scripts, and summary reports.
2. Integration testing ensures different components work together effectively, focusing on system components and their interactions. This involves system integration testing, API testing, and environment-specific testing. Exemplary AI-assisted or automated integration testing can be particularly useful when individual digital models or tools are updated.

FIG. 30 illustrates a flowchart 3000 showing a process for AI-assisted testing within the IDMP, in accordance with some embodiments of the present invention. A data collection database 3002 stores all the testing-related data, including training data for ML models generating test scenarios, training data for ML models generating test scripts, and examples of user workflow data such as model type files, instructions, test scripts, and test reports. The dashed lines 3050a and 3050b depict the flow of data being collected by the data collection database 3002. The dotted lines 3052 depict the flow of data from the data collection database 3002 to be used as training data or inputs for LLM models in certain sections of the flowchart. The flowchart is divided into four main sections: code integration 3010 for data collection, test scenario generation 3020, test script generation 3030, and test script execution 3040.

Within the code integration section 3010, in step 3012, web pages that are part of the software platform are parsed and form fields are extracted. Web page parsing may involve applying XPath queries to identify input elements, select dropdowns, and other form elements, while extracting relevant attributes such as field type, name, ID, and default values for further processing or test scenario generation. In step 3014, which may occur in parallel with step 3012, user actions and scenarios related to different user intents (e.g., “create new account”, “save design”, “update model file”, etc.) are logged. Javascript code is injected in all pages of the platform to collect information. The form field data and user action data from steps 3012 and 3014 are collected by the data collection database 3002 and may be used in steps 3022 and 3032 for test scenario generation and test script generation.

Test scenario generation section 3020 features step 3022, where an LLM model for test scenario generation parses user actions from the data collection database 3002 and generates human readable test scenarios. The LLM model may be trained on training data from the data collection database 3002. Based on the output of the LLM model, the process then moves to a decision point 3024 for approval by a human expert. If the human readable test scenario is not approved, then the human feedback is returned to the LLM model and step 3022 is repeated with the human feedback. If the human readable test scenario is approved, the process proceeds to the next section.

Testing script or test script generation section 3030 features step 3032, where an LLM model for test script generation generates test scripts based on the human readable scenarios from the test scenario generation section 3020 and user action data and data from interactive fields in the web page from the data collection database 3002. The test script generation LLM may be prompted by a user to generate test scripts utilizing specific frameworks and libraries. Based on the output of the LLM model, the process then moves to another decision point 3034 for approval by a human expert. If the test scripts are not approved, then the human feedback is returned to the LLM model and step 3032 is repeated with the human feedback. If the test scripts are approved, the process proceeds to the next section.

Within the test script execution section 3040, in step 3042, the test scripts from the test script generation section 3030 are executed on the platform. In step 3004, the test execution results are output in a report. The report output is also collected by the data collection database 3002 and may be used for further training and updating of the test scenario generation LLM models and the test script generation LLM models. The flowchart demonstrates a structured approach to automated test generation and execution, incorporating machine learning models and human oversight at various stages to ensure accuracy and relevance of the generated tests. The proposed implementation is described in more detail within the illustrative example of AI-assisted testing of Tables 2 and 3 and FIGS. 32-36 below, through the following five steps:
1. Code integration with the necessary code and schema within the target software (see Tables 2 and 3 and FIG. 32);
2. Data preparation (see FIG. 33);
3. Test scenario generation (see FIG. 34);
4. Test script generation (see FIG. 35); and
5. Execution & Report generation (see FIG. 36).

The proposed implementation, illustrated in FIG. 30, is further described with respect to specification and feature testing, discussed in reference to FIG. 31 next.

### Additional Roles of AI Agents in AI-Assisted Testing

In exemplary implementations of the IDMP, AI agents, modules, or models may be pre-trained on contract documentation, customer environment description documents, or platform API documentation or resource-capability mappings and may provide AI assistance to users for various ongoing testing requirements. Some AI agents may assist in parsing customer documents into software specifications and requirements and in defining user scenarios for testing.

AI agents, such as scenario machine learning (ML) models described below, may take example test scenarios and iterate across a broader test parameter set to create synthetic test scenarios based on the initial test scenario examples. Additional AI agents, such as script machine learning (ML) models described below, may utilize the test scenarios and requirements to generate executable test code scripts. Such scenario ML models and script ML models may be implemented as part of the scripting AI module 1750 shown in FIG. 17. These approaches can leverage external feedback to refine testing processes. The AI agents can be deployed to train within the specific context of appropriate documentations using a Retrieval Augmented Generation (RAG)-based approach or a Low-Rank Adaptation (LoRA) approach.

### Specification and Feature Testing

FIG. 30. provides an adequate framework to introduce specification testing and feature testing, which can be viewed as unit tests as discussed in the context of FIGS. 14-17.

Specification testing involves creating test scenarios based on the software's requirements to ensure it meets the specified criteria. In this process, test scenario generation 3020 provides the necessary specifications, such as environment variables or software modules. In addition, the test scenarios might include simulations within the environment or module integration tests. Test script generation 3030 and execution 3040 will then follow these scenarios, create the necessary scripts, and conduct the tests.

Feature testing, however, focuses on testing individual features or API functions. Here, test scenario generation 3020 defines test scenarios, such as checking feature dependencies, testing edge cases, refining features based on customer feedback, and using related feature examples. Test script generation 3030 and execution 3040 will then implement the test scripts and carry out the testing for these scenarios.

FIG. 31 shows an exemplary process for AI-assisted specification and/or feature testing script generation, in accordance with one embodiment of the present invention. Specifically, FIG. 31 illustrates specification and feature testing through an exemplary flowchart for automated testing with scenarios, scripts, and tester agents.

In FIG. 31, a user input (3112) initiates the testing process by capturing the user's intent for testing along with action data reflecting interactions with the IDMP and its interfaces. This input is processed by a scenario ML model (3114) that defines test scenarios. The scenario ML model is trained on historical data such as software specifications, requirements documents (3116), and the IDMP platform documentation, including its resource-capability mapping or API (3118). This model may be specifically trained on this targeted data or could be a refined large language model adapted to the specific context of the IDMP using RAG or LoRA approaches. This approach enables the generation of precise test scenarios tailored to the platform's unique requirements.

In various exemplary implementations, this process can be applied to software specification testing during the deployment of the IDMP platform in specific environments, as well as for integration testing of available tools. Additionally, it is suitable for feature testing or API testing, where the requirements of a particular feature or API are validated using the IDMP documentation and API, and by extrapolating various scenarios to assess performance.

Once the test scenarios are defined, a script ML model generates the corresponding test scripts (3122), which are then compiled by the IDMP (3124) to ensure they are executable and meet the intended testing objectives. The script ML model can be trained using a variety of data sources, including user inputs, user actions, historical test scenarios, and test scripts. Tester agents (3126) generate test cases based on these scenarios and execute the scripts to run the tests using the test input in step (3132). If the scripts execute successfully, the system generates a detailed report on the testing outcomes in step (3136). If issues arise at the errors decision point (3134), the tester agents iterate through additional test cases to resolve them. This tester agent may be implemented as part of the AI agent discussed in the context of FIGS. 16 and 17.

Throughout this process, the testing can be fully automated, or in some examples, semi-automated with human expert feedback integrated to further refine both the test scenarios (3120) and scripts (3128), ensuring that the process is comprehensive and aligned with real-world requirements.

### Examples for AI-Assisted Testing

FIGS. 32-36 illustrate the individual components of the AI-assisted testing process shown in FIG. 30, according to embodiments of the present invention. In the embodiments of FIGS. 32-36, the process is carried out by a test module.

### Step 1: Code Integration Example

In one embodiment, the test module starts by generating a unique JavaScript code for the IDMP. The unique JavaScript code is created by a human expert or created by the system based on prior examples. The function of this code is to record all user actions within the IDMP. The development team will then inject this code into the HTML code of the system pages, specifically within the <head> tag.

Tables 2 and 3 below show an illustrative software application HTML <head> tag (Table 2) running an exemplary user-action collection script (Table 3), according to embodiments of the present invention. In this case, the target software is the DE platform application.

TABLE 2
Software Application HTML <head> Tag

```
<!DOCTYPE html>
<html lang=“en”>
  <head>
  <meta charset=“UTF-8” />
  <link rel=“icon” type=“image/svg+xml” href=“/assets/favicon-0e910ae6.svg” />
  <!-- Font -->
  <link rel=“preconnect” href=“fonts.googleapis.com” />
  <link rel=“preconnect” href=“ fonts.gstatic.com” crossorigin />
  <link
      href=“fonts.googleapis.com/css2?family=Inter:wght@400;500;600;700&family=Source+Sans+Pro
:wght@400;600;700&display=swap”
      rel=“stylesheet”
    />
    <meta name=“viewport” content=“width=device-width, initial-scale=1.0” />
    <title>Istari Digital</title>
    <script type=“module” crossorigin src=“/assets/index-42aaa01e.js”></script>
    <link rel=“stylesheet” href=“/assets/index-722777db.css”>
  </head>
```

TABLE 3
User Action Collection Script

<script>
(function(i,s,o,g,r,a,m){i[‘GoogleAnalyticsObject’]=r;i[r]=i[r]||function( ){(i[r].q=i[r].q||[ ]).push(argume
nts)},i[r].1=1*new Date( );a=s.createElement(o),
m=s.getElementsByTagName(o)[0];a.async=1;a.src=g;m.parentNode.insertBefore(a,m)})(window,
document,‘script’,‘//www.google-analytics.com/analytics.js’,‘ga’);
ga(‘create’, ‘UA-xxxxxx-1’, ‘auto’);
ga(‘send’, ‘pageview’);
</script>

Hence, in the exemplary embodiment of Tables 2 and 3, if a user opens the application's main page and clicks the “Create Account” link, the code will create a record in the database capturing this behavior. Additionally, the JavaScript code of Table 3 also records the front-end elements with which the user interacts, such as the “Create Account” link, and stores this information in the data collection database (1102).

FIG. 32 shows a developer screen illustrating a user action (“Create Account”) interface and corresponding HTML code, according to an embodiment of the present invention. With reference to the exemplary embodiments of Tables 2 and 3, a user may enter login credentials in the data field 3202 and click the “Create Account” link 3204. The corresponding HTML code 3206 and CSS code 3208 for the “Create Account” link 3204 shows the page structure and styles within the developer tools. All user actions within the user interface can be recorded, and this user action data can be stored and used for testing in subsequent steps.

### Step 2: Data Preparation and Collection

Next, the test module collects all user action data recorded by the JavaScript code and prepares a dataset to feed the AI model. FIG. 33 illustrates data collection for AI-enabled testing, according to one embodiment of the present invention. The data collection process 3302 includes logging user actions, usage workflow, and UI components following a specific usage scenario carried out by the user. In FIGS. 33-36, inputs and outputs are indicated by dashed and dotted boxes, respectively, as illustrated by the figure key 3320.

In step 3310, a user performs actions on a web page through the UI in a specific user scenario. The data collection step 3312 involves logging user actions and scenarios. This is done through a computer program that records all user actions 3314 on a user interface (UI). These actions could include clicks on buttons, filling out text fields, or submitting forms.

The order in which these actions are performed is also recorded, creating what is referred to as a user scenario or usage workflow 3316. This is essentially the logical sequence of user actions.

Additionally, the system also logs a mapping between the UI components and their corresponding XPath (a language used to navigate through elements in an HTML/XML document), as illustrated by element 3318. The XPath serves as a pointer to specific UI components, allowing the system to know exactly where a user action took place on the UI. The collected data 3314, 3316, and 3318 are then used for AI fine-tuning and training, forming the basis for the next steps in the system's process. FIG. 33 additionally contrasts a human view 3330 and a computer view 3340 of a web page and illustrates the XPath to the username text field.

### Step 3: Scenario Generation

The test module processes this data and prompts a scenario generation AI model to generate test scenarios based on user actions and interactions with the system components. FIG. 34 illustrates an exemplary process for AI-enabled test scenario generation 3400, according to one embodiment of the present invention. The generated scenarios are initially written in natural language, which allows human experts to review and approve them before they are converted into automated scripts. In FIG. 34, the element “A” 3408 refers to the data input from test reports that are successfully completed later in the workflow.

The test scenario generation step involves using AI to generate different test scenarios based on the data collected in the first step. This process is AI-assisted and may use a large language model to generate these scenarios in a human-readable format. Inputs and outputs of the scenario generation AI model 3410 are indicated by dashed and dash-dotted boxes, respectively, as illustrated by the figure key 3420.

The scenario generation AI model 3410 takes the logged user actions 3404 and usage workflows 3406 as inputs. These inputs are essentially the sequences of user actions that were recorded during the data collection phase. The scenario generation AI model 3410 then generates different human readable test scenarios 3412 based on these inputs. The goal is to create a variety of scenarios that an engineer might need to test, essentially simulating different user behaviors and sequences of actions. The inputs comprising user actions 3404, usage workflows 3406, and “A” (test report data) 3408 may also be used as training data for training the scenario generation AI model 3410.

The generated scenarios are in a human-readable format, which allows for human feedback 3414 and modification if necessary. The human feedback 3414 on the human readable test scenarios 3412 may be used to iteratively improve the scenario generation AI model 3410. This is important because it allows for the adjustment and fine-tuning of scenarios based on human expertise and understanding, which can lead to more effective and comprehensive testing.

A test scenario such as the human readable test scenarios 3412 may be defined as a sequence of steps that represents a possible situation that can be tested (i.e., a target testing situation). It is a high-level description of what a user or a bot can do with the system, and includes a list of actions. In some embodiments, a test scenario also includes the expected results or the list of actions. In other words, a test scenario pertains to a sequence of actions, constituting a potential situation to evaluate a software system. It provides a high-level depiction of the tasks a user or a system can execute, detailing the procedures and their corresponding action points. In various embodiments, each scenario also incorporates the anticipated outcomes besides the set of operations, offering comprehensive insight into the expected system responses. Test scenarios usually focus on understanding “what” to test rather than “how” to test, aiding in system validation and reliability assessment. FIG. 34 shows an exemplary human-readable test scenario 3430.

It is important to highlight that the number of potential test scenarios can increase exponentially based on the variety of user actions. This is where the AI model becomes invaluable, as it aids in generating valid test scenarios from this vast pool. The human-readable format of these scenarios allows for human intervention and modification if needed, ensuring more effective and comprehensive testing.

### Step 4: Test Script Generation

Upon approval of the test scenarios, the test module proceeds to create automation scripts using different programming languages like Java or Python. These scripts are created to be compatible with common automation frameworks like SELENIUM, CYPRESS, and TESTNG.

FIG. 35 shows an illustrative process for AI-assisted testing script or test script generation, in accordance with embodiments of the present invention. The test script generation process 3500 involves feeding the human-readable test scenarios 3503, UI components and their corresponding XPath mappings 3506, and training data into a script generation AI model 3508 (e.g., an LLM such as GorillaLLM). Inputs and outputs of the automatic script generation AI model 3508 are indicated by dashed and dash-dotted boxes, respectively, as illustrated by the figure key 3520.

The script generation AI model 3508 generates automation scripts 3510 based on the inputs 3504 and 3506. These scripts are essentially instructions for automated testing tools to execute specific test scenarios. The generated automation scripts 3510 are designed to mimic the actions a human tester would take, such as clicking on a button, filling out a form, or navigating through a website. This allows for automated testing of the software or application, which can save time and resources compared to manual testing. Once the scripts are generated, they can be reviewed and modified by a human if necessary, generating human feedback 3512 which can be used to iteratively improve the output of the script generation AI model 3508. The human feedback 3512 allows for fine-tuning of the scripts to ensure they accurately represent the test scenarios and can effectively test the software or application.

A test script refers to a predefined set of instructions, often written as program code, that are executed within specific software, such as the digital engineering platform, or a subsystem within it, to validate its expected functionality. The instructions in the test script, significantly inspired by easy-to-understand test scenarios, are delineated in an executable script that either runs within the target software or across the larger platform. Each test script, designed to execute detailed test cases, corresponds to one or more overarching test scenarios. It lays out the individual steps to be undertaken by the test module, the precise inputs required, and the anticipated outputs, thereby maintaining system behavior predictability and reliability. FIG. 35 shows an exemplary test script testing the automation of a POST request over a DE platform 3530.

In certain implementations, testing integrates error replication to enhance system resilience. An error replication process involves identifying a particular scenario that resulted in a prior error or system glitch. After identifying the issue, the system formulates tests to recreate that exact error-causing scenario, allowing developers to validate fixes and ensure that the issue does not return in future iterations of the software. A major challenge in prior manual and naive automated approaches is developing comprehensive tests that are not limited to covering the exact scenario which gave rise to an issue, but also recreate related cases that may cause similar errors to occur. With AI assisted testing, the system generates further tests that emulate analogous scenarios, increasing the likelihood of detecting and addressing hidden problems before they affect the end user. In these implementations, AI-assisted testing allows for several iterations between Step 3 (scenario generation) and Step 4 (test script generation), resulting in a portfolio of test scripts testing for the error but also encompassing analogous scenarios.

### Step 5: Test Execution and Report

FIG. 36 illustrates test script execution and report generation, according to embodiments of the present invention. The Execution and Test Reports step is the final component of the test module. It involves running the AI-generated automation test scripts and subsequently generating test reports based on the results. Within the execution and report generation process 3600, the test execution engine 3608 executes the generated automation test scripts 3604 on a dedicated server and generates comprehensive test reports 3610, which it shares with the IDMP's quality team & management. The test reports 3610 may also be collected in element “A” 3612 and shared as training inputs to the scenario generation AI model 3410 of FIG. 34. The test reports 3610 detail the number of generated and executed automation scripts and provides test results for each scenario. Inputs and outputs of the test execution engine 3608 are indicated by dashed and dash-dotted boxes, respectively, as illustrated by the figure key 3620.

In more detail, during the execution phase, the automation scripts 3604 that were generated in the previous step are run. These scripts perform a series of actions on the software or application being tested, effectively simulating user behavior and interactions.

Once the scripts have been executed, test reports 3610 are generated. These reports provide a detailed account of the test execution, including information about which tests passed, which tests failed, and any errors or issues that were encountered during the testing process.

These test reports can then be used for further analysis and improvement of the target software. They can provide valuable insights into the performance and effectiveness of the automation scripts, as well as highlight any potential issues or bugs in the software or application being tested.

Furthermore, these reports can also serve as a source of feedback or training for the AI models as shown in element “A” 3612, helping to improve and fine-tune the generation of user scenarios and automation scripts in future iterations.

Therefore, test scenario- and script- generation can be configured as cycles that end when human feedback triggers the following testing steps, as shown in FIG. 11. In other embodiments, the test scenario generation, test script generation, and test execution steps may be repeated until sufficient replication of a specific error, bug, or UI issue is achieved. In addition to their use within this cycle to verify error replication, test reports may also be used to train the various ML models, as discussed above.

### Machine Learning (ML) and Neural Networks

Machine learning (ML) algorithms are characterized by the ability to improve their performance at a task over time without being explicitly programmed with the rules to perform that task (i.e., learn). An ML model is the output generated when a ML algorithm is trained on data. As described herein, embodiments of the present invention use one or more artificial intelligence (AI) and ML algorithms. Various exemplary ML algorithms are within the scope of the present invention. The following description describes illustrative ML techniques for implementing various embodiments of the present invention.

### Neural Networks

A neural network is a computational model including interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 37 describes neural network operation fundamentals, according to exemplary embodiments of the present invention.

FIG. 37 shows a single-layered neural network, also known as a single-layer perceptron. The operation of a single-layered neural network involves the following steps:
1. Input: Receiving a DE input vector v 3704 with elements vⱼ, with j∈[1, n] representing the j^{th} DE input, and where each element of the vector corresponds to an element 3706 in the input layer. A DE input can be a user prompt, a DE document, a DE model, DE program code, system data from the IDMP, and/or any useful form of data in digital engineering.
2. Transfer Function: Multiplying each element of the DE input vector by a corresponding weight wⱼ 3708. These weighted inputs are then summed together as the transfer function, yielding the net input to the activation function

$${\sum }_{j = 1}^{n} {v}_{j} \cdot {w}_{j} 3710.$$

Each neuron in a neural network may have a bias value 3712, which is added to the weighted sum of the inputs to that neuron. Both the weights and bias values are learned during the training process. The purpose of the bias is to provide every neuron with a trainable constant value that can help the model fit the data better. With biases, the net input to the activation function is

$${\sum }_{j = 1}^{n} \{ {v}_{j} \cdot {w}_{j} \} + b .$$

3. Activation Function: Passing the net input through an activation function 3714. The activation function σ determines the activation value o 3718, which is the output of the neuron. It is typically a non-linear function such as a sigmoid or ReLU (Rectified Linear Unit) function. The threshold θ 3716 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
4. Output: The activation value o 3718 is the output of the activation function. This value is what gets passed on to the next layer in the network or becomes the final DE output in the case of the last layer. A DE output can also be an updated twin configuration, digital twin, physical twin, DE document, DE model, DE program code, or any useful form of data in digital engineering.

FIG. 38 shows an overview of an IDMP neural network training process, according to exemplary embodiments of the present invention. The training of the IDMP neural network involves repeatedly updating the weights and biases 3810 of the network to minimize the difference between the predicted output 3804 and the true or target output 3806, where the predicted output 3804 is the result produced by the network when a set of inputs from a dataset is passed through it. The predicted output 3804 of an IDMP neural network 3802 corresponds to the DE output 3718 of the final layer of the neural network. The true or target output 3806 is the true desired result. The difference between the predicted output and the true output is calculated using a loss function 3808, which quantifies the error made by the network in its predictions.

The loss function is a part of the cost function 3808, which is a measure of how well the network is performing over the whole dataset. The goal of training is to minimize the cost function 3808. This is achieved by iteratively adjusting the weights and biases 3810 of the network in the direction that leads to the steepest descent in the cost function. The size of these adjustments is determined by the learning rate 3808, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 3810 of the network based on the error (e.g., cost function) 3808 of the output. After forward propagation through the IDMP neural network 3802, the output 3804 of the network is compared with true output 3806, and the error 3808 is calculated. This error is then propagated back through the network, starting from the output layer and moving towards the input layer. The weights and biases 3810 are adjusted in a way that minimizes this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

FIG. 39 provides additional details on the training process or an IDMP machine learning model, according to exemplary embodiments of the present invention.

### Transformer Model Architecture

The transformer architecture is a neural network design that was introduced in the paper “Attention is All You Need” by Vaswani et al. published in June 2017, and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding”. Therefore, the training of a neural network and its evaluation (i.e., its use upon deployment) both occur within the embeddings space.

In this document, the processes of tokenization, encoding, decoding, and de-tokenization may be assumed. In other words, the processes described below occur in the “embeddings space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 39 is an illustrative flow diagram showing the different phases and datasets involved in training an IDMP ML model, according to exemplary embodiments of the present invention.

The training process starts at step 3910 with DE data acquisition, retrieval, assimilation, or generation. At step 3920, acquired DE data are pre-processed, or prepared. At step 3930, the IDMP ML model is trained using training data 3925. At step 3940, the IDMP ML model is evaluated, validated, and tested, and further refinements to the IDMP ML model are fed back into step 3930 for additional training. Once its performance is acceptable, at step 3950, optimal IDMP ML parameters are selected.

Training data 3925 is a dataset containing multiple instances of system inputs and correct outcomes. It trains the IDMP ML model to optimize the performance for a specific target task, such as the prediction of a specific target output data field within a specific target document. In FIG. 39, training data 3925 may also include subsets for validating and testing the IDMP ML model, as part of the training iterations 3930 and 3940. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 3925 may be expanded via a document database augmentation process.

In some embodiments, an additional fine-tuning 3960 phase including iterative fine-tuning 3960 and evaluation, validation, and testing 3970 steps, is carried out using fine-tuning data 3955. Fine-tuning in machine learning is a process that involves taking a selected 3950 pre-trained model and further adjusting or “tuning” its parameters to better suit a specific task or fine-tuning dataset 3955. This technique is particularly useful when dealing with deep learning models that have been trained on large, general training datasets 3925 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 3925, such as ImageNet for image recognition tasks. The model's existing weights, which have been learned from the original training, serve as the starting point. During fine-tuning, the model is trained further on a new fine-tuning dataset 3955, which may contain different classes or types of data than the original training set. This additional training phase allows the model to adjust its weights to better capture the characteristics of the new fine-tuning dataset 3955, thereby improving its performance on the specific task it is being fine-tuned for.

In some embodiments, additional test and validation 3980 phases are carried out using DE test and validation data 3975. Testing and validation of a ML model both refer to the process of evaluating the model's performance on a separate dataset 3975 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDMP ML model is trained 3930, selected 3950, and optionally fine-tuned 3960 and validated/tested 3980, the process ends with the deployment 3990 of the IDMP ML model. Deployed IDMP ML models 3995 usually receive new DE data 3985 that was pre-processed 3980.

In machine learning, data pre-processing 3920 is tailored to the phase of model development. During model training 3930, pre-processing involves cleaning, normalizing, and transforming raw data into a format suitable for learning patterns. For fine-tuning 3960, pre-processing adapts the data to align with the distribution of the specific targeted task, ensuring the pre-trained model can effectively transfer its knowledge. Validation 3980 pre-processing mirrors that of training to accurately assess model generalization without leakage of information from the training set. Finally, in deployment 3990, pre-processing ensures real-world data matches the trained model's expectations, often involving dynamic adjustments to maintain consistency with the training and validation stages.

Unless otherwise stated, the methods and systems disclosed herein regarding training, particularly pertaining to training data collection, generally apply to tuning, fine-tuning, pre-training, and/or post-training.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List”, by S. Raschka (posted Feb. 7, 2023, available at sebastianraschka.com), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances and output instances, or may be generated synthetically by subject matter experts.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDMP (in various architecture configurations including private cloud), and/or on the public cloud.

FIG. 40 provides illustrative schematics of a server (management computing entity) 4010 connected via a network 4020 to a client (user computing entity) 4030 used within an IDMP, according to some embodiments of the present invention. While FIG. 40 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 40 for a server or management computing entity 4010. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital engineering process.

In one embodiment, management computing entity 4010 may be equipped with one or more communication interfaces 4012 for communicating with various computing entities, such as by exchanging data, content, and/or information (similar terms used herein interchangeably) that can be transmitted, received, operated on, processed, displayed, stored, and/or the like. For instance, management computing entity 4010 may communicate with one or more client computing devices such as 4030 and/or a variety of other computing entities. Network or communications interface 4012 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 4010 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 40, in one embodiment, management computing entity 4010 may include or be in communication with one or more processors 4014 (also referred to as processors and/or processing circuitry, processing elements, and/or similar terms used herein interchangeably) that communicate with other elements within management computing entity 4010, for example, via a bus. As will be understood, processor 4014 may be embodied in a number of different ways. For example, processor 4014 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 4014 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 4014 may be configured for a particular use or configured to execute instructions stored in volatile or non-volatile (or non-transitory) media 4016 and 4018, or otherwise accessible to processor 4014. As such, whether configured by hardware or computer program products, or by a combination thereof, processor 4014 may be capable of performing steps or operations according to embodiments of the present disclosure when configured accordingly.

In one embodiment, management computing entity 4010 may further include or be in communication with non-transitory memory 4018 (also referred to as non-volatile media, non-volatile storage, non-transitory storage, physical storage media, memory, memory storage, and/or memory circuitry—similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FIG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 4010 may further include or be in communication with volatile memory 4016 (also referred to as volatile storage, memory, memory storage, memory and/or circuitry—similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 4014. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 4010 with the assistance of processor 4014 and an operating system.

Although not shown, management computing entity 4010 may include or be in communication with one or more input elements, such as a keyboard input, a mouse input, a touch screen/display input, motion input, movement input, audio input, pointing device input, joystick input, keypad input, and/or the like. Management computing entity 4010 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 4010 may be located remotely from other management computing entity components, such as in a distributed system. Furthermore, one or more of the components may be combined and additional components performing functions described herein may be included in management computing entity 4010. Thus, management computing entity 4010 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 40 further provides an illustrative schematic representation of a client user computing entity 4030 that may be used in conjunction with embodiments of the present disclosure. In various embodiments, computing device 4030 may be a general-purpose computing device with dedicated modules for performing digital engineering-related tasks. It may alternatively be implemented in the cloud, with logically and/or physically distributed architectures.

As shown in FIG. 40, user computing entity 4030 may include a power source 4031, an antenna 4070, a radio transceiver 4032, a network and communication interface 4034, and a processor unit 4040 that provides signals to and receives signals from the network and communication interface. The signals provided to and received may include signaling information in accordance with air interface standards of applicable wireless systems. In this regard, user computing entity 4030 may be capable of operating with one or more air interface standards, communication protocols, modulation types, and access types. More particularly, user computing entity 4030 may operate in accordance with any of a number of wireless communication standards and protocols, such as those described above with regard to management computing entity 4010. Similarly, user computing entity 4030 may operate in accordance with multiple wired communication standards and protocols, such as those described above with regard to management computing entity 4010.

Via these communication standards and protocols, user computing entity 4030 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 4030 may also download changes, add-ons, and updates, for instance, to its firmware, software (e.g., including executable instructions, applications, program modules), and operating system.

In some implementations, processing unit 4040 may be embodied in several different ways. For example, processing unit 4040 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 4040 may be embodied as one or more other processing devices or circuitry. The term circuitry may refer to an entirely hardware embodiment or a combination of hardware and computer program products. Thus, processing unit 4040 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 4040 may be configured for a particular use or configured to execute instructions stored in volatile or non-volatile media or otherwise accessible to the processing unit. As such, whether configured by hardware or computer program products, or by a combination thereof, processing unit 4040 may be capable of performing steps or operations according to embodiments of the present invention when configured accordingly.

In some embodiments, processing unit 4040 may comprise a control unit 4042 and a dedicated arithmetic logic unit (ALU) 4044 to perform arithmetic and logic operations. In some embodiments, user computing entity 4030 may comprise a graphics processing unit (GPU) 4046 for specialized parallel processing tasks, and/or an artificial intelligence (AI) module or accelerator 4048, also specialized for applications including artificial neural networks and machine learning. In some embodiments, processing unit 4040 may be coupled with GPU 4046 and/or AI accelerator 4048 to distribute and coordinate digital engineering related tasks.

In some embodiments, computing entity 4030 may include a user interface, including an input interface 4050 and an output interface 4052, each coupled to processing unit 4040. User input interface 4050 may comprise any of a number of devices or interfaces allowing computing entity 4030 to receive data, such as a keypad (hard or soft), a touch display, a mic/speaker for voice/speech/conversation, a camera for motion or posture interfaces, and appropriate sensors for spatial computing interfaces. User output interface 4052 may comprise any of a number of devices or interfaces allowing computing entity 4030 to provide information to a user, such as through the touch display, or a speaker for audio outputs. In some embodiments, output interface 4052 may connect computing entity 4030 to an external loudspeaker or projector, for audio and/or visual output. In some embodiments, user interfaces 4050 and 4052 integrate multimodal data in an interface that caters to human users. Some examples of human interfaces include a dashboard-style interface, a workflow-based interface, conversational interfaces, and spatial-computing interfaces. As shown in FIG. 5, computing entity 4030 may also support bot/algorithmic interfaces such as code interfaces, text-based API interfaces, and the like.

User computing entity 4030 can also include volatile and/or non-volatile storage or memory 4060, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FIG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 4060 may store an operating system 4062, application software 4064, data 4066, databases, database instances, database management systems, data, applications, programs, program modules, scripts, source code, object code, byte code, compiled code, interpreted code, machine code, executable instructions, and/or the like to implement functions of user computing entity 4030. As indicated, this may include a user application that is resident on the entity or accessible through a browser or other user interface for communicating with management computing entity 4010 and/or various other computing entities.

In some embodiments, user computing entity 4030 may include one or more components or functionalities that are the same or similar to those of management computing entity 4010, as described in greater detail above. As will be recognized, these architectures and descriptions are provided for exemplary purposes only and are not limited to the various embodiments.

In some embodiments, computing entities 4010 and/or 4030 may communicate to external devices like other computing devices and/or access points to receive information such as software or firmware, or to send information from the memory of the computing entity to external systems or devices such as servers, computers, smartphones, and the like.

In some embodiments, two or more computing entities such as 4010 and/or 4030 may establish connections using a network such as 4020 utilizing any of the networking protocols listed previously. In some embodiments, the computing entities may use network interfaces such as 4012 and 4034 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### Terminology

Some illustrative terminologies used with the IDMP are provided below to assist in understanding the present invention, but these are not to be read as restricting the scope of the present invention. The terms may be used in the form of nouns, verbs, or adjectives, within the scope of the definition.

### Digital Engineering

Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data includes project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model: A computer-generated model that represents characteristics or behaviors of a complex product, system, or process. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE model is a type of digital model, defined below. In general, any reference to a DE model in the specification and drawings may be considered equivalent to a reference to a digital model, and vice versa.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the Interconnected Digital Model Platform (IDMP) as disclosed herein refers to any digital file uploaded onto the platform. All the terms and concepts defined above and included herein, including model splicing, model splices, and software-defined digital threads, apply in the context of the digital model and within the context of the IDMP.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.

### IDMP/IDEP

Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. Specifically, an embodiment of the IDEP is a software platform that interconnects a plurality of spliced DE model files through one or more software-defined digital threads (see FIGS. 1-4). A DE and certification ecosystem performs verification and validation tasks, defined next. An IDEP may be considered a type of Interconnected Digital Model Platform (IDMP) when one or more of the digital models are engineering or science related, the IDMP being defined below. In general, any reference to an IDEP in the specification and drawings can be considered equivalent to a reference to an IDMP, and vice versa, and any feature, embodiment, or description in relation to one applies analogously to the other. The terms “Interconnected” and “Integrated” are used interchangeably herein.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads.
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
AI Agent or Tool Agent: a software entity or module that takes instructions from the enclave and acts on behalf of a user or another program to perform specific tasks or operations related to an AI model or a DE tool. An AI agent or a tool agent may be designed as part of the IDMP but deployed by a customer within a secured customer environment to interface in-between the IDMP, AI models, and/or proprietary tools the customer is licensed for. Inside the customer environment, modular agents interact directly with the domain-specific tools and models to allow for bi-directional data flow across distributed tools.
Resource-capability mapping: A framework for identifying and linking available resources with the capabilities they enable or support. An exemplary resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Another example of the resource-capability mapping framework is the variable mapping table disclosed herein.
User intent: The goal, objective, or desired outcome that a user aims to achieve when interacting with the IDMP/IDEP. User intent may be expressed through various forms of input, such as user actions, natural language prompts, commands, or selections within the platform interface.
User actions: Specific interactions, inputs, or operations performed by a user within the IDMP/IDEP. User actions may include, but are not limited to, mouse clicks, keyboard inputs, voice commands, or any other form of interaction with the platform's interface or components.

### Model Splicing on IDMP/IDEP

Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A computer-executable sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or IDMP/IDEP API: A library of API scripts available on the IDEP/IDMP as disclosed herein.
API function scripts, “splice functions,” “splice methods,” “ISTARI functions,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice. In some embodiments, as a matter of design choice, a digital artifact is atomic and indivisible in terms of security levels, so that permissions for users to access and/or modify the digital artifact apply to the digital artifact as a whole, and may not apply to segments of the digital artifact. In other embodiments, a digital artifact includes segments that may have different access (e.g., viewing) and modification (e.g., updating) security levels. Consequently, for a given user, an “authorized artifact” for access is an artifact for which all segments fall under an access security level that allows the given user to access (e.g., view) it. Similarly, for a given user, an “authorized artifact” for modification is an artifact for which all segments fall under a modification security level that allows the given user to modify (e.g., update) it.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing, where the DE model being spliced is a human-readable text-based document.
Model splicer: Program code or script (uncompiled) that performs model splicing of DE models. A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.

### Digital Threads

Model splice linking: Generally, model splice linking refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a computer-executable script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices. In various embodiments, a digital thread associated with a digital twin is configured to execute a scripted workflow associated with the digital twin.
Tool linking: Similar to model splice linking, tool linking generally refers to jointly accessing two or more DE tools via model splices, where model splice functions that encapsulate disparate DE tool functions are called upon jointly to perform a DE task.
Workflow: A workflow typically representing an entire process or sequence of operations that achieves a specific goal or outcome. It encompasses the complete set of activities, from initiation to completion, that are required to fulfill a business process or software function. Workflows often involve multiple participants, systems, or departments and can be complex, involving branching paths, decision points, and parallel processes.
Digital Workflow: A digital workflow refers to a series of digital tasks and process steps that are carried out electronically to achieve a specific outcome. Digital workflows involve the use of digital tools, software applications, and technologies to streamline and manage various activities within an organization or project. They often enable full or partial automation, and typically include elements such as data input, information processing, task assignment, approval processes, and document management, all conducted in a digital environment.
Tasks and Process Steps: A task is usually a subset of a workflow and represents a discrete unit of work that needs to be completed as part of the larger process. Tasks are more specific and focused than workflows and are often assigned to individual agents. They have defined inputs, outputs, and objectives. Multiple tasks typically make up a workflow, and each task contributes to the overall goal of the workflow. A process step, or simply “step”, in turn, is the smallest unit of work within this hierarchy. Process steps are the individual actions or operations that, when combined, form a task. They are highly specific, often atomic actions that represent the most granular level of detail in a workflow. Multiple process steps are usually required to complete a single task, and the successful execution of all steps results in the completion of the task. In the context of digital workflows, the terms “digital task”, “digital workflow task”, and “digital engineering task” are used interchangeably herein.
Digital Task Implementation: An orchestration script, or a platform script, may be generated over the IDMP to implement a digital task including one or more process steps, where the “implementation” of the digital task through an orchestration script means that the orchestration script includes instructions carrying out each process step required to complete the digital task.

### Digital Twin

Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity; a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains. In some embodiments, a digital twin is a digital replica configured to run in a virtual environment and instantiated through a scripted digital thread, where the digital thread accesses data (e.g., digital artifacts) from a set of digital models through splicing. A digital twin may be instantiated, run, or executed, through a digital thread. Updating a digital twin may include the actions of modifying, deleting, and/or adding data to its twin configuration, to an associated digital thread, or to an associated digital model associated with the updated digital twin. In one embodiment, digital twins may be ephemeral and may have in-built time and space restrictions (see “twin configuration” definition below). In various embodiments, a physical twin is a physical object instantiated in a physical environment based on a set of model files through an MBSE manufacturing and/or prototyping process. In various embodiments, digital twins can be created for both physical products and physical processes. They are not limited to tangible items like machinery or vehicles; they can also simulate complex physical processes, such as manufacturing workflows or supply chain logistics, to improve efficiency and predict outcomes. This flexibility allows digital twins to be applied across various industries and scenarios.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
External Feedback: In various embodiments, external feedback comprises feedback data from at least one source external to a given digital twin, including digital twin performance data as received, analyzed or processed by the IDMP. External feedback may also include physical twin performance data, data from a virtual sensor, data from a physical sensor, user input (e.g., a user prompt, or a user response over a GUI), data from a simulation, a product certification file, or a product requirements file. In some embodiments, external feedback may also include feedback from control algorithms or processes in the IDMP that track digital twin performance (e.g., tracking error levels and/or tolerance between digital and corresponding physical twin data). External feedback data can also include feedback data that is external to the IDMP.
Twin Configuration: A twin configuration includes data specifying the configuration of a digital or a physical twin. Twin configurations may include a twin version identifier identifying the digital twin, one or more digital thread identifiers identifying the digital threads responsible for instantiating and running a twin, one or more model representation identifiers (e.g., URIs) identifying the model representations that are used by the twin, and an authoritative twin indicator (e.g., a boolean or binary variable) indicating whether the twin is an authoritative twin. The various twin configurations associated with the various physical and digital twins of a given product may be stored in a twin configuration set of the IDMP. In some embodiments, the twin configuration set acts as a specification database for the various digital and physical twins for one or more products or systems. In some embodiments, the twin configuration of a digital twin may include time and space restrictions on the associated digital twin, such as a validity time frame, a validity cutoff time, a validity space, or a validity geographical area (e.g., geofencing, proximity to another twin configuration).

### Security

Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Zero-knowledge approach: A zero-knowledge approach in data operations refers to a method where computational processes and data analyses are conducted such that the underlying data remains completely confidential and undisclosed to the parties performing the operations. This technique enables the validation, aggregation, and processing of data without exposing the actual data content, thereby preserving privacy and confidentiality.
Security Network: Information security networks are security networks that are configured to maintain the confidentiality, integrity, and availability of digital information (e.g., digital model data) through cybersecurity measures such as encryption, firewalls, intrusion detection systems, and access controls. A “security network” is a set of networked resources having identical access control restrictions, where each networked resource provides access to one or more digital model files. In various embodiments, the networked resources of a security network may be determined by one or a combination of the following factors: (1) having a minimum security access level, (2) belonging to a given physical network, (3) belonging to a given customer organization, and (4) belonging to a given business division.
Information Security (Infosec) Levels: Also referred to as “security levels” or “security access levels”, information security (Infosec) levels designate classifications assigned to data and operations based on sensitivity and security requisites, dictating access control and data handling procedures across networks. In some embodiments, an infosec level may define a security network.

### Testing

Testing: The process of evaluating and verifying the functionality, performance, and reliability of software components, digital workflows, or systems within a software platform such as the IDMP/IDEP. Testing may include assessing various aspects such as quality assurance (QA), quality control (QC), usability, and end-to-end functionality of the platform, its components, or the digital tasks executed on it.
Human-readable test scenarios: Descriptions of test cases or testing situations written in natural language that are easily understandable by human users or testers. These scenarios may outline the steps, conditions, and expected outcomes of a particular test. The test scenarios usually include a sequence of human-readable testing steps that are carried out on the software platform. In some embodiments, the testing steps are configured to evaluate the performance of the software platform in accomplishing the user intent. In other embodiments, they are configured to verify the ability of the software platform to accomplish the user intent.
Test script: A set of instructions, typically in the form of computer code or a structured sequence of commands, designed to automate the execution of a specific test scenario within the IDMP/IDEP. Test scripts may be generated based on human-readable test scenarios and may be used to perform automated testing of various platform components, digital workflows, or system functionalities.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes, parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example” or its equivalents is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number±10%, such that “about 10” would include from 9 to 11. In other exemplary embodiments, the term “about” may include the recited number±X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. One or more non-transitory storage media storing program code executable by a hardware processor, the program code when executed by the hardware processor causing the hardware processor to implement a process for artificial intelligence (AI) assisted workflow integration on a digital model platform, the one or more non-transitory storage media comprising program code to:
receive, from a user, a user selection of a target digital tool from a plurality of digital tools that are not directly interoperable with each other;
receive, from the user, a user request comprising a description of a function script interpretable by the digital model platform, wherein the description of the function script indicates a digital artifact generated by the function script from a digital model of a target digital model type associated with the target digital tool, when the function script is interpreted by the digital model platform;
fine-tune, based on the user selection and the user request, a scripting AI agent on prior user actions involving the target digital tool on the digital model platform, and on a platform resource-capability mapping of the digital model platform,
wherein the scripting AI agent generates scripts in a scripting language,
wherein the platform resource-capability mapping comprises documentation specific to the target digital tool,
wherein the platform resource-capability mapping provides a correspondence between given resources on the digital model platform and corresponding capabilities of the given resources,
wherein the given resources comprise third-party digital tool functions accessible by the digital model platform, and
wherein the corresponding capabilities comprise a plurality of platform scripts interpretable on the digital model platform, and that call upon the third-party digital tool functions accessible by the digital model platform;
generate, using the scripting AI agent, the function script, wherein the function script calls a given tool function from the target digital tool;
generate, using the scripting AI agent, a unit test script interpretable by the digital model platform, wherein the unit test script when interpreted tests the function script against the description of the function script; and
interpret the unit test script to generate a verification result for the function script.

2. The one or more non-transitory storage media of claim 1, wherein the unit test script, when interpreted, tests the function script by validating the digital artifact against a corresponding compliance requirement, and wherein a test result indicates whether the digital artifact has passed or failed the compliance requirement.

3. The one or more non-transitory storage media of claim 2, wherein the function script when interpreted by the digital model platform, generates the digital artifact from two or more digital models of different digital model types.

4. The one or more non-transitory storage media of claim 2,
wherein the digital model of the digital model type is a first digital model of a first digital model type,
wherein the target digital tool is a first digital tool,
wherein the given tool function is a first tool function of the first digital tool, and
wherein the function script when interpreted by the digital model platform, generates the digital artifact from the first digital model of the first digital model type and a second digital model of a second digital model type, by calling a second tool function of a second digital tool different from the first digital tool.

5. The one or more non-transitory storage media of claim 4, wherein the first digital tool and the second digital tool are not directly interoperable.

6. The one or more non-transitory storage media of claim 1, further comprising program code to:
determine, by the digital model platform, whether the user is authorized to access the scripting AI agent.

7. The one or more non-transitory storage media of claim 1, further comprising program code to:
collect, on the digital model platform, the prior user actions involving the target digital tool, wherein the prior user actions comprise user-verified scripts that make function calls of the target digital tool to access or manipulate digital models of the digital model type.

8. The one or more non-transitory storage media of claim 7, wherein the program code to fine-tune the scripting AI agent generates synthetic fine-tuning data using an Abstract Syntax Tree (AST) decomposition of the user-verified scripts.

9. The one or more non-transitory storage media of claim 1, further comprising program code to:
generate a model splice connected to the digital model of the digital model type, wherein the model splice comprises access to one or more model data items and the function script, wherein the function script provides an Application Programming Interface (API) or Software Development Kit (SDK) endpoint to access the digital artifact.

10. The one or more non-transitory storage media of claim 1, wherein the function script is generated based on a predefined input/output schema for the digital model type.

11. The one or more non-transitory storage media of claim 1, further comprising program code to:
receive a user feedback;
update a prompt to the scripting AI agent based on the user feedback;
send the prompt to the scripting AI agent; and
receive an updated function script from the scripting AI agent.

12. The one or more non-transitory storage media of claim 1, wherein the given tool function from the target digital tool is an Application Programming Interface (API) function from a digital tool library associated with the target digital tool, and wherein the user request comprises an identification of the digital tool library.

13. The one or more non-transitory storage media of claim 1, further comprising program code to:
annotate program code of the function script or the unit test script, using a documentation AI agent,
wherein the code annotation comprises a human-readable description of the function script.

14. The one or more non-transitory storage media of claim 1, further comprising program code to:
generate, using the scripting AI agent, a suite test script for a digital model representation,
wherein the suite test script comprises at least one invocation of the function script in a test scenario, and
wherein the test scenario is selected from the group consisting of a quality assurance (QA) test scenario, a quality control (QC) test scenario, a usability test scenario, an end-to-end test scenario, a performance test scenario, and a security test scenario.

15. The one or more non-transitory storage media of claim 14, further comprising program code to:
execute the suite test script to verify the digital model representation; and
in response to verifying that the digital model representation, generate using a documentation AI agent, a technical product documentation for the digital model splice.

16. The one or more non-transitory storage media of claim 1, further comprising program code to:
fine-tune the scripting AI agent using retrieval augmented generation, based on enterprise-specific knowledge.

17. A computer-implemented method for artificial intelligence (AI) assisted workflow integration on a digital model platform, comprising:
receiving, from a user, a user selection of a target digital tool from a plurality of digital tools that are not directly interoperable with each other;
receiving, from the user, a user request comprising a description of a function script interpretable by the digital model platform, wherein the description of the function script indicates a digital artifact generated by the function script from a digital model of a target digital model type associated with the target digital tool, when the function script is interpreted by the digital model platform;
fine-tuning, based on the user selection and the user request, a scripting AI agent on prior user actions involving the target digital tool on the digital model platform, and on a platform resource-capability mapping of the digital model platform,
wherein the scripting AI agent generates scripts in a scripting language,
wherein the platform resource-capability mapping comprises documentation specific to the target digital tool,
wherein the platform resource-capability mapping provides a correspondence between given resources on the digital model platform and corresponding capabilities of the given resources,
wherein the given resources comprise third-party digital tool functions accessible by the digital model platform, and
wherein the corresponding capabilities comprise a plurality of platform scripts interpretable on the digital model platform, and that call upon the third-party digital tool functions accessible by the digital model platform;
generating, using the scripting AI agent, the function script, wherein the function script calls a given tool function from the target digital tool;
generating, using the scripting AI agent, a unit test script interpretable by the digital model platform, wherein the unit test script when interpreted tests the function script against the description of the function script; and
interpreting the unit test script to generate a verification result for the function script.

18. The computer-implemented method of claim 17, wherein the unit test script, when interpreted, tests the function script by validating the digital artifact against a corresponding compliance requirement, and wherein a test result indicates whether the digital artifact has passed or failed the compliance requirement.
